(19) United States
(12) Patent Application Publication
(10) Pub. No.: US 2021/0198503 A1
(43) Pub. Date: Jul. 1, 2021

(54) Ink Jet Ink Composition, Ink Composition Producing Method, Recorded Product, And Ink Jet Recording Method

(71) Applicant: Seiko Epson Corporation, Tokyo (JP)

(72) Inventors: Masahiro YATAKE, Shiojiri (JP); Kazuhiko KITAMURA, Matsumoto (JP); Kohei ISHIDA, Matsumoto (JP)

(21) Appl. No.: 17/132,213

(22) Filed: Dec. 23, 2020

(30) Foreign Application Priority Data
Dec. 25, 2019 (JP) 2019-234110
Dec. 25, 2019 (JP) 2019-234114

(51) Int. Cl. C09D 11/102; C09D 11/38; B41M 5/00

(52) U.S. Cl. CPC C09D 11/102; C09D 11/38; B41M 5/0064; B41M 5/0023; B41M 5/0047

(57) ABSTRACT

In an ink jet ink composition containing polymer particles, a polymer constituting the polymer particles includes a polymer having a urethane group derived from one or more isocyanates selected from dicyclohexylmethane diisocyanate, isophorone diisocyanate, 1,3-bis(isocyanatemethyl)cyclohexane, m-bis(isocyanatepropyl)benzene, and m-bis(isocyanatemethyl)benzene and a structure derived from polytetramethylene glycol and having an acid value of 50 to 100 mgKOH/g.

The present application is based on, and claims priority from JP Application Serial Number 2019-234110, filed Dec. 25, 2019 and JP Application Serial Number 2019-234114, filed Dec. 25, 2019, the disclosures of which are hereby incorporated by reference herein in their entirety.

### BACKGROUND

### 1. Technical Field

The present disclosure relates to an ink jet ink composition, an ink composition producing method, a recorded product, and an ink jet recording method.

### 2. Related Art

An ink jet recording method has been used for printing of business documents and the like including letters, graphs, and the like using ordinary papers or the like as recording media. On the other hand, utilization of the ink jet recording method for recording on more poorly absorbable or non-absorbable recording media has also been expected. For such applications, inks using pigments as coloring materials are particularly useful since high-level coloring properties and robustness (scratch resistance, light resistance, ozone gas resistance, water resistance, and the like) of images are required.

Products printed with pigment inks have higher coloring properties than those printed with inks using dyes as coloring materials, and one of the reasons is that pigment components are likely to be localized on surfaces of recording media. This is because the dyes permeate the inside of the recording media while the pigments are likely to aggregate through evaporation or permeation of vehicle components caused in the process of adhesion of the inks to the recording media or after the adhesion. However, since the pigments that are coloring materials in the pigment inks are likely to be present on the surfaces of the recording media, the pigment inks have properties of low blocking resistance and low delamination resistance. In order to improve scratch resistance and the like of a pigment ink used for recording, addition of a urethane resin to the ink has been examined (see JP-A-2006-022132, JP-A-2012-140602, and JP-A-2013-035897). However, an aqueous ink jet ink with excellent blocking resistance and delamination resistance when printing is performed on films has not yet been found.

For example, the ink described in JP-A-2006-022132 uses a urethane resin modified with allophanate to which polyethylene glycol monomethyl ether is added as a pigment dispersant. The ink described in JP-A-2012-140602 is a pigment ink to which a urethane resin modified with allophanate with polyethylene glycol monomethyl ether added thereto is added. All of these inks have insufficient blocking resistance and delamination resistance.

Also, the ink described in JP-A-2013-035897 uses a urethane resin modified with isocyanurate. Such an ink provides low blocking resistance and delamination resistance of a recorded image.

Further, the pigment ink tends to have low scratch resistance of a printed product since the pigment, which is a coloring material, is likely to be present on the surface of the recording medium. In order to improve scratch resistance and the like of a product recorded with the pigment ink, addition of a urethane resin to the ink has been examined (see JP-A-2006-022132, JP-A-2012-140602, and JP-A-2013-035897).

For example, the ink described in JP-A-2006-022132 uses a urethane resin modified with allophanate to which polyethylene glycol monomethyl ether is added as a pigment dispersant.

The ink described in JP-A-2012-140602 is a pigment ink to which a urethane resin modified with allophanate with polyethylene glycol monomethyl ether added thereto is added. All of these inks have insufficient ink jet basic properties such as clogging stability, intermittent ejection stability, and successive printing stability, and scratch resistance.

Also, the ink described in JP-A-2013-035897 uses a urethane resin modified with isocyanurate. Such an ink has low scratch resistance of a recorded product, low clogging stability, and low delamination resistance and low glossiness when the ink is printed on a film such as OPP or PET.

Since a urethane-based polymer (particles) in the related art includes many hydrophilic groups and polar groups such as urethane groups, viscosity increases when a large amount of urethane-based polymer is used in an aqueous ink. When the viscosity increases in ink jet printing, ejection becomes unstable, clogging is likely to occur, and the amount of added resin is thus limited. Thus, sufficient fixability has not yet been obtained in term of excellent blocking resistance and delamination resistance when a printed product is used.

Thus, an ink with which an image with excellent blocking resistance and delamination resistance can be recorded on a recording medium and polymer particles suitable for such an ink have not yet been found.

Also, since the urethane-based polymer (particles) in the related art includes many hydrophilic groups and polar groups such as urethane groups, utilization of a large amount of urethane-based polymer in an aqueous ink leads to an increase in viscosity. When the viscosity increases in ink jet printing, ejection becomes unstable, clogging is likely to occur, and the amount of added resin is thus limited. Therefore, sufficient scratch resistance of a recorded product has not yet been obtained. In addition, although there are cases in which a protective film that is a lamination is provided to a recorded product, there is a problem that the lamination peels off.

As described above, a recorded product with excellent scratch resistance and delamination resistance and an ink jet ink composition and an ink jet recording method that enable production of such a recorded product have not yet been found.

### SUMMARY

The present disclosure was made in order to solve at least a part of the aforementioned problems and can be implemented as in the following aspects or application examples.

The first disclosure can be configured as follows.

According to an aspect of the present embodiment, there is provided an ink jet ink composition containing polymer particles, in which a polymer constituting the polymer particles includes a polymer that has a urethane group derived from one or more isocyanates selected from dicyclohexylmethane diisocyanate, isophorone diisocyanate, 1,3-bis(isocyanatemethyl)cyclohexane, m-bis(isocyanatepropyl)benzene, and m-bis(isocyanatemethyl)benzene and a structure derived from polytetramethylene glycol and has an acid value of 50 to 100 mgKOH/g.

Further, the content of the polymer particles may be 1% to 20% by mass with respect to the total mass of the ink composition.

Further, the polymer particles may have chains extended with polyamine having 1 to 10 carbon atoms and have a urea group.

Further, the molecular weight of the polytetramethylene glycol may be 500 to 3000.

Further, the ink jet ink composition may further contain a silicone-based surfactant and/or an acetylene glycol-based surfactant.

Further, the polymer particles may be polymer particles produced by performing a reaction of the one or more isocyanates, the polytetramethylene glycol, and acid group-containing polyol in an organic solvent and performing a chain extending reaction using polyamine in an aqueous solvent.

Further, the ink jet ink composition may be used to perform recording on a poorly absorbable recording medium or a non-absorbable recording medium.

Further, the ink jet ink composition may be used to perform recording on a non-absorbable recording medium made of polyolefin or polyethylene terephthalate.

According to another aspect of the present embodiment, there is provided an ink producing method for producing the aforementioned ink jet ink composition, the method including performing by using polymer particles.

According to yet another aspect of the present embodiment, there is provided a recorded product obtained by recording with the aforementioned ink jet ink composition on a poorly absorbable recording medium or a non-absorbable recording medium.

Further, the recorded product may be obtained by recording on the non-absorbable recording medium made of polyolefin or polyethylene terephthalate.

According to yet another aspect of the present embodiment, there is provided an ink jet recording method including: ejecting the aforementioned ink jet ink composition from an ink jet head and causing the ink jet ink composition to adhere to a recording medium.

The second disclosure can be configured as follows.

An aspect of an ink jet ink composition according to the present disclosure is as follows.

### Aspect 1

An ink jet ink composition containing polymer particles, in which the polymer particles include polymer particles A and polymer particles B, the polymer particles A is constituted of a urethane resin having a structure derived from one or more kinds selected from dicyclohexylmethane diisocyanate, isophorone diisocyanate, and 1,3-bis(isocyanatemethyl)cyclohexane and a structure derived from polytetramethylene glycol, and the polymer particles B is constituted of a urethane resin having a structure derived from one selected from m-bis(isocyanatepropyl)benzene, m-bis(isocyanatemethyl)benzene, tolylene diisocyanate, and 4,4-diphenylmethane diisocyanate.

### Aspect 2

The ink jet ink composition according to aspect 1, in which the total content of the polymer particles A and the polymer particles B is 1% to 20% by mass with respect to the total mass of the ink composition.

### Aspect 3

The ink jet ink composition according to aspect 1 or 2, in which the polymer particles A and the polymer particles B are polymer particles having an acid value.

### Aspect 4

The ink jet ink composition according to any one of aspects 1 to 3, in which the polymer particles B have a structure derived from polyester polyol.

### Aspect 5

The ink jet ink composition according to any one of aspects 1 to 4, in which the polymer particles A and the polymer particles B have chains extended with alkyldiamine having 1 to 10 carbon atoms.

### Aspect 6

The ink jet ink composition according to any one of aspects 1 to 5, in which the molecular weight of the polytetramethylene glycol is 500 to 3000.

### Aspect 7

The ink jet ink composition according to any one of aspects 1 to 6, in which the ink composition contains a polyurethane resin having a fluorene group.

### Aspect 8

The ink jet ink composition according to any one of aspects 1 to 7, in which the ink composition further contains a polyolefin-based wax agent.

### Aspect 9

The ink jet ink composition according to any one of aspects 1 to 8, in which the ink composition contains a silicone-based surfactant or an acetylene glycol-based surfactant.

### Aspect 10

The ink jet ink composition according to any one of aspects 1 to 9, in which the polymer particles A and the polymer particles B are produced by performing a reaction between isocyanate and polyol in an organic solvent and performing a chain extending reaction using polyamine in a water-based solvent.

### Aspect 11

The ink jet ink composition according to any one of aspects 1 to 10, in which the ink composition is used for recording on a poorly absorbable recording medium or a non-absorbable recording medium.

### Aspect 12

The ink jet ink composition according to Aspect 11, in which the ink composition is used for recording on the non-absorbable recording medium made of polyolefin or polyethylene terephthalate.

### Aspect 13

The ink jet ink composition according to any one of aspects 1 to 12, in which the ink composition is used for recording on a recorded product to be used by performing a laminating process on a recording surface and for recording on a recorded product used without performing the laminating process on the recording surface.

### Aspect 14

A recorded product obtained by performing recording with the ink jet ink composition according to any one of aspects 1 to 13 on a poorly absorbable recording medium or a non-absorbable recording medium.

### Aspect 15

The recorded product according to aspect 14, in which the recording is performed on the non-absorbable recording medium made of polyolefin or polyethylene terephthalate.

### Aspect 16

An ink jet recording method including: ejecting the ink jet ink composition according to any one of aspects 1 to 13 from an ink jet head and causing the ink composition to adhere to a recording medium.

### DESCRIPTION OF EXEMPLARY EMBODIMENTS

Hereinafter, some embodiments of the first disclosure will be described. The embodiments described below describe examples of the present disclosure. The present disclosure is not limited to the following embodiments at all and includes various modifications implemented within a range in which the gist of the present disclosure is not changed. Note that not all of the configurations described below are necessarily essential configurations of the present disclosure.

### 1. Ink Jet Ink Composition

An ink jet ink composition according to the present embodiment contains polymer particles, and a polymer constituting the polymer particles has a urethane group derived from one or more isocyanates selected from dicyclohexylmethane diisocyanate, isophorone diisocyanate, 1,3-bis(isocyanatemethyl)cyclohexane, m-bis(isocyanatepropyl) benzene, and m-bis(isocyanatemethyl)benzene and a skeleton derived from polytetramethylene glycol and has an acid value of 50 to 100 mgKOH/g.

If such an ink jet ink composition is applied to an ink jet ink, successive printing stability is satisfied, and also excellent blocking resistance and delamination resistance of a printed product are achieved. In other words, since the position at which an isocyanate group is bonded in all of the one or more kinds selected from dicyclohexylmethane diisocyanate, isophorone diisocyanate, 1,3-bis(isocyanatemethyl)cyclohexane, m-bis(isocyanatepropyl)benzene, and m-bis(isocyanatemethyl)benzene is a position at which neither crystallization nor stacking is likely to occur when a polymer is obtained through polymerization, it is possible to form an image with excellent blocking resistance and delamination resistance on a printed product. Also, since the acid value is equal to or greater than 50 mgKOH/g and equal to or less than 100 mgKOH/g, interactions with other components (water, a pigment, and the like) contained in the ink jet ink composition fall within appropriate ranges. It is thus possible to secure satisfactory successive printing stability.

In this manner, the successive printing stability is satisfied, and also excellent blocking resistance and delamination resistance are achieved when printing is performed on a film or the like.

The ink jet ink composition according to the present embodiment contains polymer particles. First, the polymer constituting the polymer particles will be described. Then, the other components will be described.

### 1.1 Polymer

The polymer particles contained in the ink jet ink composition according to the present embodiment is ones obtained using one or more isocyanates selected from dicyclohexylmethane diisocyanate, isophorone diisocyanate, 1,3-bis(isocyanatemethyl)cyclohexane, m-bis(isocyanatepropyl)benzene, and m-bis(isocyanatemethyl)benzene. In other words, the polymer particles have a group derived from such isocyanate. The group has one or more groups selected from a urethane group and a urea group. In particular, the group has a urethane group.

Since the position at which the isocyanate group is bonded is a position at which neither crystallization nor stacking is likely to occur when a polymer is obtained through polymerization in such isocyanate, it is possible to form an image with excellent blocking resistance and delamination resistance.

### 1.1.1. Overview of Polymer

The polymer contained in the ink jet ink composition according to the present embodiment has one or more groups (bonds) selected from a urethane group (urethane bond) and a urea group (urea bond) derived from one or more diisocyanates selected from dicyclohexylmethane diisocyanate, isophorone diisocyanate, 1,3-bis(isocyanatemethyl)cyclohexane, m-bis(isocyanatepropyl)benzene, and m-bis(isocyanatemethyl)benzene. Therefore, it is possible to refer the polymer as a urethane resin (polyurethane) in the specification.

The polymer contained in the ink jet ink composition according to the present embodiment is a resin polymerized using polyisocyanate, and the polymerization is performed using at least polyisocyanate, polyol, and polyamine, and if needed, polyol and polyamine that are a crosslinking agent and a chain extender.

The polymer is a polymer including one or more groups selected from a urethane bond (urethane group) obtained through a reaction between an isocyanate group and a hydroxyl group and a urea bond (urea group) generated through a reaction between an isocyanate group and an amino group and may be linear or branched.

Further, the polymer includes one with thermoplasticity regardless of presence of a crosslinked structure and one, in which a crosslinked structure is formed, which does not exhibit Tg and a melting point at all or only slightly exhibits Tg and a melting point.

The isocyanate group for forming the urethane bond is supplied from a compound containing isocyanate groups. A hydroxyl group for forming the urethane bond is supplied from a compound including hydroxyl groups. For the polymerization, a compound that has two or more isocyanate groups is selected as the compound having the isocyanate groups, and a compound having two or more hydroxyl groups is selected as the compound having the hydroxyl groups. In the specification, the compounds having two or more isocyanate groups may be referred to as polyisocyanate, and the compounds having two or more hydroxyl groups may be referred to as polyol. Note that, among these, the compounds having two isocyanate groups may be referred to as diisocyanate while the compounds having two hydroxyl groups may be referred to as diol.

A molecular chain between the isocyanate groups in polyisocyanate, a molecular chain between the hydroxyl groups in polyol, and a molecular chain between amino groups in polyamine serve as portions other than the urethane bond and the urea bond in the case of polyurethane. In the specification, an entirety or a part of the portions other than the urethane bond or the urea bond in the case of polyurethane may be referred to as a skeleton. The skeleton may be linear or branched.

Also, the polymer may include a bond other than the urethane bond and the urea bond, and examples of such a bond include a urea bond generated through a reaction between a plurality of isocyanate bonds and water, a biuret bond generated through a reaction between a urea bond and an isocyanate group, an allophanate bond generated through a reaction between a urethane bond and an isocyanate group, an uretdione bond obtained through dimerization of an isocyanate group, and an isocyanurate bond obtained through trimerization of an isocyanate group. It is possible to control whether to actively generate or not generate these bonds depending on a reaction temperature and the like. Therefore, when polyisocyanate, polyol, and polyamine are present together, for example, a polymer including these bonds (groups) in addition to the urethane bond and the urea bond may be generated. Having an allophanate structure, a biuret structure, an uretdione structure, and an isocyanurate structure may increase adhesiveness to a medium, increase film strength, and provide satisfactory scratch resistance.

Note that in the specification, compounds having two or more amino groups will be referred to as polyamine similarly to how polyisocyanate and polyol described above are called, in regard to polyamine as well.

### 1.1.2. Raw Materials of Polymer

The polymer in the present embodiment is obtained through polymerization using at least diisocyanate and polyol, and the polymer used in the ink jet ink composition according to the present embodiment may be polymerized using polyamine, and it is also possible to further use polyol, polyamine, and the like as a crosslinking agent and a chain extender as needed.

### 1.1.2.1. Diisocyanate

Diisocyanate used for the polymer in the present embodiment is one or more kinds selected from dicyclohexylmethane diisocyanate, isophorone diisocyanate, 1,3-bis(isocyanatemethyl)cyclohexane, m-bis(isocyanatepropyl)benzene, and m-bis(isocyanatemethyl)benzene.

A chemical structure of such diisocyanate will be described below. Since it is possible to name such diisocyanate in various manners using common names or the like, diisocyanate has multiple different names. Thus, CAS numbers will be described together instead of notations of different names.

Dicyclohexylmethane diisocyanate: CAS=5124-30-1

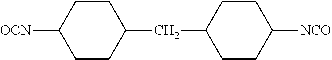

Isophoronediisocyanate: CAS=4098-71-9

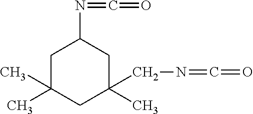 [SMILES: CC1(C)CC(N=C=O)CC(C)(CN=C=O)C1]

1,3-bis(isocyanatemethyl)cyclohexane: CAS=38661-72-2

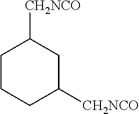

m-bis(isocyanatepropyl)benzene: CAS=2778-42-9

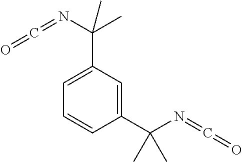 [SMILES: CC(C)(N=C=O)c1cccc(C(C)(C)N=C=O)c1]

m-bis(isocyanatemethyl)benzene: CAS=3634-83-1

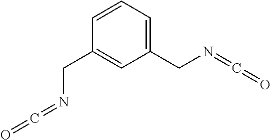 [SMILES: O=C=NCc1cccc(CN=C=O)c1]

When such diisocyanate is polymerized to become a polymer through formation of bonds with, for example, a hydroxyl group and an amino group, bonding is achieved at positions at which a cyclohexyl ring and a benzene ring are unlikely to be stacked or crystallized. In this manner, an excessive increase in density of a microphase separated structure and a crosslinked structure of microcrystals caused by the polymer (urethane resin) is curbed. It is thus possible to lower Tg (glass transition temperature) of the polymer and to enhance flexibility of the polymer. In this manner, it is possible to form an image with blocking resistance and delamination resistance on a printed product when the ink jet ink composition adheres to a recording medium.

In particular, isophorone diisocyanate, 1,3-bis(isocyanatemethyl)cyclohexane, and m-bis(isocyanatepropyl)benzene are preferably employed due to more excellent lamination resistance (delamination resistance) and blocking resistance.

Also, isophorone diisocyanate, 1,3-bis(isocyanatemethyl)cyclohexane, m-bis(isocyanatepropyl)benzene, and m-bis(isocyanatemethyl)benzene are polymerized to have such a structure that the cyclohexyl ring and the benzene ring are unlikely to be stacked or crystallized since the isocyanate group is allocated at a meta position of a six-membered ring (1,3-allocation). Similarly, dicyclohexylmethane diisocyanate has a bent structure although that is a symmetric structure, has a cyclohexyl ring structure, and thus has a structure with which crystallization is unlikely to occur. Therefore, when these are polymerized to form a polymer (urethane resin), an excessive increase in density of the microphase separated structure and the crosslinked structure of a microcrystal is curbed.

The dicyclohexylmethane diisocyanate may be a mixture of or a single substance selected from dicyclohexylmethane 4,4′-diisocyanate, dicyclohexylmethane 2,2′-diisocyanate, and dicyclohexylmethane 2,4′-diisocyanate. Furthermore, polyfunctional isocyanate of dimer or more of an arbitrary combination of these may be used. The polyfunctional polyisocyanate is a compound that has a structure of two or more molecules of polyisocyanate and has two or more isocyanate groups at terminals of the molecules to react with an OH group or an NH₂ group in polyol, polyamine, or the like. The polyfunctional polyisocyanate may include at least one selected from a group consisting of an allophanate structure, an uretdione structure, an isocyanurate structure, and a biuret structure.

The polyfunctional polyisocyanate preferably has a structure constituting of monomeric diisocyanate or two or more molecules of polymeric polyisocyanate and has many branches in the molecules. A polymer having a structure constituting of such polyfunctional polyisocyanate is brought in a state where a structure in which the molecules three-dimensionally tangled in a complicated manner and urethane bonds are concentrated. It is thus possible to stably disperse the polymer in a water-based ink even if the acid value is relatively low. Using such polyisocyanate enables successive printing stability to be secured and enables an image to be recorded to generate a printed product with excellent blocking resistance and delamination resistance.

### 1.1.2.2. Polyol

Polyol can be used as a raw material for the polymer contained in the ink jet ink composition according to the present embodiment. Polyol is a bifunctional or higher functional compound, that is, a compound having two or more hydroxyl groups. In the present embodiment, polytetramethylene glycol is used, in particular. In other words, a skeleton derived from polytetramethylene glycol is included. Also, this is preferably used as a main component from among several kinds of polyol used. Polytetramethylene glycol preferably constitutes 50% by mass or more of polyol used. The amount of polytetramethylene glycol is more preferably equal to or greater than 80% by mass. When polytetramethylene glycol is used, flexibility of the polymer (urethane resin) is improved, and it is possible to improve delamination resistance and blocking resistance when printing is performed on a film. Also, the weight-average molecular weight of polytetramethylene glycol is preferably equal to or greater than 250 and equal to or less than 4000 and is more preferably equal to or greater than 500 and equal to or less than 3000. In this case, a satisfactory balance between strength and flexibility of a film (image) formed by the polymer is achieved, and it is possible to achieve satisfactory blocking resistance and delamination resistance of a printed product, which is preferable.

A commercially available product can be used as polytetramethylene glycol, and examples thereof include PTMG650, PTMG1000, PTMG2000, PTMG3000, and PTMG4000 manufactured by Mitsubishi Chemical Corporation and PTG and PTMG-L manufactured by Hodogaya Chemical Co., Ltd.

By the polymer containing the skeleton derived from polytetramethylene glycol, it is possible to achieve satisfactory blocking resistance and delamination resistance of an obtained image. Further, when the weight-average molecular weight of the skeleton derived from polytetramethylene glycol falls within the aforementioned range, flexibility of a solidified substance of the ink jet ink composition becomes satisfactory, and adhesiveness to a plastic film of PET, OPP, or the like is improved, which is preferable.

The weight-average molecular weight of the skeleton derived from polytetramethylene glycol is further preferably equal to or greater than 1000 and equal to or less than 2500.

Also, polyol other than polytetramethylene glycol may further be used. Although polyol that can be used is not particularly limited, polyol with low solubility in water is preferably used. Examples of polyol include alkylene glycol, polyester polyol, polyether polyol, and polycarbonate diol. Polytetramethylene glycol and other polyol may be used in combination, which is preferable.

The following substances can be used as alkylene glycol. That is, examples thereof include ethylene glycol, diethylene glycol, triethylene glycol, polyethylene glycol, 1,2-propylene glycol, 1,3-propanediol, tripropylene glycol, polypropylene glycol, (poly)tetramethylene glycol, hexamethylene glycol, tetramethylene glycol, neopentyl glycol, 1,2-butanediol, 1,3-butanediol, 1,4-butanediol, 1,2-pentanediol, 1,5-pentanediol, 1,2-hexanediol, 1,6-hexanediol, 3-methyl-1,5-pentanediol, 1,2-cyclohexanediol, 1,4-cyclohexanediol, 1,4-cyclohexanedimethanol, 4,4-dihydroxyphenylpropane, 4,4-dihydroxyphenylmethane, glycerin, trimethylolethane, trimethylolpropane, 1,2,5-hexanetriol, 1,2,6-hexanetriol, pentaerythritol, trimethylolmelamine, polyoxypropylenetriol, dimethyl-1,3-pentanediol, diethyl 1,3-pentanediol, dipropyl-1,3-pentanediol, dibutyl-1,3-pentanediol, 2-butyl-2-ethyl-1,3-propanediol and the like. Among these, 1,4-cyclohexanediol, 1,4-cyclohexanedimethanol, 4,4-dihydroxyphenylpropane, 4,4-dihydroxyphenylmethane, dimethyl-1,3-pentanediol, diethyl-1,3-pentanediol, dipropyl-1,3-pentanediol, dibutyl-1,3-pentanediol, and 2-butyl-2-ethyl-1,3-propanediol are preferably used.

If alkylene glycol is used as a raw material for the polymer, alkylene glycol with a small molecular weight may penetrate into the three-dimensional network structure formed in the polymer and react with isocyanate to form a urethane bond, resulting in a stronger coating film. This may increase the strength of the coating film (image), and the blocking resistance and the delamination resistance of the printed product may be further improved. However, the amount of addition of these substances is preferably equal to or less than 10%. The amount of addition of these substances is more preferably equal to or less than 5%.

Since the molecular weight of alkylene glycol itself is small, the urethane group may excessively increase through a reaction between a hydroxyl group and an isocyanate group, flexibility may be lost, and the blocking resistance and the delamination resistance may be likely to deteriorate. Therefore, these are basically urethane groups or allophanate groups, which are the hard segments of the polymer. Note that alkylene glycol can also be used as a component to cause a reaction with polyfunctional polyisocyanate, a chain extender, a crosslinking agent, or the like and can also be used to control physical properties of the polymer.

When polyol is used as a raw material for the polymer, the weight-average molecular weight thereof is preferably equal to or greater than 500 and equal to or less than 3000. When the weight-average molecular weight is equal to or greater than 500, the density of urethane bonds in the polymer does not excessively increase, and it is possible to curb stiffness of molecular chains derived from polyol. The flexibility of the polymer is thus enhanced, and satisfactory blocking resistance and delamination resistance of a printed product are achieved. When the weight-average molecular weight of polyol that causes a reaction with polyisocyanate is equal to or less than 3000, the density of urethane bonds in the polymer does not excessively decreases, stretchability of molecular chains derived from polyol does not excessively increases, flexibility of the polymer is curbed, tackiness is thus unlikely to be caused, and it is possible to secure the blocking resistance and the delamination resistance of a printed product. Therefore, since a balance between the strength and the flexibility of the film (image) formed by the polymer is improved by the weight-average molecular weight of polyol being equal to or greater than 500 and equal to or less than 3000, it is possible to achieve satisfactory blocking resistance and delamination resistance of a printed product.

Examples of polyester polyol include acid ester. Examples of an acid component constituting acid ester include aliphatic dicarboxylic acids such as a malonic acid, a succinic acid, a tartaric acid, an oxalic acid, a glutaric acid, an adipic acid, a pimelic acid, a suberic acid, an azelaic acid, a sebacic acid, an alkylsuccinic acid, a linolenic acid, a maleic acid, a fumaric acid, a mesaconic acid, a citraconic acid, and an itaconic acid, and alicyclic dicarboxylic acids such as a phthalic acid, a naphthalene dicarboxylic acid, a biphenyl dicarboxylic acid, a tetrahydrophthalic acid, and aromatic hydrogenated products. Anhydrides, salts, alkyl esters, acid halides and the like of these acid components can also be used as the acid components. Examples of an alcohol component constituting the acid ester include the aforementioned diol compounds and are not particularly limited. However, those having low solubility in water are preferably used.

Examples of polyether polyol include addition polymerization products of alkylene oxides and condensation polymerization products of polyols such as (poly)alkylene glycol. Examples of alkylene oxide include ethylene oxide, propylene oxide, butylene oxide, α-olefin oxide, and the like. Examples of (poly)alkylene glycol include polyethylene glycol (polyoxyethylene glycol), polypropylene glycol (polyoxypropylene glycol), and the like.

Polycarbonate diol contains two hydroxyl groups and a molecular chain having a carbonate bond.

Examples of polycarbonate diol that can be used as a part of polyol in the present embodiment include carbonate components such as alkylene carbonate, diaryl carbonate, and dialkyl carbonate, phosgene, polycarbonate diol obtained through a reaction of an aliphatic polyol component, and further alkanediol-based polycarbonate diols such as polyhexamethylene carbonate diol. By using polycarbonate diol as a starting material for the polymer, heat resistance and hydrolysis resistance of the generated polymer tend to become satisfactory.

Using polycarbonate diol as polyol causes the polymer to have a skeleton derived from polycarbonate diol, and it is thus possible to achieve further satisfactory blocking resistance and delamination resistance of an obtained printed product.

Polycarbonate diol suitable as a raw material for the polymer in the present embodiment generally has two hydroxyl groups in the molecule and can be obtained through a transesterification reaction between a diol compound and a carbonic acid ester. Examples of such a diol compound include 1,4-butanediol, 1,3-butanediol, 1,2-butanediol, 1,5-pentanediol, 1,2-pentanediol, 1,6-hexanediol, 1,5-hexanediol, 1,2-hexanediol, 1,7-heptanediol, 1,8-octanediol, 1,2-octanediol, 1,9-nonanediol, 1,10-decanediol, neopentyl glycol, 4-methyl-1,5-pentanediol, 2-methyl-1,3-propanediol, 2-methyl-1,8-octanediol, 2-isopropyl-1,4-butanediol, 2-ethyl-1,6-hexanediol, 3-methyl-1,5-pentanediol, 2,4-dimethyl-1,5-pentanediol, 2,4-diethyl-1,5-pentanediol, 1,3-butanediol, 2-ethyl-1,3-hexanediol, 2-butyl-2-ethyl-1,3-propanediol, 1,4-cyclohexanedimethanol, 1,3-cyclohexanediol, 1,4-cyclohexanediol, and the like. One of these can be used alone, or two or more of these can be used in combination. Among the aforementioned diols, neopentyl glycol, 4-methyl-1,5-pentanediol, 2-methyl-1,3-propanediol, 2-methyl-1,8-octanediol, 2-isopropyl-1,4-butanediol, 2-ethyl-1,6-hexanediol, 3-methyl-1,5-pentanediol, 2,4-dimethyl-1,5-pentanediol, and 2,4-diethyl-1,5-pentanediol which are more unlikely cause crystallization are more preferably used.

Although carbonic acid ester that can be used for producing polycarbonate diol is not limited as long as the advantages of the present disclosure are not impaired, examples thereof include dialkyl carbonate, diaryl carbonate, and alkylene carbonate. Among these, diaryl carbonate is preferably used in terms of reactivity. Specific examples of the carbonate compound include dimethyl carbonate, diethyl carbonate, dibutyl carbonate, diphenyl carbonate, ethylene carbonate, and the like, and diphenyl carbonate is more preferably used.

Examples of commercially available polycarbonate diols include NL1010DB, NL2010DB, NL3010DB, NL1010B, NL2010B, NL3010B, NL1050DB, NL2050DB, and NL3050DB from BENEBiOL series of Mitsubishi Chemical Corporation, Duranol series of Asahi Kasei Chemicals Corporation, Nipolon series of Tosoh Corporation, polyhexanediol carbonate of Kuraray Co., Ltd., Placcel series and CDCD205PL of Daicel Corporation, ETERNACOLL series of Ube Industries, Ltd., and the like.

As a raw material of the polymer contained in the ink jet ink composition in the present embodiment, an acid group is more preferably present in the molecule of polyol.

In this case, the acid value can be easily adjusted to be equal to or greater than 50 mgKOH/g and equal to or less than 100 mgKOH/g. Also, since fixability of a formed image to a recording medium can be further improved, excellent blocking resistance and delamination resistance are achieved.

Examples of acid group-containing diol include a dimethylolacetic acid, a dimethylolpropionic acid, a dimethylolbutanoic acid, a dimethylolbutyric acid, and the like. Examples of the acid group include organic acid groups as described above, and in particularly, a carboxyl group is exemplified. Further, a dimethylolpropionic acid and a dimethylolbutanoic acid are further preferably used among these. When the ink jet ink composition of the present embodiment is a water-based ink composition, the polymer is more preferably polymerized using such an acid group-containing diol as a raw material.

In this case, the acid value can be particularly easily adjusted to be equal to or greater than 50 mgKOH/g and equal to or less than 100 mgKOH/g. Also, since further satisfactory fixability of a formed image to a recording medium can be achieved, excellent blocking resistance and delamination resistance are achieved.

The polymer polymerized using such a component is composed mainly of two segments, namely a hard segment and a soft segment. The hard segment is constituted of polyisocyanate, short-chain polyol, polyamine, a crosslinking agent, a chain extender, and the like and mainly contributes to strength of the polymer. On the other hand, the soft segment is constituted of long-chain polyol and the like and mainly contributes to flexibility of the resin. Then, the ink jet ink composition is caused to adhere to a recording medium, these hard segment and soft segment have a microphase separated structure in a coating film formed of such a polymer, and the coating film has thus strength, flexibility, and high elasticity. Such properties of a coating film contribute to an improvement in blocking resistance and delamination resistance of a printed product.

### 1.1.2.3. Other Starting Materials

### (Polyamine)

Raw materials of the polymer contained in the ink jet ink composition according to the present embodiment may contain polyamine. Although polyamine is not particularly limited as long as it is a compound having a bifunctional or higher functional amino group, a compound having high hydrophobicity is preferably used. By containing polyamine as a raw material, the polymer has a urea group.

As polyamine, aliphatic diamine and/or aromatic diamine may be used. In other words, the polymer may contain one or more skeletons selected from a skeleton derived from aliphatic diamine and a skeleton derived from aromatic diamine.

According to such an ink jet ink composition, more satisfactory flexibility of a solidified substance of the ink jet ink composition is achieved, and further satisfactory blocking resistance and delamination resistance of a printed product can be achieved.

As polyamine, polyamine having 1 to 10 carbon atoms may be used in the polymer. In other words, the polymer may contain a skeleton derived from polyamine having 1 to 10 carbon atoms.

According to such an ink jet ink composition, more satisfactory flexibility of a solidified substance of the ink jet ink composition is achieved, and further satisfactory blocking resistance and delamination resistance of a printed product can be achieved.

Examples of polyamines include aliphatic diamine such as ethylenediamine, propylenediamine, 2,2-dimethyl-1,3-propanediamine, 2-methyl-1,5-pentanediamine, trimethylhexanediamine, 2-butyl-2-ethyl-1,5-pentanediamine, 1,8-octanediamine, 1,9-nonanediamine, 1,10-decanediamine, isophoronediamine, and bicycloheptanedimethanamine, diethylenetriamine, hexylenediamine, triethylenetetramine, tetraethylenepentamine, xylylenediamine, diphenylmethanediamine, hydrogenated diphenylmethanediamine, hydrazine, polyamide polyamine, polyethylene polyimine, 1-amino-3-aminomethyl-3,5,5-trimethylcyclohexane, dicyclohexylmethanediamine, bicycloheptanedimethanamine, mensendiamine, diaminodicyclohexylmethane, isoprobilitin cyclohexyl-4,4′-diamine, 1,4-diaminocyclohexane, 1,3-bisaminomethylcyclohexane and the like.

Among these, polyamine having 1 to 10 carbon atoms is preferably used, aliphatic diamine such as 2,2-dimethyl-1,3-propanediamine, 2-methyl-1,5-pentanediamine, trimethylhexanediamine, 2-butyl-2-ethyl-1,5-pentanediamine, 1,8-octanediamine, 1,9-nonanediamine, 1,10-decanediamine, isophoronediamine, and bicycloheptanedimethanamine are preferably used, and isophoronediamine and bicycloheptanedimethanamine are further particularly preferably used.

Note that many general-purpose compounds as polyamine have molecular weights equivalent to that of short-chain polyol and are basically urea groups or biuret groups that are hard segments of the polymer.

Note that polyamine can also be used as a component that causes a reaction with polyfunctional polyisocyanate, a chain extender, a crosslinking agent, or the like, and a urea bond is formed when a reaction is cased between the isocyanate group and the amino group. Therefore, when polyamine is used, it is also possible to control physical properties of the polymer by determining the amount of used polyamine such that a ratio of the urea group/the urethane group becomes a desired ratio in the polymer.

As methods for adjusting the ratio of the urea group/the urethane group in the polymer, there are a method of adjusting the amount of used amine compound (polyamine) in consideration of the equivalent amount of amino group in the amine compound when the polymer is synthesized, a method of adjusting the remaining rate of unreacted isocyanate group when the polymer is transferred into a water phase, and the like.

According to the method of adjusting the amount of used polyamine when the polymer is synthesized, the amount of urea bond generated through a reaction between polyamine and the isocyanate group is controlled. First, a plurality of types of polymers are synthesized with different amounts of polyamine used, and the ratio of the urea group/the urethane group is calculated. A relationship between the amount of used polyamine and the molar ratio is examined from the obtained molar ratio to create a calibration curve, and the amount of used polyamine required to synthesize the polymer having a desired molar ratio is determined using the calibration curve. Note that the calibration curve was created in advance because a reaction rate and the like may change if components other than polyamine are different even when the same kind of polyamine is used and the same molar ratio is thus not obtained.

As the method of adjusting the remaining rate if unreacted isocyanate group when the polymer is phase-transferred to water, the remaining rate of isocyanate group with respect to the amount of used polyisocyanate is checked using a Fourier transform-type infrared spectrophotometer (FT-IR) first in the process of a polymer synthesis reaction. The remaining rate of isocyanate group can be adjusted by changing the reaction time, the amount of used polyisocyanate, and the like.

### Crosslinking Agent and Chain Extender

The polymer in the present embodiment may contain a crosslinking agent and/or a chain extender.

The crosslinking agent is used to synthesize the prepolymer, and the chain extender is used to cause a chain extending reaction after the synthesis of the prepolymer. As the crosslinking agent and the chain extender, it is possible to appropriately select and use ones from polyisocyanates, polyol, polyamine, and the like described above in accordance with applications such as crosslinking, chain extension, and the like.

The chain extender is, for example, a compound that causes a reaction with an isocyanate group in the above polyisocyanates that does not form a urethane bond. Examples of the compound that can be used as the chain extender include polyol, polyamine, and the like described above. It is also possible to use a compound capable of crosslinking the polymer as the chain extender. Examples of the compound that can be used as the chain extender include low molecular weight polyols, polyamines, and the like having a number average molecular weight of less than 500.

Examples of the crosslinking agent include trifunctional or higher functional polyisocyanate, polyol, and polyamine. Examples of trifunctional or higher polyfunctional polyisocyanate include polyisocyanate having an isocyanurate structure and polyisocyanate having an allophanate or biuret structure. As polyol, glycerin, trimethylolpropane, pentaerythritol, polyoxypropylenetriol, or the like can be used. Examples of trifunctional or higher functional polyamine include trialcoholamine such as triethanolamine and triisopropanolamine, and trifunctional or higher functional amines having an amino group such as diethylenetriamine and tetraethylenepentamine.

Note that whether the polymer has been crosslinked can be determined based on a gel fraction calculated by calculating a ratio of a gel content and a sol content using a phenomenon in which the polymer with a crosslinked structure is not dissolved in a solvent and swells. The gel fraction is an index of a degree of crosslinking measured from solubility of the solidified polymer, and the higher the degree of crosslinking is, the higher the gel fraction tends to be.

### Other Isocyanates

In the polymer contained in the ink jet ink composition of the present embodiment, isocyanate other than the aforementioned isocyanate (diisocyanate) may be used as a raw material as long as the functions and effects described above are not impaired. Examples of such isocyanate include aliphatic polyisocyanates, aromatic polyisocyanate, and alicyclic polyisocyanate.

Examples of the aliphatic polyisocyanate include polyisocyanate having a chain structure such as tetramethylene diisocyanate, hexamethylene diisocyanate, dodecamethylene diisocyanate, 2,2,4-trimethylhexamethylene diisocyanate, 2,4,4-trimethylhexamethylene diisocyanate, lysine diisocyanate, 2-methylpentane-1,5-diisocyanate, and 3-methyl-1,5-pentane diisocyanate.

Aromatic polyisocyanate can also be used. Examples thereof include tolylene diisocyanate, 1,4-phenylene diisocyanate, and 1,5-naphthylene diisocyanate. When aromatic polyisocyanate is used, blocked alicyclic polyisocyanate in which not less than 80% of the aromatic rings of the aromatic polyisocyanate are hydrogenated may be used.

Examples of alicyclic polyisocyanate include 1,4-cyclohexane diisocyanate and hydrogenated xylylene diisocyanate (hydrogenated XDI).

The strength of the formed film may be enhanced, and satisfactory blocking resistance and delamination resistance may be achieved, using such polyisocyanate. The strength of the film is further enhanced, and further satisfactory blocking resistance and delamination resistance are achieved, using alicyclic polyisocyanate described above, in particular. Further, a plurality of types of such polyisocyanate may be mixed and used.

Further, polyisocyanate may have a structure constituted of two or more molecules of polyisocyanate. The structure constituted of two or more molecules of polyisocyanate is, for example, a uretdione structure or an isocyanurate structure. When such polyisocyanate is selected, the polymer is brought into a state in which a structure in which the molecules three-dimensionally tangled in a complicated manner and urethane bonds are concentrated. Therefore, it is possible to stably disperse the polymer in a water-based ink even at a low acid value, for example.

Generally, degradation of successive printing stability is caused mainly by evaporation of water from nozzles of an ink jet head. One of elements to improve the successive printing stability is to maintain a state in which a pigment and a resin are stably dispersed without aggregation even when water is evaporated from the ink composition that is present in the vicinity of the nozzles of the ink jet head to some extent and an interaction between the polymer and the pigment is enhanced. Since the polymer in the present embodiment has a structure in which it is three-dimensionally entangled in a complicated manner by including the aforementioned structure constituted of polyisocyanate as described above regardless of a relatively low acid value, repulsion is likely to occur due to an electrostatic effect, a repulsive force, and the like between the polymer and the pigment even if evaporation of water advances, and a stable dispersed structure can easily be obtained.

In this specification, the skeleton of the polymer denotes a molecular chain between functional groups. Therefore, the polymer in the present embodiment has a skeleton derived from a molecular chain of a raw material such as polyisocyanate, polyol, or polyamine. Other skeletons are not particularly limited and may be, for example, a substituted or unsubstituted saturated, unsaturated, or aromatic chain and have a carbonate bond, an ester bond, an amide bond, or the like. The type and the number of substituents in such a skeleton are not particularly limited, and an alkyl group, a hydroxyl group, a carboxyl group, an amino group, a sulfonyl group, a phosphonyl group, or the like may be included.

### 1.1.3. Synthesis and Analysis of Polymer

### Synthesis of Polymer

The polymer used in the ink jet ink composition in the present embodiment can be synthesized using a known method as a polymer polymerization method. Hereinafter, description will be given based on an example. Polyisocyanate and a compound that causes a reaction therewith (polyol and if needed polyamine or the like) are made to cause a reaction such that the amounts of use thereof are adjusted to increase isocyanate groups, and a prepolymer having the isocyanate groups at terminals of molecules is polymerized. At this time, it is preferable to carry out the reaction in an organic solvent. At this time, an organic solvent having a boiling point of equal to or less than 100° C., such as methyl ethyl ketone, acetone, or tetrahydrofuran, may be used as needed. This is generally called a prepolymer method.

When acid group-containing diol is used as a raw material, the acid group in the prepolymer is neutralized using a neutralizing agent such as an organic base such as N,N-dimethylethanolamine, N,N-diethylethanolamine, diethanolamine, triethanolamine, triisopropanolamine, trimethylamine, or triethylamine, an inorganic base such as sodium hydroxide, potassium hydroxide, or ammonia, or the like. Preferably, a neutralizing agent containing alkali metal such as sodium hydroxide or potassium hydroxide is used, thereby improving polymer dispersion stability. The viscosity is unlikely to increase, and operability is improved by using preferably 0.5 to 1.0 mol of such neutralizing agent, or more preferably 0.8 to 1.0 mol of such neutralizing agent per mol of acidic group included in the prepolymer.

Thereafter, the prepolymer is added to a solution containing a chain extender and a crosslinking agent to cause a chain extending reaction and a crosslinking reaction. In the case in which an organic solvent is used, the organic solvent is then removed using an evaporator, thereby obtaining a polymer dispersion. When the chain extending reaction and the crosslinking reaction are carried out, the reactions are preferably carried out in water (aqueous solvent). The water-based solvent is a solution containing at least water as a main solvent.

As a catalyst used for the polymer polymerization reaction, a titanium catalyst, an aluminum catalyst, a zirconium catalyst, an antimony catalyst, a germanium catalyst, a bismuth catalyst, or a metal complex-based catalyst is satisfactorily used. Particularly preferable titanium catalyst is specifically tetraalkyl titanate such as tetrabutyl titanate or tetramethyl titanate or an oxalic acid metal salt such as potassium titanium oxalate. Although other catalysts are not particularly limited as long as the catalysts are known catalysts, examples thereof include tin compounds such as dibutyltin oxide and dibutyltin dilaurylate. It is known from long time ago that an acetylacetonate complex of transition metal such as titanium, iron, copper, zirconium, nickel, cobalt, or manganese has a urethane-forming activity as a non-heavy metal catalyst. In recent years, low toxic catalysts that can replace heavy metal catalysts have been desired due to increasing environmental awareness, and in particular, high urethane-forming activity of titanium/zirconium compounds has been attracting attention.

In the ink jet ink composition according to the present disclosure, the contained polymer is preferably a polymer obtained by a method of performing a reaction of isocyanate, polytetramethylene glycol, and acid group-containing polyol in an organic solvent and performing chain extension of the obtained prepolymer with polyamine in an aqueous solvent.

According to this, the polymer can be easily and stably produced, and when the polymer is applied to an ink jet ink, it is possible to produce an ink jet ink composition capable of easily forming an image to generate a printed product with excellent blocking resistance and delamination resistance.

### Analysis of Polymer

Each of the composition of the polymer, the structure of polyisocyanate, and the acid value of the polymer can be analyzed by the following methods.

First, a method for extracting a polymer from an ink containing the polymer will be described. When the ink jet ink composition contains a pigment, it is possible to extract the polymer from the ink jet ink composition using an organic solvent (acetone, methyl ethyl ketone, or the like) that does not dissolve the pigment but dissolve the polymer. Alternatively, it is also possible to extract the polymer by isolating the ink jet ink composition through ultracentrifugation and acidifying the supernatant thereof with an acid.

### (A) Composition of Polymer

The polymer is dissolved in deuterated dimethyl sulfoxide (DMSO-d6) to prepare a sample, and the type of polyisocyanate, polyol, polyamine, or the like can be checked from positions of peaks obtained in analysis based on a proton nuclear magnetic resonance method (¹H-NMR) or a carbon 13 nuclear magnetic resonance method (¹³C-NMR). Further, it is also possible to calculate a composition ratio from a ratio of integrated values of peaks of chemical shift of the components. It is also possible to check the type of polyisocyanate, polyol, polyamine, or the like by analyzing the polymer based on pyrolytic gas chromatography (GC-MS). When the analysis is performed by the carbon 13 nuclear magnetic resonance spectrometry (¹³C-NMR), it is possible to obtain the number of repetitions of a unit of long-chain polyol and to calculate the number average molecular weight.

### (B) Structure of Polyisocyanate

The structure of polyisocyanate can be checked from an infrared absorption spectrum obtained through analysis of the polymer by Fourier transform infrared spectroscopy (FT-IR). The main absorption is as follows. In an allophanate structure, NH stretching vibration absorption is present at 3300 cm⁻¹, and 2 pieces of C═O stretching vibration absorption are present at 1750 to 1710 cm⁻¹ and 1708 to 1653 cm⁻¹. In a uretdione structure, C═O stretching vibration absorption is present at 1780 to 1755 cm⁻¹, and absorption based on the uretdione ring is present at 1420 to 1400 cm⁻¹. In an isocyanurate structure, C═O stretching vibration absorption is present at 1720 to 1690 cm⁻¹, and absorption based on the isocyanurate ring is present at 1428 to 1406 cm⁻¹. In a biuret structure, C═O stretching vibration absorption is present at 1720 to 1690 cm⁻¹.

### (C) Acid Value of Polymer

The acid value of the polymer can be measured by a titration method. For the acid value, measurement is performed using AT610 (product name) manufactured by Kyoto Electronics Manufacturing Co. Ltd., and the numerical value is applied to the following expression (1) to calculate the acid value.

Acid value (mg/g)=(EP1−BL1)×FA1×C1×K1/SIZE (1)

(In the above expression, EP1 is a titration amount (mL), BL1 is blank value (0.0 mL), FA1 is a factor of titrant (1.00), C1 is a concentration conversion value (5.611 mg/mL) (corresponding to 0.1 mol/L KOH 1 mL of potassium hydroxide), K1 is a coefficient (1), and SIZE is a sampling amount (g).)

Then, the acid value of the polymer dissolved in tetrahydrofuran can be measured by colloid titration using a potential difference. An ethanol solution of sodium hydroxide can be used as the titration reagent at this time.

### 1.1.4. Acid Value of Polymer

Although the acid value of the polymer can be measured as described above, the acid value of the polymer in the present embodiment is equal to or greater than 50 mgKOH/g and equal to or less than 100 mgKOH/g. In this manner, the interaction with the other components (water, a pigment, and the like) contained in the ink jet ink composition falls within an appropriate range. It is thus possible to secure satisfactory successive printing stability.

The acid value of the polymer is more preferably equal to or greater than 60 mgKOH/g and equal to or less than 95 mgKOH/g. Further, the acid value of the polymer is preferably 65 to 90 mgKOH/g, is more preferably 70 to 85 mgKOH/g, and is further preferably 75 to 85 mgKOH/g. When the acid value is equal to or greater than 50 mgKOH/g, satisfactory dispersion stability of the polymer in the water-based ink is achieved, clogging is unlikely to occur even at a high temperature, and delamination resistance is improved. On the other hand, when the acid value is equal to or less than 100 mgKOH/g, the polymer is less likely to swell with water, the viscosity of the ink is less likely to increase, and satisfactory blocking resistance is achieved.

The acid value of the polymer can be changed by, for example, adjusting the content of the skeleton derived from carboxyl group-containing glycol (acid group-containing polyol such as a dimethylolpropionic acid). When the ink jet ink composition according to the present embodiment is a water-based ink, a polymer that is carboxyl group-containing glycol and has a carboxyl group is preferably used so as to be able to be easily dispersed with water.

### 1.1.5. Content of Polymer

The ink jet ink composition in the present embodiment may contain a plurality of kinds of the aforementioned polymers. Also, the polymers may be added in the form of an emulsion. The total content of the polymers in the ink jet ink composition in the present embodiment is preferably equal to or greater than 1% and equal to or less than 20.0% and is more preferably equal to or greater than 2.0% and equal to or less than 15.0% on a mass basis (hereinafter, the units simply referred to as % indicate % by mass) as a solid content. Further, the total content is more preferably equal to or greater than 4.0% and equal to or less than 12.0%.

### 1.2. Other Components

### 1.2.1. Pigment

The ink jet ink composition in the present embodiment may contain a pigment, a dye, or the like as a coloring material. Since the ink jet ink composition in the present embodiment can cause the coloring material to be physically fixed to a recording medium due to the aforementioned polymer, a pigment is more preferably used as the coloring material. An image (recorded product) is formed by such a pigment adhering to the recording medium.

The pigment is not particularly limited, and examples of the pigment type include inorganic pigments such as carbon black, calcium carbonate, and titanium oxide, and organic pigments such as an azo pigment, an isoindolinone pigment, a diketopyrrolopyrrole pigment, a phthalocyanine pigment, a quinacridone pigments, and an anthraquinone pigments.

Examples of a black pigment include No. 2300, No. 900, MCF88, No. 33, No. 40, No. 45, No. 52, MA7, MA8, MA100, No. 2200B, and the like (all of which are manufactured by Mitsubishi Chemical Corporation), Raven 5750, Raven 5250, Raven 5000, Raven 3500, Raven 1255, Raven 700, and the like (all of which are manufactured by Columbia Carbon Co., Ltd.), Regal 400R, Regal 330R, Regal 660R, Mogul L, Monarch 700, Monarch 800, Monarch 880, Monarch 900, Monarch 1000, Monarch 1100, Monarch 1300, Monarch 1400, and the like. (all of which are manufactured by Cabot Corporation), Color Black FW1, Color Black FW2, Color Black FW2V, Color Black FW18, Color Black FW200, Color Black 5150, Color Black 5160, Color Black 5170, Printex 35, Printex U, Printex V, Printex 140U, Special Black 6, Special Black 5, Special Black 4A, and Special Black 4 (all of which are manufactured by Degussa Ltd.), and the like.

Examples of a white pigment include C.I. Pigment White 1 (basic lead carbonate), 4 (zinc oxide), 5 (a mixture of zinc sulfide and barium sulfate), 6 (titanium oxide), 6:1 (titanium oxide containing other metal oxides), 7 (zinc sulfide), 18 (calcium carbonate), 19 (clay), 20 (titanium mica), 21 (barium sulfate), 22 (natural barium sulfate), 23 (gloss white), 24 (alumina white), 25 (gypsum), 26 (magnesium oxide/silicon oxide), 27 (silica), 28 (anhydrous calcium silicate), and the like.

Examples of a yellow pigment include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, 180, and the like.

Examples of a magenta pigment include C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, and 245, C.I. Pigment Violet 19, 23, 32, 33, 36, 38, 43, and 50, and the like.

Examples of a cyan pigment include C.I. Pigment Blue 1, 2, 3, 15, 15:1, 15:2, 15:3, 15:34, 15:4, 16, 18, 22, 25, 60, 65, and 66, C.I. Vat Blue 4 and 60, and the like.

Examples of pigments other than black, white, yellow, magenta, and cyan pigments include C.I. Pigment Green 7 and 10, C.I. Pigment Brown 3, 5, 25, and 26, C.I. Pigment Orange 1, 2, 5, 7, 13, 14, 15, 16, 24, 34, 36, 38, 40, 43, and 63, and the like.

The pigments listed above can be used as at least one of a pigment having an anionic group bonded to the particle surfaces directly or via another atomic group (surface-treated pigment) and a pigment dispersed with a resin having an anionic functional group.

Examples of the pigment having an anionic group bonded to the particle surfaces directly or through another atomic group include those in which a functional group containing an anionic group is bonded to the surfaces of the pigment particles and those in which an anionic resin is bonded to the surfaces of the pigment particles. Examples of the pigment dispersed with a resin having an anionic functional group include those in which an anionic resin is physically adsorbed on the surfaces of pigment particles and those contained in an anionic resin.

A self-dispersion pigment in which a functional group containing an anionic group is bonded to the surfaces of the pigment particles is obtained by an anionic group such as —COOM, —SO₃M, —PO₃HM, or —PO₃M₂ being bonded to the surfaces of the pigment particles directly or through another atomic group. Examples of M include organic amines such as a hydrogen atom, lithium, sodium, potassium, ammonium (NH₄), methylamine, ethylamine, monoethanolamine, diethanolamine, and triethanolamine. Examples of another atomic group include a linear or branched alkylene group having 1 to 12 carbon atoms, a phenylene group, a naphthylene group, an amide group, a sulfonyl group, an amino group, a carbonyl group, an ester group, an ether groups, and groups as combinations of these groups.

As these self-dispersion pigments, those in which an anionic group is bonded to the surfaces of the pigment particles through an oxidation treatment by a known method and those in which a functional group including an anionic group such as diazo coupling is bonded to the surfaces of the pigment particles are exemplified, and both can be suitably used. In the self-dispersion pigment in which an anionic resin is bonded to the surfaces of the pigment particles, the resin having a unit that has at least an anionic group as a hydrophilic unit is bonded to the surfaces of the pigment particles directly or through an atomic group.

Both the resin-dispersed pigment in which an anionic resin is physically adsorbed on the surfaces of the pigment particles and the resin-dispersed pigment which is contained in the anionic resin are based on dispersion methods using a resin dispersant. As the resin dispersant, a copolymer having a hydrophilic group and a hydrophobic group is used.

As the resin dispersant used for the self-dispersion pigment or the resin-dispersed pigment, any known resin that can be used in ink jet ink can be used. As a suitable resin dispersant, the hydrophilic group preferably contains at least an anionic group. Examples of the hydrophilic group include those based on a hydrophilic monomer such as a (meth)acrylic acid or a salt thereof. Further, examples of the hydrophobic group include a functional group based on a hydrophobic monomer such as styrene or a derivative thereof, a monomer having an aromatic ring such as benzyl (meth)acrylate, a monomer having an aliphatic group such as (meth)acrylic acid ester, or the like.

The resin used as the resin dispersant preferably has a weight-average molecular weight of equal to or greater than 10,000 and equal to or less than 100,000 and further preferably has a weight-average molecular weight of equal to or greater than 30,000 and equal to or less than 80,000 and also has an acid value of equal to or greater than 50 mgKOH/g and equal to or less than 150 mgKOH/g. In the present disclosure, it is more preferable to use a styrene-(meth)acrylic resin or a (meth)acrylic resin having an acid value of equal to or greater than 50 mgKOH/g and equal to or less than 150 mgKOH/g as a dispersant. When a dispersion method using a dispersant is used, the mass ratio of the resin dispersant/the pigment is preferably equal to or greater than 0.1 times and equal to or less than 10.0 times and is further preferably equal to or greater than 0.5 times and equal to or less than 5.0 times.

When an adhesion target of the ink jet ink composition in the present embodiment is a recording medium such as a transparent or semi-transparent film, and if an inorganic pigment (white pigment) is used when some pigment is used, it is possible to form a base layer (a first layer, which will be described later) with excellent fixability and scratch resistance and to produce a recorded product with satisfactory background shielding properties due to such a base layer.

A plurality of kinds of these exemplified pigments may be used. The total content of pigments (solid content) in the ink jet ink composition may differ depending on the types of used pigments, and the total content is preferably equal to or greater than 0.1% by mass and equal to or less than 15.0% by mass and is further preferably equal to or greater than 1.0% by mass and equal to or less than 10.0% by mass in the case of a color ink when the total mass of the ink jet ink composition is defined as 100% by mass in terms of satisfactory coloring properties. In the case of a white ink, the total content is preferably equal to or greater than 0.1% by mass and equal to or less than 20.0% by mass and is further preferably equal to or greater than 1.0% by mass and equal to or less than 15.0% by mass.

Note that when the ink jet ink composition is prepared, a pigment dispersion with a pigment dispersed therein may be prepared in advance, and the pigment dispersion may be added to the ink jet ink composition. As methods for obtaining such a pigment dispersion, there are a method of dispersing a self-dispersion pigment in a dispersion medium without using a dispersant, a method of dispersing a pigment in a dispersion medium using a polymer dispersant (resin dispersant), a method of dispersing a surface-treated pigment in a dispersion medium, and the like.

### 1.2.2. Water

The ink jet ink composition according to the present embodiment may contain water. Examples of water include pure water such as ion-exchanged water, ultrafiltered water, reverse osmosis water, and distilled water and water from which ionic impurities have been removed as much as possible such as ultrapure water. Also, when water sterilized through irradiation with an ultraviolet ray, addition of hydrogen peroxide, or the like is used, it is possible to prevent bacteria and fungi from being generated when the ink jet ink composition is stored for a long period of time.

The content of water is equal to or greater than 30% by mass, is preferably equal to or greater than 40% by mass, is more preferably equal to or greater than 45% by mass, and is further preferably equal to or greater than 50% by mass with respect to the total amount of ink jet ink composition. Note that the water in the ink jet ink composition described herein is defined as including water from a polymer particle dispersion, a pigment dispersion, added water, and the like used as raw materials, for example. When the content of water is equal to or greater than 30% by mass, the ink jet ink composition can have a relatively low viscosity. The upper limit of the content of water is preferably equal to or less than 90% by mass, is more preferably equal to or less than 85% by mass, and is further preferably equal to or less than 80% by mass with respect to the total amount of ink jet ink composition.

The ink jet ink composition according to the present embodiment is more preferably a water-based ink containing water. The polymer is thus easily dispersed in the form of an emulsion, and it is possible to easily form an image with further excellent fixability and scratch resistance by the ink jet method. The water-based ink is an ink containing at least water as a main solvent and is an ink containing equal to or greater than 30% by mass of water.

### 1.2.3. Water-Soluble Organic Solvent

The ink jet ink composition in the present embodiment may include a water-soluble organic solvent. By including the water-soluble organic solvent, it is possible to achieve excellent ejection stability of the ink jet ink composition in the ink jet method and to effectively curb moisture evaporation from the recording head caused by leaving the recording head for a long period of time.

The water-soluble organic solvent is not particularly limited as long as it is water-soluble, and it is possible to use nitrogen-containing polar solvents including monovalent or polyhydric alcohol, (poly)alkylene glycol, glycol ether, lactam such as ϵ-caprolactam, 2-pyrrolidone, and N-methyl-pyrrolidone, and lactone such as ϵ-caprolactone and δ-valerolactone, sulfur-containing polar solvents such as dimethyl sulfoxide (DMSO), acetin, and diacetin, and the like. Among these, a lactam structure is preferably used, and 2-pyrrolidone is preferably used. The content (% by mass) of the water-soluble organic solvent in the ink jet ink composition is preferably equal to or greater than 3.0% by mass and equal to or less than 50.0% by mass in total with reference to the total mass of the ink.

### 1.2.4. Surfactant

The ink jet ink composition in the present embodiment may contain a surfactant. As the surfactant, any of nonionic surfactants, anionic surfactants, cationic surfactants, and amphoteric surfactants can be used, and these may be used in combination. In particular, a silicone-based surfactant and an acetylene glycol-based surfactant are preferably used.

When a surfactant is blended in the ink jet ink composition, the amount of surfactant blended is equal to or greater than 0.01% by mass or equal to or less than 3% by mass, is preferably equal to or greater than 0.05% by mass and equal to or less than 2% by mass, is further preferably equal to or greater than 0.1% by mass and equal to or less than 1% by mass, and is particularly preferably equal to or greater than 0.2% by mass and equal to or less than 0.5% by mass with respect to the entire ink jet ink composition.

By the ink jet ink composition containing a surfactant, there is a trend that stability increases when the ink is ejected from the head.

### 1.2.5. Chelating Agent

The ink jet ink composition in the present embodiment may contain a chelating agent. The chelating agent has a characteristic of capturing ions. Examples of such a chelating agent include an ethylenediaminetetraacetic acid salt (EDTA), a nitrilotriacetic acid salt of ethylenediamine, hexametaphosphate, pyrophosphate, and metaphosphate.

### 1.2.6. Preservative

The ink jet ink composition in the present embodiment may contain a preservative. By containing a preservative, it is possible to curb growth of mold and bacteria and to achieve more satisfactory preservability of the ink composition. This facilitates utilization of the ink jet ink composition as a maintenance solution for maintaining the printer without using it for a long period of time, for example. Preferred examples of the preservative include Proxel CRL, Proxel BDN, Proxel GXL, Proxel XL-2, Proxel IB, and Proxel TN.

### 1.2.7. pH Adjuster

The ink jet ink composition in the present embodiment may contain a pH adjuster. By containing the pH adjuster, it is possible to curb or promote elution of impurities from a member forming an ink flow path and to adjust cleaning properties of the ink jet ink composition, for example. Examples of the pH adjuster include amino alcohols such as morpholines, piperazines, and triethanolamine.

### 1.2.8. Other Components

The ink jet ink composition according to the present embodiment may further contain a water-soluble organic compound that is a solid at an ordinary temperature such as polyhydric alcohols such as trimethylolpropane and trimethylolethane and urea derivatives such as urea and ethyleneurea, as needed. Further, various additives such as an antirust, a fungicide, an antioxidant, a reduction inhibitor, an evaporation accelerator, and a water-soluble resin may be contained as needed.

### 1.3. Method for Producing Ink Jet Ink Composition

Although the method for producing the ink jet ink composition in the present embodiment is not particularly limited, the ink jet ink composition can be produced as follows, for example.

First, when a polymer is polymerized, the polymer having a urethane group or a urea group derived from one or more kinds selected from dicyclohexylmethane diisocyanate, isophorone diisocyanate, 1,3-bis(isocyanatemethyl)cyclohexane, m-bis(isocyanatepropyl)benzene, and m-bis(isocyanatemethyl)benzene through a reaction in a methyl ethyl ketone solvent.

The ink jet ink composition can be produced by mixing the obtained polymer dispersion or polymer solution with the aforementioned components in an arbitrary order and removing impurities therefrom through filtration or the like as needed. As a method of mixing the components, a method of sequentially adding materials to a container equipped with a stirring device such as a mechanical stirrer or a magnetic stirrer and stirring and mixing the materials is suitably used.

### 1.3. Physical Properties of Ink Jet Ink Composition Surface Tension

The surface tension of the ink jet ink composition in the present embodiment at 20° C. is preferably equal to or greater than 20 mN/m and equal to or less than 40 mN/m and is more preferably equal to or greater than 20 mN/m and equal to or less than 35 mN/m in terms of a balance between image quality and reliability of the ink for ink jet recording. Note that the surface tension can be measured by checking the surface tension when a platinum plate is moistened with the ink in an environment at 20° C. using an automatic surface tension meter CBVP-Z (product name, manufactured by Kyowa Interface Science Co., Ltd.).

### Viscosity

The viscosity of the ink jet ink composition in the present embodiment at 20° C. is preferably equal to or greater than 3 mPa·s and equal to or less than 15 mPa·s and is more preferably equal to or greater than 3 mPa·s and equal to or less than 10 mPa·s from the similar viewpoint. The viscosity in the environment at 20° C. can be measured using a viscoelasticity tester MCR-300 (product name, manufactured by Pysica), for example.

### 1.4. Actions, Effects, and the Like

According to the ink jet ink composition in the present embodiment, it is possible to improve blocking resistance and delamination resistance of a printed product and also to maintain high successive printing stability by adding the aforementioned polymer thereto. The successive printing stability relates to an acid value of the polymer, and a high acid value leads to an increase in hydrophilicity of the polymer and an improvement in successive printing stability. However, when the acid value of the polymer is excessively high, there is a trend that blocking resistance of a printed product is degraded although the successive printing stability is improved. It is also known that the successive printing stability of the ink may be degraded depending on the form in which the polymer is contained in the ink jet ink composition. The delamination resistance also relates to the acid value of the polymer, and when the acid value is low, the polarity of the polymer decreases, and the delamination resistance is degraded. A preferable range of the acid value is equal to or greater than 50 mgKOH/g and equal to or less than 100 mgKOH/g.

Generally, degradation in successive printing stability is caused by evaporation of water mainly from the nozzles of the ink jet head. In order to enhance the successive printing stability, it is necessary to maintain a state in which the pigment and the resin are stably dispersed without aggregation even when water is evaporated from the ink that is present in the vicinity of the nozzles of the ink jet head to some extent and an interaction between the polymer and the pigment increases.

Since the polymer included in the ink jet ink composition in the present embodiment has a structure in which it is three-dimensionally tangled in a complicated manner, repulsion is likely to occur between the polymer and the pigment due to an electrostatic effect, a repulsive force, and the like even if evaporation of water advances. Thus, according to the ink jet ink composition in the present embodiment, blocking resistance and delamination resistance of a printed product are improved, a pigment dispersed state is stably maintained, and it is thus possible to improve successive printing stability.

Further, by appropriately blending isocyanate as in the polymer contained in the ink jet ink composition according to the present embodiment, blocking resistance and delamination resistance of a printed product are improved when printing is performed on a recording medium with high flatness such as a film.

Since the polymer is configured mainly of polyisocyanate and a component that reacts with polyisocyanate, a proportion at which short-chain polyol such as acid group-containing diol occupies is increased when the acid value of the polymer is increased to improve successive printing stability of the ink jet ink composition. Then, the proportion at which long-chain polyol that is a target component that reacts with polyisocyanate occupies decreases similarly to the short-chain polyol. This leads to an increase in urethane bond and a decrease in soft segment in the polymer, and flexibility of the polymer film is impaired. Therefore, when hydrophilicity of the polymer is increased by increasing the acid value thereof, successive printing stability of the ink jet ink composition is improved while blocking resistance of the image is degraded.

The acid value of the polymer contained in the ink jet ink composition in the present embodiment is set to 50 to 100 mgKOH/g, thereby securing successive printing stability of the ink jet ink composition. Also, by polymerizing the polymer using a raw material including specific diisocyanate, blocking resistance and delamination resistance of the printed product are improved.

Note that when recording is performed by the ink jet recording method, evaporation of water in the ink from the nozzles occurs when a state in which the ink is not ejected from the nozzles of the ink jet head continues for a certain period of time. When it is attempted to eject the next ink from the nozzles, ink droplets do not fly straight or cannot be ejected. The ink that causes such a phenomenon is regarded as having low successive printing stability.

### 1.4. Method for Producing Ink Jet Ink Composition

The method for producing the ink composition in the present embodiment is a method for producing an ink using the aforementioned polymer particles.

### 2. Recording Method

### 2.1. Recording Medium

A recording method according to the present embodiment is used as a recording method for performing recording on a recording medium using the ink jet ink composition. Hereinafter, examples of the recording medium used along with the recording method according to the present embodiment will be described.

Although the recording medium used in the recording method according to the present embodiment is not particularly limited, poorly absorbable or non-absorbable recording medium is preferably used. The poorly absorbable or non-absorbable recording medium denotes a recording medium with a characteristic that the recording medium does not absorb the ink at all or absorbs substantially no ink. Quantitatively, the recording medium used in the present embodiment denotes a “recording medium having a water absorption amount of equal to or less than 10 mL/m² in 30 msec^{1/2} from the start of contact in the Bristow method”. The Bristow method is a method that has most widely been distributed as a method for measuring the amount of absorbed solution in a short time, and is also employed by the Japan Pulp and Paper Technology Association (JAPAN TAPPI). Details of the test method are described in the standard No. 51 “Paper and Paperboard-Liquid Absorption Test Method-Bristow Method” of “JAPAN TAPPI Paper Pulp Test Method 2000 Edition”. Examples of the recording medium having such a non-absorbable characteristic include a recording medium having no ink-accepting layer with ink absorbability on the recording surface and a recording medium having a coating layer with small ink absorbability on the recording surface.

Although the non-absorbable recording medium is not particularly limited, examples thereof include a plastic film having no ink absorbing layer, a recording medium with a base material such as paper coated with plastic, and a recording medium with a plastic film adhering thereto. Examples of the plastic described here include polyvinyl chloride, polyethylene terephthalate, polycarbonate, polystyrene, polyurethane, polyethylene, and polypropylene.

Although the poorly absorbable recording medium is not particularly limited, examples thereof include a coated paper provided with a coating layer on the surface for accepting an oil-based ink. Although the coated paper is not particularly limited, examples thereof include printing papers such as an art paper, a coated paper, and a matte paper.

It is preferable to use the ink jet ink composition according to the present embodiment since it is possible to record a recorded product with excellent delamination resistance and blocking resistance even on such an ink non-absorbable or ink poorly absorbable recording medium. In addition, it is possible to more easily form a predetermined image with satisfactory fixability and satisfactory scratch resistance.

The ink composition in the present embodiment may be or is preferably an ink composition to be used for performing recording on a poorly absorbable or non-absorbable recording medium.

In the recording method according to the present embodiment, the recording medium that is a target of adhesion of the ink is preferably a poorly absorbable or non-absorbable recording medium, and in particular, the recording medium preferably contains, as a main component, polyolefin (polyethylene, polypropylene, or the like) and/or polyethylene terephthalate (PET). Since such a recording medium is a recording medium, to which adhesion is generally difficult, on which an image having good fixability can be formed, there are significant effects that satisfactory fixability and blocking resistance and delamination resistance of a printed product are achieved.

### 2.2. Recording Method

The recording method according to the present embodiment uses the ink jet ink composition described above. According to such a recording method, when the ink jet ink composition is ejected from an ink jet head onto a recording medium and is caused to adhere to the recording medium (adhesion step) to form an image layer, for example, it is possible to secure successive printing stability and to obtain an image with blocking resistance and delamination resistance of a printed product in a good balance.

The recording method in the present embodiment is a method of eject the ink jet ink composition in the present embodiment described above from a recording head based on the ink jet scheme and recording an image on a recording medium. Examples of the scheme of ejecting the ink include a scheme of applying mechanical energy caused by an electrostrictive element to the ink and a method of applying thermal energy to the ink. In this embodiment, it is particularly preferable to use the scheme of applying mechanical energy caused by the electrostrictive element to the ink.

### 2.2. Recorded Product

The recorded product in the present embodiment is a recorded product obtained by performing recording on the aforementioned recording medium using the aforementioned ink composition.

Hereinafter, some embodiments of the second disclosure will be described. The embodiments described below describe examples of the present disclosure. The present disclosure is not limited to the following embodiments at all and includes various modifications implemented within a range in which the gist of the present disclosure is not changed. Note that not all of the configurations described below are necessarily essential configurations of the present disclosure.

### 1. Ink Jet Ink Composition

The ink jet ink composition in the present embodiment is an ink jet ink composition containing polymer particles, and the polymer particles include polymer particles A and polymer particles B, the polymer particles A are constituted of a urethane resin that has a structure derived from one or more kinds selected from dicyclohexylmethane diisocyanate, isophorone diisocyanate, and 1,3-bis(isocyanatemethyl)cyclohexane, and a structure derived from polytetramethylene glycol, and the polymer particles B are constituted of a urethane resin that has a structure derived from one or more kinds selected from m-bis(isocyanatepropyl)benzene, m-bis(isocyanatemethyl)benzene, tolylene diisocyanate, and 4,4-diphenylmethane diisocyanate.

According to the ink jet ink composition of the present embodiment, scratch resistance and delamination resistance are excellent. Further, it is possible to satisfy basic properties of ink jet such as clogging stability, intermittent ejection stability, and successive printing stability. Also, sufficient glossiness can also be obtained when glossiness of the film or the like is required when front printing is performed on the film. In addition, required excellent blocking resistance is also achieved both when front printing is performed on the film and when back printing is performed thereon.

Here, the delamination resistance will be described.

In the present disclosure, attaching a laminated film on a printed surface to enhance preservability of a printed product with a film or the like will be referred to as lamination, and the delamination resistance is an index representing, as a numerical value, strength with which the laminated film peels off from the printed surface.

The front printing will be described.

In the present disclosure, the front printing means printing performed on a film directly or via a pretreated layer or the like with no lamination such that the content and the like are accommodated on the opposite side of the printed surface, when printing is performed on the film or the like.

The back printing will be described.

In the present disclosure, the back printing means printing performed on a film directly or via a pretreated layer or the like with a laminated film adhering to the printed surface with an adhesive or the like such that the content and the like are accommodated on the side of the laminated film, when printing is performed on the film or the like.

Blocking resistance will be described.

In the present disclosure, the blocking resistance is an index indicating that the ink and the like are not transferred from the printed surface to the opposite surface when the printed surface and the rear surface of the recording medium are overlapped with each other.

In particular, excellent scratch resistance of the printed product is required when printing is performed on a film, and also, excellent delamination resistance is required when back printing is performed on the film.

Further, it is also effective to satisfy the basic properties of the ink jet such as clogging stability, intermittent ejection stability, and successive printing stability. Excellent glossiness of the recorded product is also effective.

Excellent blocking resistance is required both when front printing is performed on a recording medium such as a film and when back printing is performed thereon.

Further, an ink composition suitable for an ink jet ink capable of addressing both front printing and back printing on a recording medium such as a film is highly effective.

Note that when recording is performed by the ink jet recording method, evaporation of water in the ink from the nozzles occurs when a state in which the ink is not ejected from the nozzles of the ink jet head continues for a certain period of time. When it is attempted to eject the next ink from the nozzles, ink droplets do not fly straight or cannot be ejected. An ink that causes such a phenomenon has low intermittent ejection stability.

Note that there are two levels of scratch resistance, namely dry rubbing properties and wet rubbing properties. In this specification, the test was conducted based on “JIS L 0849 Dyeing fastness test method against rubbing”. A test conducted with a dry white cotton cloth is defined as a dry rubbing test, and how good the result thereof is defined as dry rubbing properties. Also, a test conducted with a white cotton cloth in a wet state is defined as a wet rubbing test, and how good the result thereof is defined as wet rubbing properties.

The ink jet ink composition in the present embodiment contains polymer particles constituted of a polymer. First, the polymer constituting the polymer particles will be described, and then the other components will be described.

### 1.1 Polymer

The ink jet ink composition in the present embodiment contains at least polymer particles A constituted of a urethane resin using one or more kinds selected from dicyclohexylmethane diisocyanate, isophorone diisocyanate, and 1,3-bis(isocyanatemethyl)cyclohexane and polymer particles B constituted of a urethane resin using one or more kinds selected from tolylene diisocyanate, 4,4-diphenylmethane diisocyanate, m-bis(isocyanatepropyl)benzene, and m-bis(isocyanatemethyl)benzene.

In all the polymer particles A that is a urethane resin using one or more kinds selected from dicyclohexylmethane diisocyanate, isophorone diisocyanate, and 1,3-bis(isocyanatemethyl)cyclohexane, the position at which the isocyanate group is bonded is a position at which it is unlikely to be crystallized or stacked when it becomes a polymer through polymerization, crystallization is unlikely to occur, a flexible polyurethane resin is obtained, adhesion to a base material film is promoted, and it is thus possible to form a printed product with excellent delamination resistance. Also, since it is possible to easily adjust the acid value in a region suitable for the ink jet ink, interactions with the other components (water, a pigment, and the like) contained in the ink jet ink composition fall within appropriate ranges. In this manner, it is possible to secure more satisfactory basic properties of the ink jet, such as clogging stability, intermittent ejection stability, and successive printing stability.

Also, all the polymer particles B that are a urethane resin using one or more kinds selected from tolylene diisocyanate, 4,4-diphenylmethane diisocyanate, m-bis(isocyanatepropyl)benzene, and m-bis(isocyanatemethyl)benzene have aromatic rings, there is a trend that crystallization or stacking occurs when it becomes a polymer through polymerization, a polyurethane resin with high mechanical strength is thus obtained, adhesion to a base material film is promoted, and it is thus possible to form a printed product with excellent scratch resistance and glossiness. Also, since it is possible to easily adjust the acid value in a region suitable for the ink jet ink, interactions with the other components (water, a pigment, and the like) contained in the ink jet ink composition fall within appropriate ranges. In this manner, it is possible to secure more satisfactory basic properties of the ink jet, such as clogging stability, intermittent ejection stability, and successive printing stability. In particular, when the polymer constituting the polymer particles A uses isophorone diisocyanate and the polymer constituting the polymer particles B uses tolylene diisocyanate, more excellent scratch resistance and delamination resistance are achieved, which is preferable.

### 1.1.1. Overview of Polymer

The polymer particles A contained in the ink jet ink composition in the present embodiment have one or more groups (bonds) selected from a urethane group (urethane bond) or a urea group (urea bond) derived from one or more diisocyanates selected from dicyclohexylmethane diisocyanate, isophorone diisocyanate, and 1,3-bis(isocyanatemethyl)cyclohexane. On the other hand, the polymer particles B have one or more groups (bonds) selected from a urethane group (urethane bond) a urea group (urea bond) derived from one or more diisocyanates selected from tolylene diisocyanate, 4,4-diphenylmethane diisocyanate, m-bis(isocyanatepropyl)benzene, and m-bis(isocyanatemethyl)benzene. Particularly, the polymer particles B have a urethane group. Therefore, it is possible to refer the polymer as a urethane resin (polyurethane) in the specification.

The polymer contained in the ink jet ink composition according to the present embodiment is a resin polymerized using polyisocyanate, and the polymerization is performed using at least polyisocyanate, polyol, and polyamine, and if needed, polyol and polyamine that are a crosslinking agent and a chain extender.

The polymer particles A and B are polymers including one or more groups selected from a urethane bond (urethane group) obtained through a reaction between an isocyanate group and a hydroxyl group and a urea bond (urea group) generated through a reaction between an isocyanate group and an amino group, and may be linear or branched.

Further, the polymer includes one with thermoplasticity regardless of presence of a crosslinked structure and one, in which a crosslinked structure is formed, which does not exhibit Tg and a melting point at all or only slightly exhibits Tg and a melting point.

The isocyanate group for forming the urethane bond is supplied from one of compounds containing isocyanate groups. A hydroxyl group for forming the urethane bond is supplied from one of compounds including hydroxyl groups. Further, an amino group for forming a urea bond is supplied from a compound having an amino group or an amino group formed through a reaction between an isocyanate group and water. For polymerization, a compound with isocyanate groups that has two or more isocyanate groups, a compound with hydroxyl groups that has two or more hydroxyl groups, and a compound with amino groups that has two or more amino groups are selected and polymerized. In the specification, the compound having two or more isocyanate groups may be referred to as polyisocyanate, the compound having two or more hydroxyl groups may be referred to as polyol, and the compound having two or more amino groups may be referred to as polyamine. Note that, among these, a compound having two isocyanate groups may be referred to as diisocyanate, a compound having two hydroxyl groups may be referred to as diol, and a compound having two amino groups may be referred to as diamine.

A molecular chain between the isocyanate groups in polyisocyanate, a molecular chain between the hydroxyl groups in polyol, and a molecular chain between amino groups in polyamine serve as portions other than the urethane bond and the urea bond in the case of polyurethane. In the specification, an entirety or a part of the portions other than the urethane bond or the urea bond in the case of polyurethane may be referred to as a skeleton. The skeleton may be linear or branched.

Also, the polymer particles A and B may contain bonds other than a urethane bond and a urea bond, and examples of such bonds include a urea bond generated through a reaction between a plurality of isocyanate bonds and water, a biuret bond generated through a reaction between a urea bond and an isocyanate group, an allophanate bond generated through a reaction between a urethane bond and an isocyanate group, a uretdione bond generated through dimerization of an isocyanate group, and an isocyanurate bond generated through trimerization of an isocyanate group. It is possible to control whether to actively generate or not generate these bonds depending on a reaction temperature and the like. Therefore, when polyisocyanate, polyol, and polyamine are present together, for example, a polymer including these bonds (groups) in addition to the urethane bond and the urea bond may be generated. By having an allophanate structure, a biuret structure, a uretdione structure, and an isocyanurate structure, adhesiveness to a medium may increase, the film strength may increased, and satisfactory scratch resistance and glossiness may be achieved.

### 1.1.2. Raw Materials of Polymer

The polymer in the present embodiment is obtained through polymerization using at least diisocyanate and polyol, and the polymer used in the ink jet ink composition according to the present embodiment may be polymerized using polyamine, and it is also possible to further use polyol, polyamine, and the like as a crosslinking agent and a chain extender as needed.

### 1.1.2.1. Diisocyanate

The diisocyanate mainly used for the polymer particles A in the present embodiment is one or more kinds selected from dicyclohexylmethane diisocyanate, isophorone diisocyanate, and 1,3-bis(isocyanatemethyl)cyclohexane.

Also, since these diisocyanates can be named in various manners such as common names, they all have a large number of different names. Thus, CAS numbers will be described together instead of notations of different names.

Dicyclohexylmethane diisocyanate: CAS=5124-30-1 Isophoronediisocyanate: CAS=4098-71-9 1,3-bis(isocyanatemethyl)cyclohexane: CAS=38661-72-2

When such diisocyanate is polymerized to become a polymer through formation of bonds with, for example, a hydroxyl group and an amino group, bonding is achieved at positions at which a cyclohexyl ring and a benzene ring are unlikely to be stacked or crystallized. In this manner, an excessive increase in density of a microphase separated structure and a crosslinked structure of microcrystals caused by the polymer (urethane resin) is curbed. It is thus possible to lower Tg (glass transition temperature) of the polymer and to enhance flexibility of the polymer. In this manner, it is possible to improve blocking resistance and delamination resistance of a printed product when the ink jet ink composition is caused to adhere to a recording medium.

The dicyclohexylmethane diisocyanate may be a mixture of or a single substance selected from dicyclohexylmethane 4,4′-diisocyanate, dicyclohexylmethane 2,2′-diisocyanate, and dicyclohexylmethane 2,4′-diisocyanate. Furthermore, polyfunctional isocyanate of dimer or more of an arbitrary combination of these may be used. The polyfunctional polyisocyanate is a compound that has a structure of two or more molecules of polyisocyanate and has two or more isocyanate groups at terminals of the molecules to react with an OH group or an NH₂ group in polyol, polyamine, or the like. The polyfunctional polyisocyanate may include at least one selected from a group consisting of an allophanate structure, an uretdione structure, an isocyanurate structure, and a biuret structure.

The polyisocyanate that can be mainly used for the polymer particles B in the present embodiment is suitably polydiisocyanate having an aromatic ring, and examples thereof include 2,4-tolylene diisocyanate (TDI), 2,6-tolylene diisocyanate, 4,4′-diphenylmethane diisocyanate (MDI), 2,4-diphenylmethane diisocyanate, 4,4′-diisocyanatobiphenyl, 3,3′-dimethyl-4,4′-diisocyanatobiphenyl, 3,3′-dimethyl-4,4′-diisocyanatodiphenylmethane, 1,5-naphthylene diisocyanate, 1,3-phenylene diisocyanate, 1,4-phenylene diisocyanate, 4,4′,4″-triphenylmethane triisocyanate, m-isocyanatophenylsulfonyl isocyanate, and p-isocyanatophenylsulfonyl isocyanate. Among these, tolylene diisocyanate, 4,4-diphenylmethane diisocyanate, m-bis(isocyanatepropyl)benzene, and m-bis(isocyanatemethyl)benzene are preferably used.

Also, since these diisocyanates can be named in various manners such as common names, they all have a large number of different names. Thus, CAS numbers will be described together instead of notations of different names. 2,4-tolylene diisocyanate: CAS=584-85-9 2,6-tolylene diisocyanate: CAS=91-08-7 4,4-diphenylmethane diisocyanate: CAS=101-68-8 m-bis(isocyanatepropyl)benzene: CAS=2778-42-9 m-bis(isocyanatemethyl)benzene: CAS=3634-83-1

Other polyisocyanates that can be further used in combination with the aforementioned ones in the polymer particles A and B include aliphatic polyisocyanate and alicyclic polyisocyanate. Examples of aliphatic polyisocyanate include ethylene diisocyanate, tetramethylene diisocyanate, hexamethylene diisocyanate (HDI), dodecamethylene diisocyanate, 1,6,11-undecane triisocyanate, 2,2,4-trimethylhexamethylene diisocyanate, lysine diisocyanate, 2,6-diisocyanatomethylcaproate, bis(2-isocyanatoethyl)fumarate, bis(2-isocyanatoethyl)carbonate, 2-isocyanatoethyl-2,6-diisocyanatohexanoate, and the like.

Examples of alicyclic polyisocyanate include isophorone diisocyanate (IPDI), 4,4′-dicyclohexylmethane diisocyanate (hydrogenated MDI), cyclohexylene diisocyanate, methylcyclohexylene diisocyanate (hydrogenated TDI), bis(2-isocyanatoethyl)-4-cyclohexene-1,2-dicarboxylate, 2,5-norbornane diisocyanate, 2,6-norbornane diisocyanate, and the like.

Although as the polyisocyanate, one having two isocyanato groups per molecule can be used, it is also possible to use a polyisocyanate compound that has three or more isocyanato groups per molecule within a range in which the polyurethane prepolymer does not cause gelation. Alicyclic polyisocyanate is preferably used for the polymer particles A in terms of an improvement in durability of the coating film, and isophorone diisocyanate (IPDI), 4,4′-dicyclohexylmethane diisocyanate (hydrogenated MDI) are particularly preferably used in terms of easiness in reaction control. In order to improve scratch resistance, aromatic ring polyisocyanates is preferably used for the polymer particles B, and tolylene diisocyanate, 4,4-diphenylmethane diisocyanate, m-bis(isocyanatepropyl)benzene, and m-bis(isocyanatemethyl)benzene are preferably used. Further, polyisocyanate may be a combination of a plurality of kinds and may be modified into alphanate, nurate, or the like.

Further, a polyurethane resin C having one or more kinds selected from a tricyclodecane dimethanol group, a pentacyclopentadecane dimethanol group, and a fluorene group can be contained. By using the polyurethane resin C having one or more kinds selected from a tricyclodecanedimethanol group, a pentacyclopentadecanedimethanol group, and fluorene group, it is possible to further improve the scratch resistance, particularly wet rubbing properties, required for front printing. As a polyurethane resin having a tricyclodecane dimethanol group and a pentacyclopentadecane dimethanol group, substances as described in JP-A-2006-312729, for example, can be used.

### 1.1.2.2. Polyol

Polyol can be used as a raw material for the polymer contained in the ink jet ink composition according to the present embodiment. In other word, the polymer has a structure derived from polyol. Polyol is a bifunctional or higher functional compound, that is, a compound having two or more hydroxyl groups. Polyol used for the polymer particles A particularly contains polytetramethylene glycol, and preferably contains polytetramethylene glycol as a main component. The amount of polytetramethylene glycol used for the polymer particles A is preferably equal to or greater than 50% of polyol used. The amount is more preferably equal to or greater than 80%. Using polytetramethylene glycol can lead to an improvement in flexibility of the polymer (urethane resin) and an improvement in blocking resistance and delamination resistance. Also, the number average molecular weight of polytetramethylene glycol is preferably equal to or greater than 500 and equal to or less than 3000, the balance between strength and flexibility of the film (printed product) formed by the polymer is improved, and it is thus possible to achieve further satisfactory delamination resistance of the printed product.

The number average molecular weight of polytetramethylene glycol is preferably equal to or greater than 250 and equal to or less than 4000, is more preferably equal to or greater than 500 and equal to or less than 3000, and is further preferably equal to or greater than 1000 and equal to or less than 2500.

It is possible to obtain further satisfactory delamination resistance of the printed product by the polymer constituting the polymer particles A containing a skeleton derived from polytetramethylene glycol. Further, when the number average molecular weight of the skeleton derived from polytetramethylene glycol falls within the aforementioned range, satisfactory flexibility of the solidified substance of the ink jet ink composition is achieved, and adhesiveness to a plastic film of PET, OPP, or the like is further improved. Therefore, since excellent delamination resistance is achieved, it is possible to use the ink for back printing when printing is performed on a film or the like.

A commercially available product can be used as polytetramethylene glycol, and examples thereof include PTMG650, PTMG1000, PTMG2000, PTMG3000, and PTMG4000 manufactured by Mitsubishi Chemical Corporation and PTG and PTMG-L manufactured by Hodogaya Chemical Co., Ltd.

Although polyol used for the polymer particles B is not limited, polyester polyol is particularly preferably used. The number average molecular weight of polyester polyol is preferably equal to or greater than 500 and equal to or less than 3000, strength of the film formed by the polymer is improved, and it is thus possible to achieve satisfactory scratch resistance of the printed product. Although polyol that is used together with polytetramethylene glycol that is preferably used for the polymer particles A and polyester polyol that is preferably used for the polymer particles B is not particularly limited, polyol with low solubility in water is preferably used. Examples of polyol include alkylene glycol, polyester polyol, polyolefin polyol, polyether polyol, polycarbonate diol, and the like.

The number average molecular weight of polyester polyol is preferably equal to or greater than 250 and equal to or less than 4000, is more preferably equal to or greater than 500 and equal to or less than 3000, and is further preferably equal to or greater than 1000 and equal to or less than 2500.

By the polymer constituting the polymer particles B containing the skeleton derived from polyester glycol, it is possible to obtain further satisfactory scratch resistance of a printed product. Also, when the number average molecular weight of the skeleton derived from polyester glycol falls within the aforementioned range, satisfactory flexibility of the solidified substance of the ink jet ink composition is achieved, and adhesiveness to a plastic film of PET, OPP, or the like is further improved. Therefore, since excellent scratch resistance and glossiness are achieved, it is possible to use the ink for front printing when printing is performed on a film or the like.

As alkylene glycol, it is possible to use the aforementioned substances and the following substances, for example, as ones other than the aforementioned substances. That is, examples thereof include ethylene glycol, diethylene glycol, triethylene glycol, polyethylene glycol, 1,2-propylene glycol, 1,3-propanediol, tripropylene glycol, polypropylene glycol, (poly)tetramethylene glycol, hexamethylene glycol, tetramethylene glycol, neopentyl glycol, 1,2-butanediol, 1,3-butanediol, 1,4-butanediol, 1,2-pentanediol, 1,5-pentanediol, 1,2-hexanediol, 1,6-hexanediol, 3-methyl-1,5-pentanediol, 1,2-cyclohexanediol, 1,4-cyclohexanediol, 1,4-cyclohexanedimethanol, 4,4-dihydroxyphenylpropane, 4,4-dihydroxyphenylmethane, glycerin, trimethylolethane, trimethylolpropane, 1,2,5-hexanetriol, 1,2,6-hexanetriol, pentaerythritol, trimethylolmelamine, polyoxypropylenetriol, dimethyl-1,3-pentanediol, diethyl 1,3-pentanediol, dipropyl-1,3-pentanediol, dibutyl-1,3-pentanediol, 2-butyl-2-ethyl-1,3-propanediol and the like. Among these, 1,4-cyclohexanediol, 1,4-cyclohexanedimethanol, 4,4-dihydroxyphenylpropane, 4,4-dihydroxyphenylmethane, dimethyl-1,3-pentanediol, diethyl-1,3-pentanediol, dipropyl-1,3-pentanediol, dibutyl-1,3-pentanediol, and 2-butyl-2-ethyl-1,3-propanediol are preferably used.

If alkylene glycol is used as a raw material for the polymer, alkylene glycol with a small molecular weight may penetrate into the three-dimensional network structure formed in the polymer and react with isocyanate to form a urethane bond, resulting in a stronger coating film. In this manner, strength of the printed product may increase, and scratch resistance may be further improved. However, the amount of addition of these substances is preferably equal to or less than 10%. The amount of addition of these substances is more preferably equal to or less than 5%.

Since the molecular weight of alkylene glycol itself is small, urethane groups may excessively increase when the hydroxyl group and the isocyanate group cause a reaction, there may become no flexibility, and scratch resistance may be easily degraded. Therefore, these are basically urethane groups or allophanate groups, which are the hard segments of the polymer. Note that alkylene glycol can also be used as a component to cause a reaction with polyfunctional polyisocyanate, a chain extender, a crosslinking agent, or the like and can also be used to control physical properties of the polymer.

When polyol is used as a raw material of the polymer, the number average molecular weight thereof is preferably equal to or greater than 500 and equal to or less than 3000. When the number average molecular weight is equal to or greater than 500, the density of the urethane bond in the polymer does not excessively increase, and it is possible to curb stiffness of molecular chains derived from polyol. In this manner, flexibility of the polymer is enhanced, and satisfactory scratch resistance of the printed product is achieved. When the number average molecular weight of polyol that causes a reaction with polyisocyanate is equal to or less than 3000, the density of urethane bonds in the polymer does not excessively decreases, stretchability of molecular chains derived from polyol does not excessively increase, flexibility of the polymer is curbed, tackiness is unlikely to be caused, and it is possible to secure scratch resistance. Therefore, by the number average molecular weight of polyol being equal to or greater than 500 and equal to or less than 3000, a good balance is achieved between the strength and the flexibility of the film (printed product) formed by the polymer is obtained, and it is thus possible to obtain satisfactory scratch resistance of a recorded printed product.

In particular, examples of polyester polyol include acid ester. Examples of an acid component constituting acid ester include aliphatic dicarboxylic acids such as a malonic acid, a succinic acid, a tartaric acid, an oxalic acid, a glutaric acid, an adipic acid, a pimelic acid, a suberic acid, an azelaic acid, a sebacic acid, an alkylsuccinic acid, a linolenic acid, a maleic acid, a fumaric acid, a mesaconic acid, a citraconic acid, and an itaconic acid, and alicyclic dicarboxylic acids such as a phthalic acid, a naphthalene dicarboxylic acid, a biphenyl dicarboxylic acid, a tetrahydrophthalic acid, and aromatic hydrogenated products. Anhydrides, salts, alkyl esters, acid halides and the like of these acid components can also be used as the acid components. Examples of an alcohol component constituting the acid ester include the aforementioned diol compounds and are not particularly limited. However, those having low solubility in water are preferably used.

Examples of commercially available polyester polyols include Polylite series such as Polylite OD-X-2251, 2423, 2547, 2555, 2420, 2692, 2586, 102, 668, 2420, 2608, 2108, 688, 2155, 640, and 2722 manufactured by DIC Corporation, Nipolon 4002, 4009, 3027, 4077, 1004, 40425035, 4040, 164, 176, 146, and 501 manufactured by Tosoh Corporation, ADEKA NEWACE NS-2400, YT-101, #50, F1212-29, YG-108, U-14-90, Y65-55 manufactured by ADEKA CORPORATION, and the like.

Examples of polyether polyol include addition polymerization products of alkylene oxides and condensation polymerization products of polyols such as (poly)alkylene glycol. Examples of alkylene oxide include ethylene oxide, propylene oxide, butylene oxide, α-olefin oxide, and the like. Examples of (poly)alkylene glycol include polyethylene glycol (polyoxyethylene glycol), polypropylene glycol (polyoxypropylene glycol), and the like.

Polyolefin diol contains two hydroxyl groups and a molecular chain having an unsaturated bond. Examples of polyolefin polyol include unsaturated low molecular weight polyol such as 2-butyne-1,4-diol and 2-butene-1,4-diol and unsaturated high molecular weight polyol such as polybutadiene glycol and polyisoprene glycol.

A commercially available polyolefin diol can also be used. Examples thereof include hydroxy group-terminated hydrogenated 1,4-polybutadiene (product name: Polytail H) manufactured by Mitsubishi Chemical Corporation, hydroxy group-terminated hydrogenated polyolefin (product name: Epol) manufactured by Idemitsu Petrochemical Co., Ltd., Poly bdR-45HT (hydroxyl group-terminated liquid polybutadiene) and Poly ip (hydroxyl group-terminated liquid polyisoprene), Epol (hydroxyl group-terminated liquid hydrogenated polyisoprene) manufactured by Idemitsu Kosan, GI-1000 (hydroxyl group-containing liquid hydrogenated polybutadiene), GI-2000 (hydroxyl group-containing liquid hydrogenated polybutadiene), GI-3000 (hydroxyl group-containing liquid hydrogenated polybutadiene), manufactured by Nippon Soda, and the like.

Polycarbonate diol contains two hydroxyl groups and a molecular chain having a carbonate bond.

Examples of polycarbonate diol that can be used as a part of polyol in the present embodiment include carbonate components such as alkylene carbonate, diaryl carbonate, and dialkyl carbonate, phosgene, polycarbonate diol obtained through a reaction of an aliphatic polyol component, and further alkanediol-based polycarbonate diols such as polyhexamethylene carbonate diol. By using polycarbonate diol as a starting material for the polymer, heat resistance and hydrolysis resistance of the generated polymer tend to become satisfactory.

By using polycarbonate diol as polyol, the polymer has a skeleton derived from polycarbonate diol, and it is thus possible to obtain further satisfactory scratch resistance of a printed product.

Polycarbonate diol suitable as a raw material for the polymer in the present embodiment generally has two hydroxyl groups in the molecule and can be obtained through a transesterification reaction between a diol compound and a carbonic acid ester. Examples of such a diol compound include 1,4-butanediol, 1,3-butanediol, 1,2-butanediol, 1,5-pentanediol, 1,2-pentanediol, 1,6-hexanediol, 1,5-hexanediol, 1,2-hexanediol, 1,7-heptanediol, 1,8-octanediol, 1,2-octanediol, 1,9-nonanediol, 1,10-decanediol, neopentyl glycol, 4-methyl-1,5-pentanediol, 2-methyl-1,3-propanediol, 2-methyl-1,8-octanediol, 2-isopropyl-1,4-butanediol, 2-ethyl-1,6-hexanediol, 3-methyl-1,5-pentanediol, 2,4-dimethyl-1,5-pentanediol, 2,4-diethyl-1,5-pentanediol, 1,3-butanediol, 2-ethyl-1,3-hexanediol, 2-butyl-2-ethyl-1,3-propanediol, 1,4-cyclohexanedimethanol, 1,3-cyclohexanediol, 1,4-cyclohexanediol, and the like. One of these can be used alone, or two or more of these can be used in combination. Among the aforementioned diols, neopentyl glycol, 4-methyl-1,5-pentanediol, 2-methyl-1,3-propanediol, 2-methyl-1,8-octanediol, 2-isopropyl-1,4-butanediol, 2-ethyl-1,6-hexanediol, 3-methyl-1,5-pentanediol, 2,4-dimethyl-1,5-pentanediol, and 2,4-diethyl-1,5-pentanediol which are more unlikely cause crystallization are more preferably used.

Although carbonic acid ester that can be used for producing polycarbonate diol is not limited as long as the advantages of the present disclosure are not impaired, examples thereof include dialkyl carbonate, diaryl carbonate, and alkylene carbonate. Among these, diaryl carbonate is preferably used in terms of reactivity. Specific examples of the carbonate compound include dimethyl carbonate, diethyl carbonate, dibutyl carbonate, diphenyl carbonate, ethylene carbonate, and the like, and diphenyl carbonate is more preferably used.

Examples of commercially available polycarbonate diols include NL1010DB, NL2010DB, NL3010DB, NL1010B, NL2010B, NL3010B, NL1050DB, NL2050DB, and NL3050DB from BENEBiOL series of Mitsubishi Chemical Corporation, Duranol series of Asahi Kasei Chemicals Corporation, Nipolon series of Tosoh Corporation, polyhexanediol carbonate of Kuraray Co., Ltd., Placcel series and CDCD205PL of Daicel Corporation, ETERNACOLL series of Ube Industries, Ltd., and the like. Acid group-containing polyol

It is also preferable to use, as a raw material of the polymer contained in the ink jet ink composition in the present embodiment, one having an acid group in the molecule of polyol. In this manner, the polymer contains a skeleton derived from carboxyl group-containing polyol.

Examples of acid group-containing polyol include acid group-containing diol, such as a dimethylolacetic acid, a dimethylolpropionic acid, a dimethylolbutanoic acid, and a dimethylolbutyric acid. Among these, a dimethylolpropionic acid and a dimethylolbutanoic acid are more preferably used. When the ink jet ink composition of the present embodiment is a water-based ink composition, the polymer is more preferably polymerized using such an acid group-containing diol as a raw material. Examples of the acid group include organic acid groups as described above, and particularly a carboxyl group is listed.

Further, acid group-containing polyol having an aromatic structure, acid group-containing polyol or the like having an aliphatic structure, or the like may be used as acid group-containing polyol.

In this manner, it is possible to easily adjust the acid value within a region suitable for the ink jet ink. Also, it is possible to achieve further satisfactory scratch resistance and delamination resistance of a printed product formed on the recording medium.

The polymer polymerized using such a component is composed mainly of two segments, namely a hard segment and a soft segment. The hard segment is constituted of polyisocyanate, short-chain polyol, polyamine, a crosslinking agent, a chain extender, and the like and mainly contributes to strength of the polymer. On the other hand, the soft segment is constituted of long-chain polyol and the like and mainly contributes to flexibility of the resin. Then, the ink jet ink composition is caused to adhere to a recording medium, these hard segment and soft segment have a microphase separated structure in a coating film formed of such a polymer, and the coating film has thus strength, flexibility, and high elasticity. Such properties of the coating film contribute to an improvement in scratch resistance and delamination resistance of the printed product.

### 1.1.2.3. Other Starting Materials

### Polyamine

Raw materials of the polymer contained in the ink jet ink composition according to the present embodiment may contain polyamine. Although polyamine is not particularly limited as long as it is a compound having a bifunctional or higher functional amino group, a compound having high hydrophobicity is preferably used. By using polyamine, the polymer has a structure derived from polyamine. In this manner, more excellent scratch resistance, lamination resistance, and the like are achieved, which is preferable.

Examples of polyamines include aliphatic diamine such as ethylenediamine, propylenediamine, 2,2-dimethyl-1,3-propanediamine, 2-methyl-1,5-pentanediamine, trimethylhexanediamine, 2-butyl-2-ethyl-1,5-pentanediamine, 1,8-octanediamine, 1,9-nonanediamine, 1,10-decanediamine, isophoronediamine, and bicycloheptanedimethanamine, diethylenetriamine, hexylenediamine, triethylenetetramine, tetraethylenepentamine, xylylenediamine, diphenylmethanediamine, hydrogenated diphenylmethanediamine, hydrazine, polyamide polyamine, polyethylene polyimine, 1-amino-3-aminomethyl-3,5,5-trimethylcyclohexane, dicyclohexylmethanediamine, bicycloheptanedimethanamine, mensendiamine, diaminodicyclohexylmethane, isoprobilitin cyclohexyl-4,4′-diamine, 1,4-diaminocyclohexane, 1,3-bisaminomethylcyclohexane and the like.

Among these, polyamine having 1 to 10 carbon atoms is preferably used, aliphatic diamine such as 2,2-dimethyl-1,3-propanediamine, 2-methyl-1,5-pentanediamine, trimethylhexanediamine, 2-butyl-2-ethyl-1,5-pentanediamine, 1,8-octanediamine, 1,9-nonanediamine, 1,10-decanediamine, isophoronediamine, and bicycloheptanedimethanamine are preferably used, and isophoronediamine and bicycloheptanedimethanamine are further particularly preferably used.

Note that many general-purpose compounds as polyamine have molecular weights equivalent to that of short-chain polyol and are basically urea groups or biuret groups that are hard segments of the polymer.

Note that polyamine can also be used as a component that causes a reaction with polyfunctional polyisocyanate, a chain extender, a crosslinking agent, or the like, and a urea bond is formed when a reaction is cased between the isocyanate group and the amino group. Therefore, when polyamine is used, it is also possible to control physical properties of the polymer by determining the amount of used polyamine such that a ratio of the urea group/the urethane group becomes a desired ratio in the polymer.

As methods for adjusting the ratio of the urea group/the urethane group in the polymer, there are a method of adjusting the amount of used amine compound (polyamine) in consideration of the equivalent amount of amino group in the amine compound when the polymer is synthesized, a method of adjusting the remaining rate of unreacted isocyanate group when the polymer is transferred into a water phase, and the like.

According to the method of adjusting the amount of used polyamine when the polymer is synthesized, the amount of urea bond generated through a reaction between polyamine and the isocyanate group is controlled. First, a plurality of types of polymers are synthesized with different amounts of polyamine used, and the ratio of the urea group/the urethane group is calculated. A relationship between the amount of used polyamine and the molar ratio is examined from the obtained molar ratio to create a calibration curve, and the amount of used polyamine required to synthesize the polymer having a desired molar ratio is determined using the calibration curve. Note that the calibration curve was created in advance because a reaction rate and the like may change if components other than polyamine are different even when the same kind of polyamine is used and the same molar ratio is thus not obtained.

As the method of adjusting the remaining rate if unreacted isocyanate group when the polymer is phase-transferred to water, the remaining rate of isocyanate group with respect to the amount of used polyisocyanate is checked using a Fourier transform-type infrared spectrophotometer (FT-IR) first in the process of a polymer synthesis reaction. The remaining rate of isocyanate group can be adjusted by changing the reaction time, the amount of used polyisocyanate, and the like.

When the polymer uses either aliphatic diamine or aromatic diamine, that is, when the polymer has one or more skeletons selected from a skeleton derived from aliphatic diamine and a skeleton derived from aromatic diamine, more satisfactory flexibility of the solidified substance of the ink jet ink composition is achieved, and it is possible to achieve further satisfactory delamination resistance, blocking resistance, and scratch resistance of the printed product.

In the ink jet ink composition according to the present disclosure, the polymer may contain a skeleton derived from alkyldiamine having 1 to 10 carbon atoms.

According to such an ink jet ink composition, more satisfactory flexibility of the solidified substance of the ink jet ink composition is achieved, and it is possible to achieve further satisfactory delamination resistance and scratch resistance of the printed product.

### Crosslinking Agent and Chain Extender

The polymer in the present embodiment may contain a crosslinking agent and/or a chain extender.

The crosslinking agent is used to synthesize the prepolymer, and the chain extender is used to cause a chain extending reaction after the synthesis of the prepolymer. As the crosslinking agent and the chain extender, it is possible to appropriately select and use ones from polyisocyanates, polyol, polyamine, and the like described above in accordance with applications such as crosslinking, chain extension, and the like.

The chain extender is, for example, a compound that causes a reaction with an isocyanate group in the above polyisocyanates that does not form a urethane bond. Examples of the compound that can be used as the chain extender include polyol, polyamine, and the like described above. It is also possible to use a compound capable of crosslinking the polymer as the chain extender. Examples of the compound that can be used as the chain extender include low molecular weight polyols, polyamines, and the like having a number average molecular weight of less than 500.

Examples of the crosslinking agent include trifunctional or higher functional polyisocyanate, polyol, and polyamine. Examples of trifunctional or higher polyfunctional polyisocyanate include polyisocyanate having an isocyanurate structure and polyisocyanate having an allophanate or biuret structure. As polyol, glycerin, trimethylolpropane, pentaerythritol, polyoxypropylenetriol, or the like can be used. Examples of trifunctional or higher functional polyamine include trialcoholamine such as triethanolamine and triisopropanolamine, and trifunctional or higher functional amines having an amino group such as diethylenetriamine and tetraethylenepentamine.

Note that whether the polymer has been crosslinked can be determined based on a gel fraction calculated by calculating a ratio of a gel content and a sol content using a phenomenon in which the polymer with a crosslinked structure is not dissolved in a solvent and swells. The gel fraction is an index of a degree of crosslinking measured from solubility of the solidified polymer, and the higher the degree of crosslinking is, the higher the gel fraction tends to be.

Isocyanates Other than Diisocyanate

The polymer contained in the ink jet ink composition in the present embodiment may use, as a raw material, isocyanate other than the aforementioned diisocyanate as long as the functions and effects described above are not impaired. Examples of such isocyanate include aliphatic polyisocyanates, aromatic polyisocyanate, and alicyclic polyisocyanate.

Examples of the aliphatic polyisocyanate include polyisocyanate having a chain structure such as tetramethylene diisocyanate, hexamethylene diisocyanate, dodecamethylene diisocyanate, 2,2,4-trimethylhexamethylene diisocyanate, 2,4,4-trimethylhexamethylene diisocyanate, lysine diisocyanate, 2-methylpentane-1,5-diisocyanate, and 3-methyl-1,5-pentane diisocyanate.

Aromatic polyisocyanate can also be used. Examples thereof include tolylene diisocyanate, 1,4-phenylene diisocyanate, and 1,5-naphthylene diisocyanate. When aromatic polyisocyanate is used, blocked alicyclic polyisocyanate in which not less than 80% of the aromatic rings of the aromatic polyisocyanate are hydrogenated may be used.

Examples of alicyclic polyisocyanate include 1,4-cyclohexane diisocyanate and hydrogenated xylylene diisocyanate (hydrogenated XDI).

By using such polyisocyanate, the strength of the formed film may increase, and satisfactory scratch resistance may be achieved. The strength of the film is further enhanced, and further satisfactory blocking resistance and delamination resistance are achieved, using alicyclic polyisocyanate described above, in particular. Further, a plurality of types of such polyisocyanate may be mixed and used.

Further, polyisocyanate may have a structure constituted of two or more molecules of polyisocyanate. The structure constituted of two or more molecules of polyisocyanate is, for example, a uretdione structure or an isocyanurate structure. When such polyisocyanate is selected, the polymer is brought into a state in which a structure in which the molecules three-dimensionally tangled in a complicated manner and urethane bonds are concentrated. Therefore, it is possible to stably disperse the polymer in a water-based ink even at a low acid value, for example.

Generally, degradation of intermittent ejection stability is caused by evaporation of water from the nozzles of the ink jet head. One of elements to enhance intermittent ejection stability is to maintain a state in which the pigment and the resin are stably dispersed without any aggregation even when water is evaporated to some extent from the ink composition that is present in the vicinity of the nozzles of the ink jet head and an interaction between the polymer and the pigment is strengthened. Since the polymer in the present embodiment has a structure in which it is three-dimensionally entangled in a complicated manner by including the aforementioned structure constituted of polyisocyanate as described above regardless of a relatively low acid value, repulsion is likely to occur due to an electrostatic effect, a repulsive force, and the like between the polymer and the pigment even if evaporation of water advances, and a stable dispersed structure can easily be obtained.

In this specification, the skeleton of the polymer denotes a molecular chain between functional groups. Therefore, the polymer in the present embodiment has a skeleton derived from a molecular chain of a raw material such as polyisocyanate, polyol, or polyamine. Other skeletons are not particularly limited and may be, for example, a substituted or unsubstituted saturated, unsaturated, or aromatic chain and have a carbonate bond, an ester bond, an amide bond, or the like. The type and the number of substituents in such a skeleton are not particularly limited, and an alkyl group, a hydroxyl group, a carboxyl group, an amino group, a sulfonyl group, a phosphonyl group, or the like may be included.

### 1.1.2.4. Fluorene Group-Containing Urethane

As the urethane resin constituting the polymer particles contained in the ink in the present embodiment, a polyurethane resin having (containing) a fluorene group may be used. In this case, more satisfactory scratch resistance, delamination resistance, successive printing stability, clogging recovery performance, and the like are achieved, which is preferable.

The polyurethane resin having a fluorene group may be a polyurethane resin in which an urethan resin constituting the aforementioned polymer particles A and having a structure derived from specific isocyanate has a fluorene group. Alternatively, the urethan resin constituting the aforementioned polymer particles B and having a structure derived from specific isocyanate may be a polyurethane resin having a fluorene group.

Preferably, it is preferable to use a polyurethane resin having a fluorene group in addition to the urethan resin constituting the aforementioned polymer particles A and having a structure derived from specific isocyanate and the urethane resin constituting the aforementioned polymer particles B and having a structure derived from specific isocyanate. Further, the ink preferably contains polymer particles constituted of a polyurethane resin having a fluorene group in addition to the polymer particles A and the polymer particles B. In this case, the polymer particles A and the polymer particles B sufficiently exhibit their effects, and the polyurethane resin having a fluorene group can exhibit its effect, which is preferable.

The polyurethane resin having a fluorene group may be any polyurethane resin having a fluorene group in its structure, and for example, substances as described in JP-A-2008-101160 can be used.

For example, the fluorene group is introduced into the urethane resin, and the polyurethane resin having the fluorene group can be obtained, by preparing the urethan resin using polyol having a fluorene group as polyol described above.

Examples of polyol having a fluorene group include polyols represented by any of Formula (1), Formula (2), Formula (3), and Formula (4) described in the aforementioned literature.

Polyol represented by Formula (1) is 9,9-bis(4-(hydroxyalkoxy)phenyl)fluorene. R1 is independently an alkylene group having 1 to 4 carbon atoms.

Formula (2) is 9,9-bis(4-hydroxyphenyl)fluorene.

Formula (3) is 9,9-bis(4-hydroxytoluyl)fluorene.

Formula (4) is 9,9-bis(hydroxyalkyl)fluorene. R² is independently an alkylene group having 1 to 4 carbon atoms.

Although the content of the polymer particles constituted of the polyurethane resin having a fluorene group in the ink is not limited, the content is preferably 0.1 to 10% by mass, is more preferably 0.5 to 5% by mass, and is further preferably 0.7 to 2% by mass.

### 1.1.3. Synthesis and Analysis of Polymer

### Synthesis of Polymer

The polymer used in the ink jet ink composition in the present embodiment can be synthesized using a known method as a polymer polymerization method. Hereinafter, description will be given based on an example. Polyisocyanate and a compound that causes a reaction therewith (polyol and if needed polyamine or the like) are made to cause a reaction such that the amounts of use thereof are adjusted to increase isocyanate groups, and a prepolymer having the isocyanate groups at terminals of molecules is polymerized. At this time, it is preferable to carry out the reaction in an organic solvent. An organic solvent with a boiling point of equal to or less than 100° C. such as methyl ethyl ketone, acetone, or tetrahydrofuran may be used as needed. This is generally called a prepolymer method.

When acid group-containing diol is used as a raw material, the acid group in the prepolymer is neutralized using a neutralizing agent such as an organic base such as N,N-dimethylethanolamine, N,N-diethylethanolamine, diethanolamine, triethanolamine, triisopropanolamine, trimethylamine, or triethylamine, an inorganic base such as sodium hydroxide, potassium hydroxide, or ammonia, or the like. Preferably, a neutralizing agent containing alkali metal such as sodium hydroxide or potassium hydroxide is used, thereby improving polymer dispersion stability. The viscosity is unlikely to increase, and operability is improved by using preferably 0.5 to 1.0 mol of such neutralizing agent, or more preferably 0.8 to 1.0 mol of such neutralizing agent per mol of acidic group included in the prepolymer.

Thereafter, the prepolymer is added to a solution containing a chain extender and a crosslinking agent to cause a chain extending reaction and a crosslinking reaction. Then, in the case in which the organic solvent is used, the organic solvent is removed using an evaporator or the like, thereby obtaining a polymer dispersion. The chain extending reaction and the crosslinking reaction are preferably carried out in a water-based solvent.

The water-based solvent contains at least water as a main solvent.

The thus obtained polymer is preferably used because the polymer can more easily exhibit the aforementioned effects.

As a catalyst used for the polymer polymerization reaction, a titanium catalyst, an aluminum catalyst, a zirconium catalyst, an antimony catalyst, a germanium catalyst, a bismuth catalyst, or a metal complex-based catalyst is satisfactorily used. Particularly preferable titanium catalyst is specifically tetraalkyl titanate such as tetrabutyl titanate or tetramethyl titanate or an oxalic acid metal salt such as potassium titanium oxalate. Although other catalysts are not particularly limited as long as the catalysts are known catalysts, examples thereof include tin compounds such as dibutyltin oxide and dibutyltin dilaurylate. It is known from long time ago that an acetylacetonate complex of transition metal such as titanium, iron, copper, zirconium, nickel, cobalt, or manganese has a urethane-forming activity as a non-heavy metal catalyst. In recent years, low toxic catalysts that can replace heavy metal catalysts have been desired due to increasing environmental awareness, and in particular, high urethane-forming activity of titanium/zirconium compounds has been attracting attention.

### Analysis of Polymer

Each of the composition of the polymer, the structure of polyisocyanate, and the acid value of the polymer can be analyzed by the following methods.

First, a method for extracting a polymer from an ink containing the polymer will be described. When the ink jet ink composition contains a pigment, it is possible to extract the polymer from the ink jet ink composition using an organic solvent (acetone, methyl ethyl ketone, or the like) that does not dissolve the pigment but dissolve the polymer. Alternatively, it is also possible to extract the polymer by isolating the ink jet ink composition through ultracentrifugation and acidifying the supernatant thereof with an acid.

### (A) Composition of Polymer

The polymer is dissolved in deuterated dimethyl sulfoxide (DMSO-d6) to prepare a sample, and the type of polyisocyanate, polyol, polyamine, or the like can be checked from positions of peaks obtained in analysis based on a proton nuclear magnetic resonance method (¹H-NMR) or a carbon 13 nuclear magnetic resonance method (¹³C-NMR). Further, it is also possible to calculate a composition ratio from a ratio of integrated values of peaks of chemical shift of the components. It is also possible to check the type of polyisocyanate, polyol, polyamine, or the like by analyzing the polymer based on pyrolytic gas chromatography (GC-MS). When the analysis is performed by the carbon 13 nuclear magnetic resonance spectrometry (¹³C-NMR), it is possible to obtain the number of repetitions of a unit of long-chain polyol and to calculate the number average molecular weight.

### (B) Structure of Polyisocyanate

The structure of polyisocyanate can be checked from an infrared absorption spectrum obtained through analysis of the polymer by Fourier transform infrared spectroscopy (FT-IR). The main absorption is as follows. In an allophanate structure, NH stretching vibration absorption is present at 3300 cm⁻¹, and 2 pieces of C═O stretching vibration absorption are present at 1750 to 1710 cm⁻¹ and 1708 to 1653 cm⁻¹. In a uretdione structure, C═O stretching vibration absorption is present at 1780 to 1755 cm⁻¹, and absorption based on the uretdione ring is present at 1420 to 1400 cm⁻¹. In an isocyanurate structure, C═O stretching vibration absorption is present at 1720 to 1690 cm⁻¹, and absorption based on the isocyanurate ring is present at 1428 to 1406 cm⁻¹. In a biuret structure, C═O stretching vibration absorption is present at 1720 to 1690 cm⁻¹.

### (C) Acid Value of Polymer

The acid value of the polymer can be measured by a titration method. For the acid value, measurement is performed using AT610 (product name) manufactured by Kyoto Electronics Manufacturing Co. Ltd., and the numerical value is applied to the following expression (1) to calculate the acid value.

Acid value (mg/g)=(EP1−BL1)×FA1×C1×K1/SIZE (1)

(In the above expression, EP1 is a titration amount (mL), BL1 is blank value (0.0 mL), FA1 is a factor of titrant (1.00), C1 is a concentration conversion value (5.611 mg/mL) (corresponding to 0.1 mol/L KOH 1 mL of potassium hydroxide), K1 is a coefficient (1), and SIZE is a sampling amount (g).)

Then, the acid value of the polymer dissolved in tetrahydrofuran can be measured by colloid titration using a potential difference. An ethanol solution of sodium hydroxide can be used as the titration reagent at this time.

### 1.1.4. Acid Value of Polymer

Although the acid value of the polymer can be measured as described above, the acid value of the polymer in the present embodiment is preferably equal to or greater than 5 mgKOH/g and equal to or less than 30 mgKOH/g. The acid value of the polymer is more preferably equal to or greater than 7 mgKOH/g and equal to or less than 25 mgKOH/g and is further preferably equal to or greater than 8 mgKOH/g and equal to or less than 20 mgKOH/g. When the acid value is equal to or greater than 5 mgKOH/g, satisfactory dispersion stability of the polymer in the water-based ink is achieved, and clogging is unlikely to occur even at a high temperature. On the other hand, when the acid value is equal to or less than 30 mgKOH/g, the polymer is unlikely to swell with water, and the viscosity of the ink is unlikely to increase. Further, it is possible to maintain satisfactory water resistance of the printed product.

The acid value of the polymer can be adjusted by adjusting the content of the aforementioned acid group-containing polyol, for example. For example, the change can be achieved by adjusting the content of the skeleton derived from carboxyl group-containing glycol (acid group-containing polyol such as a dimethylolpropionic acid). When the ink jet ink composition according to the present embodiment is a water-based ink, a polymer that is carboxyl group-containing glycol and has a carboxyl group is preferably used so as to be able to be easily dispersed with water.

A suitable acid value of the polymer particles A is 10 mgKOH/g to 120 mgKOH/g and is more preferably 20 mgKOH/g to 90 mgKOH/g. Therefore, the ink can be suitably used for back printing when the printing is performed on a film or the like.

A suitable acid value of the polymer particles B is 5 mgKOH/g to 100 mgKOH/g and is more preferably 15 mgKOH/g to 80 mgKOH/g. Therefore, the ink can be suitably used for front printing when the printing is performed on a film or the like.

Therefore, the ink jet ink composition according to the present disclosure using both the polymer particles A and the polymer particles B is an ink suitable both for front printing and for back printing of a film.

### 1.1.5. Content of Polymer

The ink jet ink composition in the present embodiment may contain a plurality of kinds of the aforementioned polymers.

Also, the polymers may be added in the form of an emulsion. The total content of the polymers in the ink jet ink composition in the present embodiment is preferably equal to or greater than 1% and equal to or less than 20.0% and is more preferably equal to or greater than 2.0% and equal to or less than 15.0% on a mass basis (hereinafter, the units simply referred to as % indicate % by mass) as a solid content. Further, the total content is further preferably 3 to 10% by mass and is particularly preferably 4 to 7% by mass.

It is also preferable to set the total content of the polymer particles A and the polymer particles B within the aforementioned range.

Each of the content of the polymer particles A and the content of the polymer particles B is preferably 0.5 to 20.0% by mass and may be set within the aforementioned range. 1.2. Other components 1.2.0. Wax

The ink in the present embodiment may contain a polyolefin-based wax agent. By containing the polyolefin-based wax agent, it is possible to further improve scratch resistance, particularly dry rubbing properties required in front printing.

Hereinafter, the olefin-based wax that can be used in the present disclosure will be specifically described.

The olefin-based wax is obtained through copolymerization of olefin and diene. Examples of olefin used for producing the olefin-based wax include ethylene and α-olefin having 3 to 12 carbon atoms. Examples of α-olefin having 3 to 12 carbon atoms include propylene, 1-butene, 1-pentene, 3-methyl-1-butene, 1-hexene, 4-methyl-1-pentene, 3-methyl-1-pentene, 1-octene, 1-decene, 1-dodecene, and the like. Among these, α-olefin having 3 to 10 carbon atoms is preferable used, α-olefin having 3 to 8 carbon atoms is more preferably used, and propylene, 1-butene, 1-hexene, and 4-methyl-1-pentene are further preferably used.

Similarly, examples of diene used for producing the olefin-based wax include butadiene, isoprene, 4-methyl-1,3-pentadiene, 1,3-pentadiene, 1,4-pentadiene, 1,5-hexadiene, 1,4-hexadiene, 1,3-hexadiene, 1,3-octadiene, 1,4-octadiene, 1,5-octadiene, 1,6-octadiene, 1,7-octadiene, ethylidene norbornene, vinyl norbornene (5-vinyl bicyclo[2.2.1]hept-2-ene), dicyclopentadiene, 2-methyl-1,4-hexadiene, 2-methyl-1,6-octadiene, 7-methyl-1,6-octadiene, 4-ethylidene-8-methyl-1,7-nonadiene, and 5,9-dimethyl-1,4,8-decatriene. Among these, vinyl norbornene, ethylidene norbornene, dicyclopentadiene, 1,4-hexadiene, butadiene, isoprene, 2-methyl-1,4-hexadiene, or 2-methyl-1,6-octadiene is preferably used.

The ink jet ink composition according to the present disclosure preferably uses a polyolefin-based wax having a melting point of 85 to 120° C. and an average particle diameter of equal to or less than 140 nm.

In the present disclosure, scratch resistance, in particular, dry rubbing properties are improved by using the aforementioned specific polyolefin-based wax.

Also, examples of the polyolefin-based wax that can be used in the present disclosure include an oxidized polyolefin-based wax obtained by oxidizing a polyolefin-based wax by a known method.

The oxidized polyolefin-based wax can be produced, for example, by introducing oxygen atoms or the like into a molecule while adjusting the molecular weight of a high molecular weight polyolefin-based resin to a desired molecular weight through thermal decomposition, chemical decomposition, or the like. The oxygen atoms introduced into the molecule constitutes, for example, a carboxyl group or the like with polarity. In the present disclosure, it is preferable to use an oxidized polyolefin-based wax in terms of easiness in emulsification in an aqueous solvent.

In the present disclosure, it is preferable to contain one or more kinds selected from a paraffin wax and a sazol wax in particular in terms of an improvement in abrasion resistance and glossiness of a printed product. In the present disclosure, the paraffin wax is a wax constituted of a mixture of a chain saturated hydrocarbon having 20 or more carbon atoms. In the present disclosure, the sazol wax (Fischer-Tropsch wax) refers to a synthetic wax that uses a raw material, that is produced by a method of synthesizing hydrocarbon through hydrogenation reaction of carbon monoxide, that is constituted of saturated and linearlly connected hydrocarbon, and that has substantially perfect linear molecular structure that has substantially no banches.

In the present disclosure, a polyolefin-based wax having a melting point of equal to or greater than 85° C. is used in terms of an improvement in scratch resistance. Among these, the melting point is preferably equal to or greater than 90° C. and is more preferably equal to or greater than 95° C. in terms of a further improvement in scratch resistance. On the other hand, the melting point of the polyolefin-based wax is equal to or less than 120° C. in the present disclosure. By using the polyolefin-based wax with a melting point of equal to or less than 120° C., adjustment of the average particle diameter of the wax emulsion to be equal to or less than 140 nm is facilitated, it is possible to curb the amount of used surfactant for preparing the emulsion, satisfactory dispersion stability of the wax emulsion is achieved, and water resistance and solvent resistance of the ink composition are improved.

In the present disclosure, the polyolefin-based wax is in an emulsion state in the ink composition. A method of forming the polyolefin-based wax into an emulsion is not particularly limited and may be appropriately selected from known methods in the related art. For example, there is a method of mixing the polyolefin-based wax, other waxes used as needed, and a known surfactant or the like. As the surfactant used in the polyolefin-based wax emulsion, a surfactant having relatively high lipophilicity is preferably used, and specific preferable examples include alkoxylate of a long-chain alcohol and its salt, polyoxyalkylene alkyl ether and its salt, a polyoxyalkylene fatty acid alcohol, glycerin fatty acid ester, sorbitan fatty acid ester, and the like.

The average particle diameter of the polyolefin-based wax emulsion in the ink is preferably equal to or less than 200 nm and is further preferably equal to or less than 120 nm in terms of excellent dispersion stability of the wax emulsion, excellent ejection properties of the ink in the ink jet method, and excellent glossiness of the printed product. On the other hand, the average particle size of the wax emulsion is preferably equal to or greater than 30 nm in terms of an improvement in scratch resistance, particularly dry rubbing properties of the printed product.

Although the content ratio of the wax emulsion is not particularly limited in the ink composition for ink jet recording according to the present disclosure, the content is preferably equal to or greater than 0.05% and equal to or less than 5% and is further preferably equal to or greater than 0.1 and equal to or less than 3% in terms of stability of the wax emulsion in the ink, water resistance, and solvent resistance and in terms of fixability and scratch resistance of the printed product.

Commercially available polyolefin-based waxes include polyolefin resins described in JP-A-2003-201436 such as “A-C8” (polyethylene wax), which is a name of a product manufactured by Honeywell, “VISCOWAX 122” (polyethylene wax), which is a name of a product manufactured by INNOSPEC, “A-C400”. (Ethylene-vinyl acetate copolymer wax), which is a name of a product manufactured by Honeywell, “VISCOWAX 334” (ethylene-vinyl acetate copolymer wax) manufactured by INNOSPEC, “VISCOWAX 343” (ethylene-vinyl acetate copolymer wax) manufactured by INNOSPEC, E-4B, E103N, E-1000, E-5403B, E-6000, E-6314, E-6400, S-3121, S-3123, S-3125, and S-3148 as polyethylene-based wax emulsions, and Hitech E-433N, Hitech E-5060 as polypropylene-based wax emulsions manufactured by Toho Industry Co., Ltd., Polyem 20 and Polyem 40J as polyethylene wax emulsions manufactured by Rohm and Haas Japan Co., Ltd., Chemipal W-100, W-200, W-300, W-308, W-310, W-400, W-401, W-405, W-410, W-500, WF-640, W-700, W-800, W-900, W-950, and W-4005 as polyethylene-based waxes manufactured by Mitsui Chemicals, Inc., AQUACER 1550, 497, 500 series, 840, 1000 series, 2500, 2650, 3500, 8075 and 8976 manufactured by BYK, S-323, S-363, S-368N5T, S-379, S-381, S-390C, S-394 S-395, S-395SD4, S-400, S-483, NEPUUNE-1, NEPUUNE-5031, NEPUUNE-968, NEPUUNE-5223N4, NEPUUNE-5331, and NEPUUNE-5918 manufactured by Sherlock Technology (USA), carnauba wax emulsion WE-100 and carnauba wax emulsion WE-1-252 manufactured by Shinei Sangyo Co., Ltd, and wax emulsion manufactured by Nikko Fine Products Inc., and the like.

### 1.2.1. Pigment

The ink jet ink composition in the present embodiment may contain a pigment, a dye, or the like as a coloring material. Since the ink jet ink composition in the present embodiment can cause the coloring material to be physically fixed to a recording medium due to the aforementioned polymer, a pigment is more preferably used as the coloring material. A printed product is formed by causing the pigment to adhere to the recording medium.

The pigment is not particularly limited, and examples of the pigment type include inorganic pigments such as carbon black, calcium carbonate, and titanium oxide, and organic pigments such as an azo pigment, an isoindolinone pigment, a diketopyrrolopyrrole pigment, a phthalocyanine pigment, a quinacridone pigments, and an anthraquinone pigments.

Examples of a black pigment include No. 2300, No. 900, MCF88, No. 33, No. 40, No. 45, No. 52, MA7, MA8, MA100, No. 2200B, and the like (all of which are manufactured by Mitsubishi Chemical Corporation), Raven 5750, Raven 5250, Raven 5000, Raven 3500, Raven 1255, Raven 700, and the like (all of which are manufactured by Columbia Carbon Co., Ltd.), Regal 400R, Regal 330R, Regal 660R, Mogul L, Monarch 700, Monarch 800, Monarch 880, Monarch 900, Monarch 1000, Monarch 1100, Monarch 1300, Monarch 1400, and the like. (all of which are manufactured by Cabot Corporation), Color Black FW1, Color Black FW2, Color Black FW2V, Color Black FW18, Color Black FW200, Color Black 5150, Color Black 5160, Color Black 5170, Printex 35, Printex U, Printex V, Printex 140U, Special Black 6, Special Black 5, Special Black 4A, and Special Black 4 (all of which are manufactured by Degussa Ltd.), and the like.

Examples of a white pigment include C.I. Pigment White 1 (basic lead carbonate), 4 (zinc oxide), 5 (a mixture of zinc sulfide and barium sulfate), 6 (titanium oxide), 6:1 (titanium oxide containing other metal oxides), 7 (zinc sulfide), 18 (calcium carbonate), 19 (clay), 20 (titanium mica), 21 (barium sulfate), 22 (natural barium sulfate), 23 (gloss white), 24 (alumina white), 25 (gypsum), 26 (magnesium oxide/silicon oxide), 27 (silica), 28 (anhydrous calcium silicate), and the like.

Examples of a yellow pigment include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, 180, and the like.

Examples of a magenta pigment include C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, and 245, C.I. Pigment Violet 19, 23, 32, 33, 36, 38, 43, and 50, and the like.

Examples of a cyan pigment include C.I. Pigment Blue 1, 2, 3, 15, 15:1, 15:2, 15:3, 15:34, 15:4, 16, 18, 22, 25, 60, 65, and 66, C.I. Vat Blue 4 and 60, and the like.

Examples of pigments other than black, white, yellow, magenta, and cyan pigments include C.I. Pigment Green 7 and 10, C.I. Pigment Brown 3, 5, 25, and 26, C.I. Pigment Orange 1, 2, 5, 7, 13, 14, 15, 16, 24, 34, 36, 38, 40, 43, and 63, and the like.

The pigments listed above can be used as at least one of a pigment having an anionic group bonded to the particle surfaces directly or via another atomic group (surface-treated pigment) and a pigment dispersed with a resin having an anionic functional group.

Examples of the pigment having an anionic group bonded to the particle surfaces directly or through another atomic group include those in which a functional group containing an anionic group is bonded to the surfaces of the pigment particles and those in which an anionic resin is bonded to the surfaces of the pigment particles. Examples of the pigment dispersed with a resin having an anionic functional group include those in which an anionic resin is physically adsorbed on the surfaces of pigment particles and those contained in an anionic resin.

A self-dispersion pigment in which a functional group containing an anionic group is bonded to the surfaces of the pigment particles is obtained by an anionic group such as —COOM, —SO₃M, —PO₃HM, or —PO₃M₂ being bonded to the surfaces of the pigment particles directly or through another atomic group. Examples of M include organic amines such as a hydrogen atom, lithium, sodium, potassium, ammonium (NH₄), methylamine, ethylamine, monoethanolamine, diethanolamine, and triethanolamine. Examples of another atomic group include a linear or branched alkylene group having 1 to 12 carbon atoms, a phenylene group, a naphthylene group, an amide group, a sulfonyl group, an amino group, a carbonyl group, an ester group, an ether groups, and groups as combinations of these groups.

As these self-dispersion pigments, those in which an anionic group is bonded to the surfaces of the pigment particles through an oxidation treatment by a known method and those in which a functional group including an anionic group such as diazo coupling is bonded to the surfaces of the pigment particles are exemplified, and both can be suitably used. In the self-dispersion pigment in which an anionic resin is bonded to the surfaces of the pigment particles, the resin having a unit that has at least an anionic group as a hydrophilic unit is bonded to the surfaces of the pigment particles directly or through an atomic group.

Both the resin-dispersed pigment in which an anionic resin is physically adsorbed on the surfaces of the pigment particles and the resin-dispersed pigment which is contained in the anionic resin are based on dispersion methods using a resin dispersant. As the resin dispersant, a copolymer having a hydrophilic group and a hydrophobic group is used.

As the resin dispersant used for the self-dispersion pigment or the resin-dispersed pigment, any known resin that can be used in ink jet ink can be used. As a suitable resin dispersant, the hydrophilic group preferably contains at least an anionic group. Examples of the hydrophilic group include those based on a hydrophilic monomer such as a (meth)acrylic acid or a salt thereof. Further, examples of the hydrophobic group include a functional group based on a hydrophobic monomer such as styrene or a derivative thereof, a monomer having an aromatic ring such as benzyl (meth)acrylate, a monomer having an aliphatic group such as (meth)acrylic acid ester, or the like.

The resin used as the resin dispersant preferably has a number average molecular weight of equal to or greater than 10,000 and equal to or less than 100,000 and further preferably has a number average molecular weight of equal to or greater than 30,000 and equal to or less than 80,000 and preferably has an acid value of equal to or greater than 50 mgKOH/g and equal to or less than 150 mgKOH/g. In the present disclosure, it is more preferable to use a styrene-(meth)acrylic resin or a (meth)acrylic resin having an acid value of equal to or greater than 50 mgKOH/g and equal to or less than 150 mgKOH/g as a dispersant. When a dispersion method using a dispersant is used, the mass ratio of the resin dispersant/the pigment is preferably equal to or greater than 0.1 times and equal to or less than 10.0 times and is further preferably equal to or greater than 0.5 times and equal to or less than 5.0 times.

When the adhesion target of the ink jet ink composition in the present embodiment is a recording medium such as a transparent or semi-transparent film, and a pigment is used, it is possible to form a base layer (first layer, which will be described later) with excellent fixability and scratch resistance by using an inorganic pigment (white pigment) and to create a printed product with satisfactory background shielding properties with such a base layer.

A plurality of kinds of these exemplified pigments may be used. The total content of pigments (solid content) in the ink jet ink composition may differ depending on the types of used pigments, and the total content is preferably equal to or greater than 0.1% by mass and equal to or less than 15.0% by mass and is further preferably equal to or greater than 1.0% by mass and equal to or less than 10.0% by mass in the case of a color ink when the total mass of the ink jet ink composition is defined as 100% by mass in terms of satisfactory coloring properties. In the case of a white ink, the total content is preferably equal to or greater than 0.1% by mass and equal to or less than 20.0% by mass and is further preferably equal to or greater than 1.0% by mass and equal to or less than 15.0% by mass.

Note that when the ink jet ink composition is prepared, a pigment dispersion with a pigment dispersed therein may be prepared in advance, and the pigment dispersion may be added to the ink jet ink composition. As methods for obtaining such a pigment dispersion, there are a method of dispersing a self-dispersion pigment in a dispersion medium without using a dispersant, a method of dispersing a pigment in a dispersion medium using a polymer dispersant (resin dispersant), a method of dispersing a surface-treated pigment in a dispersion medium, and the like.

### 1.2.2. Water

The ink jet ink composition according to the present embodiment may contain water. Examples of water include pure water such as ion-exchanged water, ultrafiltered water, reverse osmosis water, and distilled water and water from which ionic impurities have been removed as much as possible such as ultrapure water. Also, when water sterilized through irradiation with an ultraviolet ray, addition of hydrogen peroxide, or the like is used, it is possible to prevent bacteria and fungi from being generated when the ink jet ink composition is stored for a long period of time.

The content of water is equal to or greater than 30% by mass, is preferably equal to or greater than 40% by mass, is more preferably equal to or greater than 45% by mass, and is further preferably equal to or greater than 50% by mass with respect to the total amount of ink jet ink composition. Note that the water in the ink jet ink composition described herein is defined as including water from a polymer particle dispersion, a pigment dispersion, added water, and the like used as raw materials, for example. When the content of water is equal to or greater than 30% by mass, the ink jet ink composition can have a relatively low viscosity. The upper limit of the content of water is preferably equal to or less than 90% by mass, is more preferably equal to or less than 85% by mass, and is further preferably equal to or less than 80% by mass with respect to the total amount of ink jet ink composition. An ink composition containing equal to or greater than 30% by mass of water is also referred to as a water-based ink composition.

The ink jet ink composition according to the present embodiment is more preferably a water-based ink containing water. In this manner, the polymer is easily dispersed in the form of the emulsion, and it is possible to more easily form a printed product with further excellent fixability and scratch resistance by the ink jet method.

### 1.2.3. Water-Soluble Organic Solvent

The ink jet ink composition in the present embodiment may include a water-soluble organic solvent. By including the water-soluble organic solvent, it is possible to achieve excellent ejection stability of the ink jet ink composition in the ink jet method and to effectively curb moisture evaporation from the recording head caused by leaving the recording head for a long period of time.

The water-soluble organic solvent is not particularly limited as long as it is water-soluble, and it is possible to use nitrogen-containing polar solvents including monovalent or polyhydric alcohol, (poly)alkylene glycol, glycol ether, lactam such as ϵ-caprolactam, 2-pyrrolidone, and N-methyl-pyrrolidone, and lactone such as ϵ-caprolactone and ≡-valerolactone, sulfur-containing polar solvents such as dimethyl sulfoxide (DMSO), acetin, and diacetin, and the like. Among these, a lactam structure is preferably used, and 2-pyrrolidone is preferably used. The content (% by mass) of the water-soluble organic solvent in the ink jet ink composition is preferably equal to or greater than 3.0% by mass and equal to or less than 50.0% by mass in total with reference to the total mass of the ink.

### 1.2.4. Surfactant

The ink jet ink composition in the present embodiment may contain a surfactant. As the surfactant, any of nonionic surfactants, anionic surfactants, cationic surfactants, and amphoteric surfactants can be used, and these may be used in combination. Particularly, a silicone-based surfactant is preferably used.

When a surfactant is blended in the ink jet ink composition, the amount of surfactant blended is equal to or greater than 0.01% by mass or equal to or less than 3% by mass, is preferably equal to or greater than 0.05% by mass and equal to or less than 2% by mass, is further preferably equal to or greater than 0.1% by mass and equal to or less than 1% by mass, and is particularly preferably equal to or greater than 0.2% by mass and equal to or less than 0.5% by mass with respect to the entire ink jet ink composition.

By the ink jet ink composition containing a surfactant, there is a trend that stability increases when the ink is ejected from the head.

### 1.2.5. Chelating Agent

The ink jet ink composition in the present embodiment may contain a chelating agent. The chelating agent has a characteristic of capturing ions. Examples of such a chelating agent include an ethylenediaminetetraacetic acid salt (EDTA), a nitrilotriacetic acid salt of ethylenediamine, hexametaphosphate, pyrophosphate, and metaphosphate.

### 1.2.6. Preservative

The ink jet ink composition in the present embodiment may contain a preservative. By containing a preservative, it is possible to curb growth of mold and bacteria and to achieve more satisfactory preservability of the ink composition. This facilitates utilization of the ink jet ink composition as a maintenance solution for maintaining the printer without using it for a long period of time, for example. Preferred examples of the preservative include Proxel CRL, Proxel BDN, Proxel GXL, Proxel XL-2, Proxel IB, and Proxel TN.

### 1.2.7. pH Adjuster

The ink jet ink composition in the present embodiment may contain a pH adjuster. By containing the pH adjuster, it is possible to curb or promote elution of impurities from a member forming an ink flow path and to adjust cleaning properties of the ink jet ink composition, for example. Examples of the pH adjuster include amino alcohols such as morpholines, piperazines, and triethanolamine.

### 1.2.8. Other Components

The ink jet ink composition according to the present embodiment may further contain a water-soluble organic compound that is a solid at an ordinary temperature such as polyhydric alcohols such as trimethylolpropane and trimethylolethane and urea derivatives such as urea and ethyleneurea, as needed. Further, various additives such as an antirust, a fungicide, an antioxidant, a reduction inhibitor, an evaporation accelerator, and a water-soluble resin may be contained as needed.

### 1.3. Method for Producing Ink Jet Ink Composition

Although the method for producing the ink jet ink composition in the present embodiment is not particularly limited, the ink jet ink composition can be produced as follows, for example.

First, when the polymer is polymerized, the reaction is caused in an organic solvent such as a methyl ethyl ketone solvent, thereby forming a polymer having a urethane group or a urea group derived one or more kinds selected from dicyclohexylmethane diisocyanate, isophorone diisocyanate, 1,3-bis(isocyanatemethyl)cyclohexane, m-bis(isocyanatepropyl)benzene and m-bis(isocyanatemethyl)benzene.

The ink jet ink composition can be produced by mixing the obtained polymer dispersion or polymer solution with the aforementioned components in an arbitrary order and removing impurities therefrom through filtration or the like as needed. As a method of mixing the components, a method of sequentially adding materials to a container equipped with a stirring device such as a mechanical stirrer or a magnetic stirrer and stirring and mixing the materials is suitably used.

### 1.3. Physical Properties of Ink Jet Ink Composition

### Surface Tension

The ink jet ink composition according to the present embodiment preferably has a surface tension of equal to or greater than 20 mN/m and equal to or less than 40 mN/m and more preferably has a surface tension of equal to or greater than 20 mN/m and equal to or less than 35 mN/m at 20° C. in terms of a balance between printed product quality and reliability as an ink for ink jet recording. Note that the surface tension can be measured by checking the surface tension when a platinum plate is moistened with the ink in an environment at 20° C. using an automatic surface tension meter CBVP-Z (product name, manufactured by Kyowa Interface Science Co., Ltd.).

### Viscosity

The viscosity of the ink jet ink composition in the present embodiment at 20° C. is preferably equal to or greater than 3 mPa·s and equal to or less than 15 mPa·s and is more preferably equal to or greater than 3 mPa·s and equal to or less than 10 mPa·s from the similar viewpoint. The viscosity in the environment at 20° C. can be measured using a viscoelasticity tester MCR-300 (product name, manufactured by Pysica), for example.

### 1.4. Actions, Effects, and the Like

According to the ink jet ink composition in the present embodiment, scratch resistance and delamination resistance of the recorded printed product are improved, and it is also possible to maintain high clogging stability and intermittent ejection stability by adding the aforementioned polymer. The intermittent ejection stability relates to the acid value of the polymer, and as the acid value is higher, the hydrophilicity of the polymer increases, and the intermittent ejection stability is improved. However, when the acid value of the polymer excessively increases, scratch resistance and water resistance of the recorded printed product tend to be degraded although the intermittent ejection stability is improved. It is also known that the intermittent ejection stability of the ink is degraded depending on the form in which the polymer is contained in the ink jet ink composition. The delamination resistance also relates to the acid value of the polymer, and when the acid value is low, the polarity of the polymer decreases, and the delamination resistance is degraded. A preferable ranges of the acid values are a range of equal to or greater than 10 mgKOH/g and equal to or less than 120 mgKOH/g for the polymer particles A and a range of equal to or greater than 5 mgKOH/g and equal to or less than 100 mgKOH/g for the polymer particles B.

Generally, degradation of the intermittent ejection stability is caused by evaporation of water from the nozzles of the ink jet head. In order to improve the intermittent ejection stability, it is necessary to maintain a state in which the pigment and the resin are stably dispersed without any aggregation even when water is evaporated to some extent from the ink that is present in the vicinity of the nozzles of the ink jet head and an interaction between the polymer and the pigment is strengthened.

Since the polymer contained in the ink jet ink composition in the present embodiment has a relatively low acid value while it has a structure in which it is three-dimensionally entangled in a complicated manner, repulsion caused by an electrostatic effect and a repulsive force tends to occur between the polymer and the pigment even if evaporation of water advances. In this manner, according to the ink jet ink composition in the present embodiment, the scratch resistance and the delamination resistance of the printed product are improved, and the pigment dispersed state is stably maintained, it is thus possible to improve clogging stability and intermittent ejection stability.

Furthermore, glossiness when the ink is applied to a recording medium with high flatness such as a film is improved by appropriately blending isocyanate as the polymer contained in the ink jet ink composition in the present embodiment.

Since the polymer is constituted mainly of polyisocyanate and components that react with polyisocyanate, the proportion at which short-chain polyol such as acid group-containing diol occupies increases when the acid value of the polymer is increased to improve the intermittent ejection stability of the ink jet ink composition. Then, the proportion at which long-chain polyol that is a target component that reacts with polyisocyanate occupies decreases similarly to the short-chain polyol. This leads to an increase in urethane bond and a decrease in soft segment in the polymer, and flexibility of the polymer film is impaired. Therefore, when the hydrophilicity of the polymer is enhanced by increasing the acid value thereof, scratch resistance and water resistance of the printed product are degraded although the intermittent ejection stability of the ink jet ink composition is improved.

In the polymer contained in the ink jet ink composition in the present embodiment, the polymer particles A has an acid value of equal to or greater than 10 mgKOH/g and equal to or less than 120 mgKOH/g, and the polymer particles B has an acid value of equal to or greater than 5 mgKOH/g and equal to or less than 100 mgKOH/g, thereby securing the intermittent ejection stability of the ink jet ink composition. By polymerizing the polymer using a raw material including specific diisocyanate, scratch resistance and delamination resistance of the printed product are improved, and also, sufficient glossiness can be obtained even when the ink is used for a recording medium that requires glossiness, such as a film.

### 1.5. Laminating

Laminating can be performed by stacking a protective film on a recording surface of a recorded product by attaching a film or the like. Although not particularly limited, a known adhesive may be caused to adhere to the recording surface of the recorded product, and the film may be attached thereto, or a film with an adhesive adhering thereto may be attached to the recording surface of the recorded product. Alternatively, it is also possible to perform the laminating by using a molten resin, which is a molten film, extruding the molten resin onto the recording surface of the recorded product, and shaping the molten resin as a film on the recording surface of the recorded product. As a material such as a film used for the laminating, it is possible to use a film made of a resin, for example.

The ink according to the present embodiment can be an ink used for recording a recorded product to be used with laminating performed on the recording surface after the recording. The recording surface is the surface of the recording medium after recording, on which the recording is performed. Since the ink according to the present embodiment has excellent delamination resistance, it is possible to obtain a recorded product with excellent delamination resistance, which is preferable.

Also, the ink according to the present embodiment can be an ink used for recording a recorded product to be used with no laminating performed on the recording surface after the recording. Since the ink according to the present embodiment has excellent scratch resistance, it is possible to record a recorded product with excellent scratch resistance without performing laminating, which is preferable.

Further, the ink can be an ink to be used for recording a recorded product to be used with laminating performed on the recording surface after the recording and also to be used for recording a different recorded product to be used with no laminating performed on the recording surface after the recording. The ink according to the present embodiment has excellent delamination resistance and scratch resistance, it is possible to obtain a recorded product with excellent delamination resistance or scratch resistance in any kinds of recorded product, which is preferable.

### 2. Recording Method

### 2.1. Recording Medium

A recording method according to the present embodiment is used as a recording method for performing recording on a recording medium using the ink jet ink composition. Hereinafter, examples of the recording medium used along with the recording method according to the present embodiment will be described.

Although the recording medium used in the recording method according to the present embodiment is not particularly limited, poorly absorbable or non-absorbable recording medium is preferably used. The poorly absorbable or non-absorbable recording medium denotes a recording medium with a characteristic that the recording medium does not absorb the ink at all or absorbs substantially no ink. Quantitatively, the recording medium used in the present embodiment denotes a “recording medium having a water absorption amount of equal to or less than 10 mL/m² in 30 msec^{1/2} from the start of contact in the Bristow method”. The Bristow method is a method that has most widely been distributed as a method for measuring the amount of absorbed solution in a short time, and is also employed by the Japan Pulp and Paper Technology Association (JAPAN TAPPI). Details of the test method are described in the standard No. 51 “Paper and Paperboard-Liquid Absorption Test Method-Bristow Method” of “JAPAN TAPPI Paper Pulp Test Method 2000 Edition”. Examples of the recording medium having such a non-absorbable characteristic include a recording medium having no ink-accepting layer with ink absorbability on the recording surface and a recording medium having a coating layer with small ink absorbability on the recording surface.

Although the non-absorbable recording medium is not particularly limited, examples thereof include a plastic film having no ink absorbing layer, a recording medium with a base material such as paper coated with plastic, and a recording medium with a plastic film adhering thereto. Examples of the plastic described here include polyvinyl chloride, polyethylene terephthalate, polycarbonate, polystyrene, polyurethane, polyethylene, and polypropylene.

Although the poorly absorbable recording medium is not particularly limited, examples thereof include a coated paper provided with a coating layer on the surface for accepting an oil-based ink. Although the coated paper is not particularly limited, examples thereof include printing papers such as an art paper, a coated paper, and a matte paper.

If the ink jet ink composition according to the present embodiment is used, it is possible to more easily form a predetermined printed product with satisfactory fixability and satisfactory scratch resistance for such an ink non-absorbable or ink poorly absorbable recording medium.

In the recording method according to the present embodiment, the recording medium as an ink adhesion target more preferably contains, as main components, polyolefin (polyethylene, polypropylene, or the like) and polyethylene terephthalate (PET). Such a recording medium is a recording medium to which adhesion is generally difficult, and it is possible to form a printed product with satisfactory fixability and scratch resistance thereon, there are further significant effects of satisfactory fixability, satisfactory scratch resistance, and delamination resistance. The ink in the present embodiment is used for performing recording on the recording medium as described above.

### 2.2. Recording Method

The recording method according to the present embodiment uses the ink jet ink composition described above. According to such a recording method, it is possible to secure intermittent ejection stability and to obtain a printed product with a good balance between fixability and scratch resistance of the printed product when the ink jet ink composition is ejected from the ink jet head onto the recording medium to form a printed product layer, for example.

The recording method according to the present embodiment is a method of ejecting the ink jet ink composition according to the present embodiment described above from a recording head of an ink jet scheme to record a printed product on a recording medium. Examples of the scheme of ejecting the ink include a scheme of applying mechanical energy caused by an electrostrictive element to the ink and a method of applying thermal energy to the ink. In this embodiment, it is particularly preferable to use the scheme of applying mechanical energy caused by the electrostrictive element to the ink.

The recording method is performed using an ink jet recording apparatus provided with the ink jet head described above.

### 2.3. Recorded Product

A recorded product according to the present embodiment is a recorded product obtained by performing recording on a recording medium using the aforementioned ink composition. As the recording medium, the aforementioned recording medium can be used.

### 3. Examples and Comparative Examples

Although the first disclosure will be further specifically described with reference to examples and comparative examples, the present disclosure can be modified in various manners without departing from the gist thereof and is not limited by the following examples in any sense. Note that % described in regard to the amounts of components denote % by mass unless otherwise particularly indicated.

### 3.1. Polymerization of Polymer

### Preparation of Urethane Resin Emulsion A1

In a reaction vessel equipped with a stirrer, a reflux condenser, and a thermometer, 220 g of polytetramethylene glycol (PTMG2000 manufactured by Mitsubishi Chemical Corporation: number average molecular weight of 2000), 140 g of 2,2-dimethylolpropionic acid (DMPA), and 130 g of methyl ethyl ketone (MEK: bp79.6° C.) were prepared under a nitrogen stream and were heated to 65° C. to dissolve the DMPA. 330 g of 4,4′-dicyclohexylmethane diisocyanate (MCHDI) and 0.26 g of a urethane-forming catalyst XK-614 (manufactured by Kusumoto Chemicals Co., Ltd.) were added thhereto, the mixture was heated to 75° C., and a urethane-forming reaction was caused for 5 hours, thereby obtaining an isocyanate-terminated urethane polymer.

Then, the reaction mixture was cooled to 70° C., and 800 g was taken out from a mixture obtained by adding 40 g of triethanolamine added to the reaction mixture and mixing the obtained mixture and was added to a mixture solution of 540 g of water and 40 g of triethanolamine under strong stirring. Then, 160 g of ice was added thereto, 28 g of 35 wt % aqueous solution of bicycloheptane dimethanamine was added thereto to cause a chain extending reaction, and a part of methyl ethyl ketone and water were distilled off so that the concentration of the solid content concentration was 30%, thereby obtaining a urethane resin emulsion A1 (urethane resin component: 30%, water: 70%, acid value: 80 mgKOH/g).

### Preparation of Urethane Resin Emulsion A2

A urethane resin emulsion A2 (urethane resin component: 30%, water: 70%, acid value: 80 mgKOH/g) was similarly obtained other than that, in the manufacturing of the urethane resin emulsion A1, 280 g of isophorone diisocyanate (IPDI) was used instead of 330 g of 4,4′-dicyclohexylmethane diisocyanate (MCHDI), the amount of polytetramethylene glycol (PTMG2000 manufactured by Mitsubishi Chemical Corporation; number average molecular weight of 2000) was changed to 260 g, and the amount of 2,2-dimethylolpropionic acid (DMPA) was changed to 138 g.

### Preparation of Urethane Resin Emulsion A3

A urethane resin emulsion A3 (urethane resin component: 30%, water: 70%, acid value: 80 mgKOH/g) was similarly obtained other than that, in the manufacturing of the urethane resin emulsion A1, 235 g of 1,3-bis(isocyanatemethyl)cyclohexane (BIMCH) was used instead of 330 g of 4,4′-dicyclohexylmethane diisocyanate, the amount of PTMG2000 was changed to 275 g, the amount of DMPA was changed to 130 g, and the amount of 35% by weight of aqueous solution of bicycloheptanedimethanamine was changed to 30 g.

### Preparation of Urethane Resin Emulsion A4

A urethane resin emulsion A4 (urethane resin component: 30%, water: 70%, acid value: 80 mgKOH/g) was similarly obtained other than that, in the manufacturing of the urethane resin emulsion A2, 300 g of m-bis(isocyanatepropyl)benzene (BICPB) was used instead of 280 g of isophorone diisocyanate (IPDI), the amount of polytetramethylene glycol (PTMG2000 manufactured by Mitsubishi Chemical Corporation; number average molecular weight of 2000) was changed to 200 g, the amount of 2,2-dimethylolpropionic acid (DMPA) was changed to 130 g, and the amount of aqueous solution of bicycloheptanedimethaneamine was changed to 55 g.

### Preparation of Urethane Resin Emulsion A5

A urethane resin emulsion A5 (urethane resin component: 30%, water: 70%, acid value: 80 mgKOH/g) was similarly obtained other than that, in the manufacturing of the urethane resin emulsion A1, 208 g of m-bis(isocyanatemethyl)benzene (BICMB) was used instead of 280 g of 4,4′-dicyclohexylmethane diisocyanate (MCHDI), the amount of polytetramethylene glycol (PTMG2000 manufactured by Mitsubishi Chemical Corporation; number average molecular weight of 2000) was changed to 157 g, and the amount of 2,2-dimethylolpropionic acid (DMPA) was changed to 125 g.

### Preparation of Urethane Resin Emulsion A6

A urethane resin emulsion A6 (urethane resin component: 30%, water: 70%, acid value: 65 mgKOH/g) was similarly obtained other than that, in the manufacturing of the urethane resin emulsion A3, 413 g of polytetramethylene glycol (PTMG3000 manufactured by Mitsubishi Chemical Corporation; number average molecular weight of 3000) was used instead of 275 g of polytetramethylene glycol (PTMG2000 manufactured by Mitsubishi Chemical Corporation; number average molecular weight of 2000).

### Preparation of Urethane Resin Emulsion A7

A polycarbonate-based urethane resin emulsion A7 (urethane resin component: 30%, water: 70%, acid value: 71 mgKOH/g) was similarly obtained other than that, in the manufacturing of the urethane resin emulsion A4, 225 g of polytetramethylene glycol (PTMG3000 manufactured by Mitsubishi Chemical Corporation; number average molecular weight of 3000) and 50 g of polycarbonate diol (polyhexamethylene carbonate diol (“Nipolon 980R” manufactured by Tosoh Corporation; number average molecular weight of 2000) were used instead of 200 g of polytetramethylene glycol (PTMG2000 manufactured by Mitsubishi Chemical Corporation; number average molecular weight of 2000).

### Preparation of Urethane Resin Emulsion A8

A urethane resin emulsion A8 (urethane resin component: 30%, water: 70%, acid value: 80 mgKOH/g) was similarly obtained other than that, in the manufacturing of the urethane resin emulsion A2, 200 g of polytetramethylene glycol (PTMG2000 manufactured by Mitsubishi Chemical Corporation; number average molecular weight of 2000) and 75 g of polycarbonate diol (polyhexamethylene carbonate diol (“Nipolon 980R” manufactured by Tosoh Corporation; number average molecular weight of 2000) were used instead of 260 g of polytetramethylene glycol (PTMG2000 manufactured by Mitsubishi Chemical Corporation; number average molecular weight of 2000).

### Preparation of Urethane Resin Emulsion A9

A polycarbonate-based urethane resin emulsion A9 (urethane resin component: 30%, water: 64%, acid value: 80 mgKOH/g) was similarly obtained other than that, in the manufacturing of the urethane resin emulsion A2, 253 g of polytetramethylene glycol (PTMG2000 manufactured by Mitsubishi Chemical Corporation; number average molecular weight of 2000) and 1 g of trimethylolpropane (TMP) were used instead of 260 g of polytetramethylene glycol (PTMG2000 manufactured by Mitsubishi Chemical Corporation; number average molecular weight of 2000).

### Preparation of Urethane Resin Emulsion A10

A urethane resin emulsion A10 (urethane resin component: 30%, water: 70%, acid value: 82 mgKOH/g) was similarly obtained other than that, in the manufacturing of the urethane resin emulsion A2, 248 g of polytetramethylene glycol (PTMG2000 manufactured by Mitsubishi Chemical Corporation; number average molecular weight of 2000) and 2 g of triethylene glycol (TEG) were used instead of 260 g of polytetramethylene glycol (PTMG2000 manufactured by Mitsubishi Chemical Corporation; number average molecular weight of 2000).

### Preparation of Urethane Resin Emulsion A11

A urethane resin emulsion A11 (urethane resin component: 30%, water: 70%, acid value: 83 mgKOH/g) was similarly obtained other than that, in the manufacturing of the urethane resin emulsion A2, 220 g of 2,4-tolylene diisocyanate (TDI) was used instead of 280 g of isophorone diisocyanate (IPDI), and the amount of 2,2-dimethylolpropionic acid (DMPA) was changed to 130 g.

### Preparation of Urethane Resin Emulsion A12

A urethane resin emulsion A12 (urethane resin component: 30%, water: 70%, acid value: 76 mgKOH/g) was similarly obtained other than that, in the manufacturing of the urethane resin emulsion A2, 315 g of 4,4′-diphenylmethane diisocyanate (MDI) was used instead of 280 g of isophorone diisocyanate (IPDI).

### Preparation of Urethane Resin Emulsion A13

A urethane resin emulsion A13 (urethane resin component: 30%, water: 70%, acid value: 89 mgKOH/g) was similarly obtained other than that, in the manufacturing of the urethane resin emulsion A2, 210 g of 1,6-hexamethylene diisocyanate (HDI) was used instead of 280 g of isophorone diisocyanate (IPDI).

### Preparation of Urethane Resin Emulsion A14

A urethane resin emulsion A14 (urethane resin component: 30%, water: 70%, acid value: 78 mgKOH/g) was similarly obtained other than that, in the manufacturing of the urethane resin emulsion A2, 250 g of 4,4′-diphenylmethane diisocyanate (MDI) and 44 g of 1,6-hexamethylene diisocyanate (HDI) were used instead of 280 g of isophorone diisocyanate (IPDI).

### Preparation of Urethane Resin Emulsion A15

A urethane resin emulsion A15 (urethane resin component: 30%, water: 70%, acid value: 102 mgKOH/g) was similarly obtained other than that, in the manufacturing of the urethane resin emulsion A2, the amount of 2,2-dimethylolpropionic acid (DMPA) was changed from 138 g to 115 g, the amount of isophorone diisocyanate (IPDI) was changed from 280 g to 210 g, the amount of polytetramethylene glycol (PTMG2000 manufactured by Mitsubishi Chemical Corporation; number average molecular weight of 2000) was changed from 260 g to 125 g, and the amount of 35% by mass of aqueous solution of bicycloheptanedimethanamine was changed to 7 g.

### Preparation of Urethane Resin Emulsion A16

A urethane resin emulsion A16 (urethane resin component: 30%, water: 70%, acid value: 49 mgKOH/g) was similarly obtained other than that, in the manufacturing of the urethane resin emulsion A2, the amount of 2,2-dimethylolpropionic acid (DMPA) was changed from 138 g to 40 g, the amount of isophorone diisocyanate (IPDI) was changed from 280 g to 100 g, and the amount of aqueous solution of bicycloheptanedimethanamine was changed to 7 g.

### Preparation of Urethane Resin Emulsion A17

A urethane resin emulsion A17 (urethane resin component: 30%, water: 70%, acid value: 80 mgKOH/g) was similarly obtained other than that, in the manufacturing of the urethane resin emulsion A3, 275 g of polyoxypropylene glycol (PPG2000; number average molecular weight of 2000) was used instead of 275 g of polytetramethylene glycol (PTMG2000 manufactured by Mitsubishi Chemical Corporation; number average molecular weight of 2000).

### Preparation of Urethane Resin Emulsion A18

A urethane resin emulsion A18 (urethane resin component: 30%, water: 70%, acid value: 65 mgKOH/g) was similarly obtained other than that, in the manufacturing of the urethane resin emulsion A6, 413 g of polyoxypropylene glycol (PPG3000; number average molecular weight of 3000) was used instead of 413 g of polytetramethylene glycol (PTMG3000 manufactured by Mitsubishi Chemical Corporation; number average molecular weight of 3000).

### Preparation of Urethane Resin Emulsion A19

A urethane resin emulsion A19 (urethane resin component: 30%, water: 70%, acid value: 80 mgKOH/g) was similarly obtained other than that, in the manufacturing of the urethane resin emulsion A4, 150 g of polyoxypropylene glycol (PPG2000; number average molecular weight of 2000) and 50 g of polycarbonate diol (polyhexamethylene carbonate diol (“Nipolon 980R” manufactured by Tosoh Corporation); number average molecular weight of 2000) were used instead of 200 g of polytetramethylene glycol (PTMG2000 manufactured by Mitsubishi Chemical Corporation; number average molecular weight of 2000).

### Preparation of Urethane Resin Emulsion A20

A polyether-based urethane resin emulsion A20 (urethane resin component: 30%, water: 70%, acid value: 70 mgKOH/g) was similarly obtained other than that, in the manufacturing of the urethane resin emulsion A9, 253 g of polytetramethylene glycol (PTMG2000 manufactured by Mitsubishi Chemical Corporation; number average molecular weight of 2000) was changed to 100 g of polytetramethylene glycol (PTMG2000 manufactured by Mitsubishi Chemical Corporation; number average molecular weight of 2000) and 153 g of polytetramethylene glycol (PTMG4000 manufactured by Mitsubishi Chemical Corporation; number average molecular weight of 4000).

### Preparation of Urethane Resin Emulsion A21

A polyether-based urethane resin emulsion A21 (urethane resin component: 30%, water: 70%, acid value: 80 mgKOH/g) was similarly obtained other than that, in the manufacturing of the urethane resin emulsion A2, 194 g of polytetramethylene glycol (PTMG3000 manufactured by Mitsubishi Chemical Corporation; number average molecular weight of 3000) and 16 g of polytetramethylene glycol (PTMG250 manufactured by Mitsubishi Chemical Corporation; number average molecular weight of 250) were added instead of 260 g of polytetramethylene glycol (PTMG2000 manufactured by Mitsubishi Chemical Corporation; number average molecular weight of 2000) to use polytetramethylene glycol with an average molecular weight of 450.

### Preparation of Urethane Resin Emulsion A22

A polyether-based urethane resin emulsion A22 (urethane resin component: 30%, water: 70%, acid value: 55 mgKOH/g) was similarly obtained other than that, in the manufacturing of the urethane resin emulsion A2, 520 g of polytetramethylene glycol (PTMG4000 manufactured by Mitsubishi Chemical Corporation; number average molecular weight of 4000) was used instead of 260 g of polytetramethylene glycol (PTMG2000 manufactured by Mitsubishi Chemical Corporation; number average molecular weight of 2000).

The aforementioned urethane resin emulsions A1 to A22 are summarized in Table 1 below.

PCD is polyhexamethylene carbonate diol (“Nipolon 980R” manufactured by Tosoh Corporation).

TABLE 1

| | | A1 | A2 | A3 | A4 | A5 | A6 | A7 | A8 | A9 | A10 | A11 |
|---|---|---|---|---|---|---|---|---|---|---|---|---|
| Specific | MCHDI | 330 | — | — | — | — | — | — | — | — | — | — |
| isocyanates | IPDI | — | 280 | — | — | — | — | — | 280 | 280 | 280 | — |
| | BIMCH | — | — | 235 | — | — | 235 | — | — | — | — | — |
| | BICPB | — | — | — | 300 | — | — | 300 | — | — | — | — |
| | BICMB | — | — | — | — | 208 | — | — | — | — | — | — |
| Other | 2,4-TDI | — | — | — | — | — | — | — | — | — | — | 220 |
| isocyanates | MDI | — | — | — | — | — | — | — | — | — | — | — |
| | 1,6-HDI | — | — | — | — | — | — | — | — | — | — | — |
| Polytetra- | PTMG250 | — | — | — | — | — | — | — | — | — | — | — |
| methylene | PTMG2000 | 220 | 260 | 275 | 200 | 157 | — | — | 200 | 253 | 248 | 260 |
| glycol | PTMG3000 | — | — | — | — | — | 413 | 225 | — | — | — | — |
| | PTMG4000 | — | — | — | — | — | — | — | — | — | — | — |
| Other | PCD | — | — | — | — | — | — | 50 | 75 | — | — | — |
| polyols | PPG2000 | — | — | — | — | — | — | — | — | — | — | — |
| | PPG3000 | — | — | — | — | — | — | — | — | — | — | — |
| | TMP | — | — | — | — | — | — | — | — | 1 | — | — |
| | TEG | — | — | — | — | — | — | — | — | — | 2 | — |
| Others | DMPA | 140 | 138 | 130 | 130 | 125 | 138 | 130 | 138 | 138 | 138 | 230 |
| | BCHDMA | 28 | 28 | 28 | 55 | 28 | 28 | 28 | 28 | 28 | 28 | 28 |
| | XK-614 | 0.26 | 0.26 | 0.26 | 0.26 | 0.26 | 0.26 | 0.26 | 0.26 | 0.26 | 0.26 | 0.26 |
| Acid value (MgKOH/g) | | 80 | 80 | 80 | 80 | 80 | 65 | 71 | 80 | 82 | 82 | 83 |
| | | A12 | A13 | A14 | A15 | A16 | A17 | A18 | A19 | A20 | A21 | A22 |
| Specific | MCHDI | — | — | — | — | — | — | — | — | — | — | — |
| isocyanates | IPDI | — | — | — | 210 | 100 | — | — | — | 280 | 280 | 280 |
| | BIMCH | — | — | — | — | — | 235 | 235 | — | — | — | — |
| | BICPB | — | — | — | — | — | — | — | 300 | — | — | — |
| | BICMB | — | — | — | — | — | — | — | — | — | — | — |
| Other | 2,4-TDI | — | — | — | — | — | — | — | — | — | — | — |
| isocyanates | MDI | 315 | — | 250 | — | — | — | — | — | — | — | — |
| | 1,6-HDI | — | 210 | 44 | — | — | — | — | — | — | — | — |
| Polytetra- | PTMG250 | — | — | — | — | — | — | — | — | — | 16 | — |
| methylene | PTMG2000 | 260 | 260 | 260 | 125 | 260 | — | — | — | 100 | — | — |
| glycol | PTMG3000 | — | — | — | — | — | — | — | — | — | 194 | — |
| | PTMG4000 | — | — | — | — | — | — | — | — | 153 | — | 520 |
| Other | PCD | — | — | — | — | — | — | — | 50 | — | — | — |
| polyols | PPG2000 | — | — | — | — | — | 275 | — | 150 | — | — | — |
| | PPG3000 | — | — | — | — | — | — | 413 | — | — | — | — |
| | TMP | — | — | — | — | — | — | — | — | 1 | — | — |
| | TEG | — | — | — | — | — | — | — | — | — | — | — |
| Others | DMPA | 138 | 138 | 138 | 115 | 40 | 130 | 138 | 130 | 138 | 138 | 117 |
| | BCHDMA | 28 | 28 | 28 | 7 | 7 | 28 | 28 | 55 | 28 | 28 | 28 |
| | XK-614 | 0.26 | 0.26 | 0.26 | 0.26 | 0.26 | 0.26 | 0.26 | 0.26 | 0.26 | 0.26 | 0.26 |

| | | | | | | | | | | | |
|---|---|---|---|---|---|---|---|---|---|---|---|
| Acid value (MgKOH/g) | 76 | 89 | 78 | 102 | 49 | 80 | 65 | 80 | 70 | 80 | 55 |

### 3.3. Preparation of Pigment Dispersion

### Pigment Dispersion 1

A mixture was obtained by mixing 500 g of carbon black, 1,000 g of water-soluble resin, and 14,000 g of water. As the water-soluble resin, a styrene-acrylic acid copolymer having an acid value of 100 mgKOH/g and a weight-average molecular weight of 10,000 was neutralized with a 0.1 mol/L aqueous solution of sodium hydroxide, and the obtained mixture was used. The mixture was dispersed for 1 hour using a rocking mill using 1 mm zirconia beads, impurities were removed therefrom by centrifugation, and vacuum filtration was further performed thereon using a microfilter with a pore size of 5.0 μm (manufactured by Millipore). Then, the concentration of a solid content of the pigment was adjusted to obtain a pigment dispersion 2 with pH of 9.0. The pigment dispersion 2 contained a pigment dispersed with the water-soluble resin (resin dispersant), the content of the pigment was 30.0%, and the content of the resin was 15.0%.

### Pigment Dispersion 2

After a reaction vessel equipped with a stirrer, a thermometer, a reflux condenser, and a dropping funnel was substituted with nitrogen, 300 parts by mass of methyl ethyl ketone was poured thereinto, 40 parts by mass of styrene, 40 parts by mass of ethyl methacrylate. 5 parts by mass of lauryl acrylate, 5 parts by mass of lauryl methacrylate, 5 parts by mass of methoxy polyethylene glycol 400 acrylate AM-90G (manufactured by Shin-Nakamura Chemical Co., Ltd.), 5 parts by mass of acrylic acid, 0.2 parts by mass of ammonium persulphate, and 0.3 parts by mass of t-dodecyl mercaptan were poured into the dropping funnel and were dropped into the reaction vessel for 4 hours to cause a polymerization reaction of a polymer dispersant. Then, methyl ethyl ketone was added to the reaction vessel to prepare a 40% by mass of solution of the polymer dispersant.

A weight-average molecular weight of the aforementioned polymer dispersant solution in terms of styrene measured using THF as a solvent and using gel permeation chromatography (GPC) of an L7100 system manufactured by Hitachi Ltd. was 58,000. Also, polydispersity index (Mw/Mn) was 3.1.

Also, 40 parts by mass of polymer dispersant solution described above, 30 parts by mass of chromofine blue C.I. Pigment Blue 15:3 (manufactured by Dainichiseika Color & Chemicals Mfg. Co., Ltd., product name, hereinafter, also referred to as “PB15:3” as a cyan pigment, 100 parts by mass of 0.1 mol/L of aqueous solution of sodium hydroxide, and 30 parts by mass of methyl ethyl ketone were mixed, and 8-pass dispersion processing was performed thereon using an Altimizer 25005 (a name of a product manufactured by Sugino Machine Ltd.). Then, 300 parts by mass of ion-exchanged water was added thereto, the whole amount of methyl ethyl ketone and a part of water were distilled off using a rotary evaporator, and the pH was adjusted to 9 through neutralization with 0.1 mol/L sodium hydroxide. Then, the mixture was dispersed until the volume average particle diameter of the cyan pigment became 100 nm while the volume average particle diameter was measured using a particle size distribution meter, and was then filtered with a 3 μm membrane filter, thereby obtaining a pigment dispersion containing 15% by mass of solid content (the polymer dispersant and the pigment).

### 3.4. Preparation of Ink Jet Ink Composition

### Preparation of Ink

### Examples 1 to 13 and Comparative Examples 1 to 9

The components described below were mixed, were sufficiently stirred, and were then subjected to vacuum filtration using a microfiliter (manufactured by Millipore) with a pore size of 5.0 μm, thereby obtaining ink jet ink compositions in examples and comparative examples. Compositions of the ink jet ink compositions in examples and comparative examples are shown in Tables 2 and 3. Note that Tables 2 and 3 show net amounts of added pigment solid contents. The ion exchanged water was added such that the amount was the balance (the balance was such an amount that the total amount of all components in each ink was 100.0%). Tables 2 and 3 also show compositions and the evaluation results of ink jet ink compositions using the urethane resin emulsions A1 to A22. In Tables 2 and 3, 1,2-HD is 1,2-hexanediol, PG is propylene glycol, SAG503A is a silicone-based surfactant Silface SAG503A manufactured by Nissin Chemical, DF110D is an acetylene glycol-based surfactant DF110D manufactured by Nisshin Chemical Co., Ltd., TiPA is triisopropanolamine, and EDTA is an ethylenediaminetetraacetic acid disodium salt.

### 3.5. Evaluation Method

### Evaluation

An ink cartridge was filled with each ink jet ink composition obtained as described above, and the ink cartridge was mounted on an ink jet recording apparatus (product name: PX-G930 manufactured by Seiko Epson Corporation) adapted to eject the ink from a recording head using an effect of energy of piezoelectric elements. In each example, a recording duty of a solid image recorded under a condition that one ink droplet with a mass of 28 ng±10% per drop was applied to a unit region of 1/600 inches× 1/600 inches was defined as 100%. As recording conditions, the temperature was set to 23° C., and the relative humidity was set to 55%. The following evaluation was conducted in each example. As evaluation criteria for blocking resistance and lamination resistance, A and B were defined as acceptable levels while C and D were defined as unacceptable levels.

### Blocking Resistance Test

A recorded product was obtained by recording a solid image of 1.0 inches×0.5 inches with a recording duty of 100% on a film (product name OPP plain roll with a thickness of 25 μm; manufactured by Toyobo Co., Ltd.). Printing was performed at a platen temperature of 60° C. and with dot density of 1440 dpi×1440 dpi. The rear surface (non-corona surface) of each base material and the printed surface were attached and evaluated using the sample with a blocking tester CO-201 manufactured by Tester Sangyo Co., Ltd. under conditions of 5 Kgf/cm2 (50 mmφ), 50° C., and leaving it for 24 hours (n=3). Each result was based on visual observation.

A: No transfer was made.
B: Slight transfer was made.
C: Faint transfer was made.
D: Clear transfer was made.

### Delamination Resistance Strength Test

Based on JIS 20237, an adhesive composition in which a main agent, a curing agent, and ethyl acetate that is a diluting solvent were blended was applied to an OPP (biaxially extending polypropylene) film, on which printing was performed under same conditions as those used in the aforementioned rubbing resistance test such that the amount of application was 2.5 g (nonvolatile content)/m2 using a Test laminator (manufactured by Musashino Kikai Co., Ltd.), the diluting solvent was volatilized and dried using a dryer, and an adhesive surface of the OPP to which an adhesive composition was applied and a cast polypropylene (CPP) film were laminated, thereby producing a laminated film including two layers of OPP/CPP. Then, the laminated film was subjected to aging at 40° C. for 3 days to cure the adhesive composition, thereby obtaining a laminated film sheet.

As films for the delamination resistance strength test, the following films were used.
OPP film (base material: printed film): manufactured by Futamura Chemical Co., Ltd., Taiko polypropylene film, FOS-AQ, 60 μm
CPP film (sealant film): CPP sealant (manufactured by Toyobo Co., Ltd., FHK-2, 50 μm)

Note that the following adhesives were used.

Two-solution curable dry laminate adhesive Polybond AY-651A (main agent) and AY-651C manufactured by Sanyo Chemical Industries, Ltd.
PET film (base material: printed film): manufactured by Futamura Chemical Co., Ltd, Taiko polyester film, FE2001, 50 μm
PE film (sealant film): manufactured by TUX-HCE 60 μm manufactured by Mitsui Chemicals Tohcello Inc., TUX-HCE, 60 μm

Note that the same adhesives as those for OPP were used.

Aliphatic ester-based TM-569 (main agent) and CAT-10L (curing agent) manufactured by Toyo-Morton, Ltd.

Hereinafter, a method for evaluating strength of delamination resistance will be described.

A sample of each laminated film was cut into a width of 15 mm, and peeling strength test was conducted thereon using a tensile tester TSNSILON RTG1250 manufactured by A&D Company, Ltd. A 50N load cell was used to conduct the test at the speed of 5 mm/s. The sample was folded back at 180°, was peeled from a test plate by 25 mm, and was secured to a chuck, the first 25 mm after starting measurement was ignored, and measurement value at the length of 50 mm after the first 25 mm was obtained three times, and an average thereof was obtained as the value. The result was as follows.

A: The average value of the three measurements was equal to or greater than 3N/15 mm.
B: The average value of the three measurements was equal to or greater than 1N/15 mm and less than 3N/15 mm.
C: The average value of the three measurements was equal to or greater than 0.5N/15 mm and less than 1N/15 mm.
D: The average value of the three measurements was less than 0.5N/15 mm.

### Successive Printing Stability Test

A part of the printer PX-G930 (manufactured by Seiko Epson Corporation) was modified to provide a printer capable of performing printing on a film. An ink cartridge of the printer was filled with each of the ink jet ink composition obtained as described above. Then, the ink jet ink composition was ejected at a resolution of 720 dpi in the vertical direction×720 dpi in the horizontal direction, thereby producing a recorded sample with a cyan solid pattern. In an environment at a temperature of 40° C. and a relative humidity of 20%, this operation was repeated for up to 8 hours to eject the ink jet ink composition, and the time until droplets of the ink jet ink composition were not stably ejected from a nozzle was measured. Successive printing stability was evaluated using the following evaluation criteria based on the obtained time.

A: Neither non-ejection nor ejection disorder was observed even after 8 hours from the start of the ejection.
B: Non-ejection and ejection disorder were observed in not less than 2 hours and less than 8 hours after the start of the ejection.
C: Non-ejection and ejection disorder were observed in not less than 1 hour and less than 2 hours after the start of the ejection.
D: Non-ejection, ejection disorder, and the like were observed in less than 1 hours after the start of the ejection.

### 3.6. Evaluation Results

All the ink jet ink compositions in the example containing polymer particles which had a urethane group using one or more isocyanates selected from dicyclohexylmethane diisocyanate, isophorone diisocyanate, 1,3-bis(isocyanatemethyl)cyclohexane, m-bis(isocyanatepropyl)benzene, and m-bis(isocyanatemethyl)benzene and a skeleton derived from polytetramethylene glycol and had an acid value of 50 to 100 mgKOH/g had satisfactory blocking resistance and delamination resistance.

On the other hand, either blocking resistance or delamination resistance was degraded in all of the ink jet ink compositions in the comparative examples which did not meet the conditions. Details will be described below.

In comparison between Examples 11 to 13 with Example 2, more excellent blocking resistance and delamination resistance were achieved, and more excellent successive printing stability was achieved in the case in which polytetramethylene glycol with the molecular weight of 500 to 3000 was used.

In comparison between examples 5 and 6 with Examples 3 and 4, more excellent blocking resistance and delamination resistance, and further, more excellent successive printing stability were achieved in the case in which acid values were slightly higher.

In Examples 1 to 5, more excellent delamination resistance and blocking resistance were achieved in the case of using isophorone diisocyanate, 1,3-bis(isocyanatemethyl)cyclohexane, and m-bis(isocyanatepropyl)benzene as isocyanate. Note that although there are no description in the tables, a blocking resistance test was separately performed with the attachment temperature further increased in Examples 1 to 5, and 1,3-bis(isocyanatemethyl)cyclohexane exhibited a particularly excellent trend.

In Comparative Examples 1 to 4 in which one or more kinds selected from dicyclohexylmethane diisocyanate, isophorone diisocyanate, 1,3-bis(isocyanatemethyl)cyclohexane, m-bis(isocyanatepropyl)benzene, and m-bis(isocyanatemethyl)benzene was not used as a raw material, and significantly poor blocking resistance or lamination resistance was obtained. Further, some of the ink jet ink compositions had degraded successive printing stability.

In Comparative Examples 5 and 6, the acid values exceeded 100 mgKOH/g or were out of the range of less than 50 mgKOH/g, and it was not possible to balance both the blocking resistance and the delamination resistance. In Comparative Examples 7 to 9, the polymer particles did not have a skeleton derived from polytetramethylene glycol, and blocking resistance or lamination resistance were degraded.

TABLE 2

| | Examples | | | | | | | | | | | | |
|---|---|---|---|---|---|---|---|---|---|---|---|---|---|
| | 1 | 2 | 3 | 4 | 5 | 6 | 7 | 8 | 9 | 10 | 11 | 12 | 13 |
| Recording | OPP | OPP | OPP | OPP | OPP | OPP | OPP | OPP | OPP | OPP | OPP | OPP | PET |
| medium | | | | | | | | | | | | | |
| Pigment | 4 | — | — | 4 | — | — | 4 | — | — | 4 | — | — | 4 |
| dispersion 1 | | | | | | | | | | | | | |
| Pigment | — | 4 | 4 | — | 4 | 4 | — | 4 | 4 | — | 4 | 4 | — |
| dispersion 2 | | | | | | | | | | | | | |
| A1 | 4 | — | — | — | — | — | — | — | — | — | — | — | — |
| A2 | — | 4 | — | — | — | — | — | — | — | — | — | — | — |
| A3 | — | — | 4 | — | — | — | — | — | — | — | — | — | — |
| A4 | — | — | — | 4 | — | — | — | — | — | — | — | — | — |
| A5 | — | — | — | — | 4 | — | — | — | — | — | — | — | — |
| A6 | — | — | — | — | — | 4 | — | — | — | — | — | — | — |
| A7 | — | — | — | — | — | — | 4 | — | — | — | — | — | — |
| A8 | — | — | — | — | — | — | — | 4 | — | — | — | — | — |
| A9 | — | — | — | — | — | — | — | — | 4 | — | — | — | — |
| A10 | — | — | — | — | — | — | — | — | — | 4 | — | — | — |
| A11 | — | — | — | — | — | — | — | — | — | — | — | — | — |
| A12 | — | — | — | — | — | — | — | — | — | — | — | — | — |
| A13 | — | — | — | — | — | — | — | — | — | — | — | — | — |
| A14 | — | — | — | — | — | — | — | — | — | — | — | — | — |
| A15 | — | — | — | — | — | — | — | — | — | — | — | — | — |
| A16 | — | — | — | — | — | — | — | — | — | — | — | — | — |
| A17 | — | — | — | — | — | — | — | — | — | — | — | — | — |
| A18 | — | — | — | — | — | — | — | — | — | — | — | — | — |
| A19 | — | — | — | — | — | — | — | — | — | — | — | — | — |
| A20 | — | — | — | — | — | — | — | — | — | — | 4 | — | — |
| A21 | — | — | — | — | — | — | — | — | — | — | — | 4 | — |
| A22 | — | — | — | — | — | — | — | — | — | — | — | — | 4 |
| 1,2-HD | 4 | 4 | 4 | 4 | 4 | 4 | 4 | 4 | 4 | 4 | 4 | 4 | 4 |
| PG | 15 | 15 | 15 | 15 | 15 | 15 | 15 | 15 | 15 | 15 | 15 | 15 | 15 |
| SAG503A | 0.4 | 0.4 | 0.4 | 0.5 | 0.4 | 0.6 | 0.4 | 0.7 | 0.4 | 0.8 | 0.1 | 0.4 | 0.1 |
| DF110D | 0.2 | 0.2 | 0.2 | 0.2 | 0.2 | 0.2 | 0.2 | 0.2 | 0.2 | 0.2 | 0.2 | 0.2 | 0.2 |
| TiPA | 0.2 | 0.2 | 0.2 | 0.2 | 0.2 | 0.2 | 0.2 | 0.2 | 0.2 | 0.2 | 0.2 | 0.2 | 0.2 |
| EDTA | 0.02 | 0.02 | 0.02 | 0.02 | 0.02 | 0.02 | 0.02 | 0.02 | 0.02 | 0.02 | 0.02 | 0.02 | 0.02 |
| Ion | Bal- | Bal- | Bal- | Bal- | Bal- | Bal- | Bal- | Bal- | Bal- | Bal- | Bal- | Bal- | Bal- |
| exchanged | ance | ance | ance | ance | ance | ance | ance | ance | ance | ance | ance | ance | ance |
| water | | | | | | | | | | | | | |
| Total | 100 | 100 | 100 | 100 | 100 | 100 | 100 | 100 | 100 | 100 | 100 | 100 | 100 |
| Blocking | A | A | A | A | B | A | B | A | A | A | B | B | B |
| resistance | | | | | | | | | | | | | |
| Strength of | B | A | A | A | A | B | A | B | A | A | B | B | B |
| delamination | | | | | | | | | | | | | |
| resistance | | | | | | | | | | | | | |
| Successive | A | A | A | A | A | B | A | A | A | A | A | B | B |
| printing | | | | | | | | | | | | | |
| stability | | | | | | | | | | | | | |

TABLE 3

| | Comparative examples | | | | | | | | |
|---|---|---|---|---|---|---|---|---|---|
| | 1 | 2 | 3 | 4 | 5 | 6 | 7 | 8 | 9 |
| Recording | OPP | OPP | PET | PET | OPP | OPP | OPP | OPP | OPP |
| medium | | | | | | | | | |
| Pigment | — | — | 4 | — | — | 4 | — | — | 4 |
| dispersion 1 | | | | | | | | | |
| Pigment | 4 | 4 | — | 4 | 4 | — | 4 | 4 | — |
| dispersion 2 | | | | | | | | | |
| A1 | — | — | — | — | — | — | — | — | — |
| A2 | — | — | — | — | — | — | — | — | — |
| A3 | — | — | — | — | — | — | — | — | — |
| A4 | — | — | — | — | — | — | — | — | — |
| A5 | — | — | — | — | — | — | — | — | — |
| A6 | — | — | — | — | — | — | — | — | — |
| A7 | — | — | — | — | — | — | — | — | — |
| A8 | — | — | — | — | — | — | — | — | — |
| A9 | — | — | — | — | — | — | — | — | — |
| A10 | — | — | — | — | — | — | — | — | — |
| A11 | 4 | — | — | — | — | — | — | — | — |
| A12 | — | 4 | — | — | — | — | — | — | — |
| A13 | — | — | 4 | — | — | — | — | — | — |
| A14 | — | — | — | 4 | — | — | — | — | — |
| A15 | — | — | — | — | 4 | — | — | — | — |
| A16 | — | — | — | — | — | 4 | — | — | — |
| A17 | — | — | — | — | — | — | 4 | — | — |
| A18 | — | — | — | — | — | — | — | 4 | — |
| A19 | — | — | — | — | — | — | — | — | 4 |
| A20 | — | — | — | — | — | — | — | — | — |
| A21 | — | — | — | — | — | — | — | — | — |
| A22 | — | — | — | — | — | — | — | — | — |
| 1,2-HD | 4 | 4 | 4 | 4 | 4 | 4 | 4 | 4 | 4 |
| PG | 15 | 15 | 15 | 15 | 15 | 15 | 15 | 15 | 15 |
| SAG503A | 0.4 | 0.9 | 0.4 | 0.1 | 0.4 | 0.1 | 0.4 | 0.1 | 0.4 |
| DF110D | 0.2 | 0.2 | 0.2 | 0.2 | 0.2 | 0.2 | 0.2 | 0.2 | 0.2 |
| TiPA | 0.2 | 0.2 | 0.2 | 0.2 | 0.2 | 0.2 | 0.2 | 0.2 | 0.2 |
| EDTA | 0.02 | 0.02 | 0.02 | 0.02 | 0.02 | 0.02 | 0.02 | 0.02 | 0.02 |
| Ion | Balance | Balance | Balance | Balance | Balance | Balance | Balance | Balance | Balance |
| exchanged | | | | | | | | | |
| water | | | | | | | | | |
| Total | 100 | 100 | 100 | 100 | 100 | 100 | 100 | 100 | 100 |
| Blocking | B | B | D | D | D | A | C | D | C |
| resistance | | | | | | | | | |
| Strength of | C | D | D | C | C | D | D | D | B |
| delamination | | | | | | | | | |
| resistance | | | | | | | | | |
| Successive | A | B | D | B | B | C | A | A | C |
| printing | | | | | | | | | |
| stability | | | | | | | | | |

Although the second disclosure will be described in more detail with reference to examples and comparative examples, the present disclosure can be modified in various manners without departing from the gist thereof and is not limited by the following examples in any sense. Note that % described in regard to the amounts of components denote % by mass unless otherwise particularly indicated. 3.1. Polymerization of polymer

### Preparation of Urethane Resin Emulsion A1

In a reaction vessel equipped with a stirrer, a reflux condenser, and a thermometer, 300 g of polytetramethylene glycol (PTMG2000 manufactured by Mitsubishi Chemical Corporation; number average molecular weight of 2000), 35 g of 2,2-dimethylolpropionic acid (DMPA) and 130 g of methyl ethyl ketone (MEK; bp79.6° C.) were prepared under a nitrogen strem, and the mixture was heated to 65° C. to dissolve DMPA. 190 g of 4,4′-dicyclohexylmethane diisocyanate (MCHDI) and 0.26 g of urethane-forming catalyst XK-614 (manufactured by Kusumoto Chemicals Ltd.) were added thereto, and the mixture was heated to 75° C. to cause a urethanization reaction for 5 hours, thereby obtainingan isocyanate-terminated urethane prepolymer.

Then, the reaction mixture was cooled to 70° C., 690 g of a mixture obtained by adding 40 g of triethanolamine thereto and mixing them, which was almost the total amount of the mixture, was taken out and was added to a mixed solution of 540 g of water and 40 g of triethanolamine under strong stirring. Then, 160 g of ice was added, 110 g of aqueous solution of 35% by weight of bicycloheptane dimethanamine was added thereto to cause a chain extending reaction, and a part of methyl ethyl ketone and water was distilled out such that the concentration of the solid content was 30%, thereby obtaining a urethane resin emulsion A1 (urethane resin component: 30%, water: 70%, acid value: 25 mgKOH/g).

### Preparation of Urethane Resin Emulsion A2

A urethane resin emulsion A2 (urethane resin component: 30%, water: 70%, acid value: 21 mgKOH/g) was similarly obtained other than that, in the manufacturing of the urethane resin emulsion A1, 160 g of isophorone diisocyanate (IPDI) was used instead of 190 g of 4,4′-dicyclohexylmethane diisocyanate (MCHDI), the amount of polytetramethylene glycol (PTMG2000 manufactured by Mitsubishi Chemical Corporation; number average molecular weight of 2000) was changed to 330 g, and the amount of 2,2-dimethylolpropionic acid (DMPA) was changed to 30 g.

### Preparation of Urethane Resin Emulsion A3

A urethane resin emulsion A3 (urethane resin component: 30%, water: 70%, acid value: 25 mgKOH/g) was similarly obtained other than that, in the manufacturing of the urethane resin emulsion A1, 140 g of 1,3-bis(isocyanatemethyl)cyclohexane (BIMCH) was used instead of 190 g of 4,4′-dicyclohexylmethane diisocyanate, the amount of PTMG2000 was changed to 310 g, and the amount of DMPA was changed to 33 g.

### Preparation of Urethane Resin Emulsion A4

A urethane resin emulsion A4 (urethane resin component: 30%, water: 70%, acid value: 19 mgKOH/g) was similarly obtained other than that, in the manufacturing of the urethane resin emulsion A3, 310 g of polytetramethylene glycol (PTMG2000 manufactured by Mitsubishi Chemical Corporation; number average molecular weight of 2000) was changed to 465 g of polytetramethylene glycol (PTMG3000 manufactured by Mitsubishi Chemical Corporation; number average molecular weight of 3000).

### Preparation of Urethane Resin Emulsion A5

A urethane resin emulsion A5 (urethane resin component: 30%, water: 70%, acid value: 21 mgKOH/g) was similarly obtained other than that, in the manufacturing of the urethane resin emulsion A2, 330 g of polytetramethylene glycol (PTMG2000 manufactured by Mitsubishi Chemical Corporation; number average molecular weight of 2000) was changed to 200 g of polytetramethylene glycol (PTMG2000 manufactured by Mitsubishi Chemical Corporation; number average molecular weight of 2000) and 130 g of polycarbonate diol (polyhexamethylene carbonate diol (“Nipolon 980R” manufactured by Tosoh Corporation); number average molecular weight of 2000).

### Preparation of Urethane Resin Emulsion A6

A urethane resin emulsion A6 (urethane resin component 30%, water: 64%, acid value: 24 mgKOH/g) was similarly obtained other than that, in the manufacturing of the urethane resin emulsion A2, 330 g of polytetramethylene glycol (PTMG2000 manufactured by Mitsubishi Chemical Corporation; number average molecular weight of 2000) was changed to 307 g of polytetramethylene glycol (PTMG2000 manufactured by Mitsubishi Chemical Corporation; number average molecular weight of 2000) and 1 g of trimethylolpropane (TMP).

### Preparation of Urethane Resin Emulsion A7

A urethane resin emulsion A7 (urethane resin component: 30%, water: 70%, acid value: 24 mgKOH/g) was similarly obtained other than that, in the manufacturing of the urethane resin emulsion A2, 330 g of polytetramethylene glycol (PTMG2000 manufactured by Mitsubishi Chemical Corporation; number average molecular weight of 2000) was changed to 303 g of polytetramethylene glycol (PTMG2000 manufactured by Mitsubishi Chemical Corporation; number average molecular weight of 2000) and 2 g of triethylene glycol (TEG).

### Preparation of Urethane Resin Emulsion A8

A urethane resin emulsion A8 (urethane resin component: 30%, water: 70%, acid value: 25 mgKOH/g) was similarly obtained other than that, in the manufacturing of the urethane resin emulsion A3, 310 g of polyoxypropylene glycol (PPG2000; number average molecular weight of 2000) was used instead of 310 g of polytetramethylene glycol (PTMG2000 manufactured by Mitsubishi Chemical Corporation; number average molecular weight of 2000).

### Preparation of Urethane Resin Emulsion A9

A urethane resin emulsion A9 (urethane resin component: 30%, water: 70%, acid value: 24 mgKOH/g) was similarly obtained other than that, in the manufacturing of the urethane resin emulsion A6, 307 g of polyoxypropylene glycol (PPG3000; number average molecular weight of 3000) was used instead of 307 g of polytetramethylene glycol (PTMG3000 manufactured by Mitsubishi Chemical Corporation; number average molecular weight of 3000).

### Preparation of Urethane Resin Emulsion A10

A polyether-based urethane resin emulsion A10 (urethane resin component: 30%, water: 70%, acid value: 24 mgKOH/g) was similarly obtained other than that, in the manufacturing of the urethane resin emulsion A2, 246 g of polytetramethylene glycol (PTMG3000 manufactured by Mitsubishi Chemical Corporation; number average molecular weight of 3000) and 20 g of polytetramethylene glycol (PTMG250 manufactured by Mitsubishi Chemical Corporation; number average molecular weight of 250) were added instead of 330 g of polytetramethylene glycol (PTMG2000 manufactured by Mitsubishi Chemical Corporation; number average molecular weight of 2000), and polytetramethylene glycol with an average molecular weight of 450 was used.

### Preparation of Urethane Resin Emulsion all

A polyether-based urethane resin emulsion A11 (urethane resin component: 30%, water: 70%, acid value: 13 mgKOH/g) was similarly obtained other than that, in the manufacturing of the urethane resin emulsion A2, 660 g of polytetramethylene glycol (PTMG4000 manufactured by Mitsubishi Chemical Corporation; number average molecular weight of 4000) was used instead of 330 g of polytetramethylene glycol (PTMG2000 manufactured by Mitsubishi Chemical Corporation; number average molecular weight of 2000).

### Preparation of Urethane Resin Emulsion B1

A urethane resin emulsion B1 (urethane resin component: 30%, water: 70%, acid value: 28 mgKOH/g) was similarly obtained other than that, in the manufacturing of the urethane resin emulsion A1, 177 g of m-bis(isocyanatepropyl)benzene (BICPB) was used instead of 190 g of 4,4′-dicyclohexylmethane diisocyanate (MCHDI), 300 g of Polylite OD-X-102 (molecular weight of 2000) manufactured by DIC Corporation was used instead of 300 g of polytetramethylene glycol (PTMG2000 manufactured by Mitsubishi Chemical Corporation; number average molecular weight of 2000), and the amount of 2,2-dimethylolpropionic acid (DMPA) was changed to 40 g.

### Preparation of Urethane Resin Emulsion B2

A urethane resin emulsion B2 (urethane resin component: 30%, water: 70%, acid value: 26 mgKOH/g) was similarly obtained other than that, in the manufacturing of the urethane resin emulsion A1, 136 g of m-bis(isocyanatemethyl)benzene (BICMB) was used instead of 190 g of 4,4′-dicyclohexylmethane diisocyanate (MCHDI), 300 g of Polylite OD-X-2251 (molecular weight of 2000) manufactured by DIC was used instead of 300 g of polytetramethylene glycol (PTMG2000 manufactured by Mitsubishi Chemical Corporation; number average molecular weight of 2000), and the amount of 2,2-dimethylolpropionic acid (DMPA) was changed to 34 g.

### Preparation of Urethane Resin Emulsion B3

A urethane resin emulsion B3 (urethane resin component: 30%, water: 70%, acid value: 18 mgKOH/g) was similarly obtained other than that, in the manufacturing of the urethane resin emulsion A2, 160 g of IPDI was changed to 125 g of 2,4-TDI, and 330 g of polytetramethylene glycol (PTMG2000 manufactured by Mitsubishi Chemical Corproation; number average molecular weight of 2000) was changed to 300 g of polytetramethylene glycol (PTMG3000 manufactured by Mitsubishi Chemical Corporation; number average molecular weight of 3000) and 130 g of Polylite OD-X-2251 (molecular weight of 2000) manufactured by DIC.

### Preparation of Urethane Resin Emulsion B4

A urethane resin emulsion B4 (urethane resin component: 30%, water: 70%, acid value: 22 mgKOH/g) was similarly obtained other than that, in the manufacturing of the urethane resin emulsion A2, 125 g of 2,4-tolylene diisocyanate (TDI) was used instead of 160 g of isophorone diisocyanate (IPDI), and 330 g of Polylite OD-X-2420 (molecular weight of 2000) manufactured by DIC was used instead of 330 g of polytetramethylene glycol (PTMG2000 manufactured by Mitsubishi Chemical Corporation; number average molecular weight of 2000).

### Preparation of Urethane Resin Emulsion B5

A urethane resin emulsion B5 (urethane resin component: 30%, water: 70%, acid value: 20 mgKOH/g) was similarly obtained other than that, in the manufacturing of the urethane resin emulsion A2, 180 g of 4,4′-diphenylmethane diisocyanate (MDI) was used instead of 160 g of isophorone diisocyanate (IPDI), and 330 g of Polylite OD-X-102 (molecular weight of 2000) manufactured by DIC was used instead of 330 g of polytetramethylene glycol (PTMG2000 manufactured by Mitsubishi Chemical Corporation; number average molecular weight of 2000).

### Preparation of Urethane Resin Emulsion B6

A urethane resin emulsion B6 (urethane resin component: 30%, water: 70%, acid value: 21 mgKOH/g) was similarly obtained other than that, in the manufacturing of the urethane resin emulsion A2, 150 g of 4,4′-diphenylmethane diisocyanate (MDI) and 20 g of 1,6-hexamethylene diisocyanate (HDI) were used instead of 160 g of isophorone diisocyanate (IPDI).

### Preparation of Urethane Resin Emulsion B7

A urethane resin emulsion B7 (urethane resin component: 30%, water: 70%) was similarly obtained other than that, in the manufacturing of the urethane resin emulsion A2, 125 g of 2,4-TDI was used instead of 160 g of isophorone diisocyanate (IPDI) and 170 g of PTMG2000 and 160 g of PTMG3000 were used instead of 330 g of PTMG2000.

### Preparation of Urethane Resin Emulsion B8

A urethane resin emulsion B8 (urethane resin component: 30%, water: 70%) was similarly obtained other than that, in the manufacturing of the urethane resin emulsion A2, 125 g of 2,4-TDI was used instead of 160 g of isophorone diisocyanate (IPDI) and 130 g of PCD, 100 g of PPG2000, and 100 g of PPG3000 were used instead of 330 g of PTMG2000.

### Preparation of Urethane Resin Emulsion C1

A urethane resin emulsion C1 (urethane resin component: 30%, water: 70%, acid value: 23 mgKOH/g) was similarly obtained other than that, in the manufacturing of the urethane resin emulsion A2, 121 g of 1,6-hexamethylene diisocyanate (HDI) was used instead of 160 g of isophorone diisocyanate (IPDI).

### Preparation of Urethane Resin Emulsion C2

A urethane resin emulsion C2 (urethane resin component: 30%, water: 70%, acid value: 26 mgKOH/g) was similarly obtained other than that, in the manufacturing of the urethane resin emulsion A2, the amount of polytetramethylene glycol (PTMG2000 manufactured by Mitsubishi Chemical Corporation; number average molecular weight of 2000) was changed to 200 g, the amount of dimethylolpropionic acid was changed to 30 g, and 31 g of bisphenoxyethanolfluorene (manufactured by Osaka Gas Chemicals Co., Ltd,) was added.

### Preparation of Urethane Resin Emulsion C3

A urethane resin emulsion C3 (urethane resin component: 30%, water: 70%, acid value: 21 mgKOH/g) was similarly obtained other than that, in the manufacturing of the urethane resin emulsion A2, 250 g of polyoxypropylene glycol (PPG2000; number average molecular weight of 2000) and 80 g of polycarbonate diol (polyhexamethylene carbonate diol (“Nipolon 980R” manufactured by Tosoh Corporation; number average molecular weight of 2000) were used instead of 330 g of polytetramethylene glycol (PTMG2000 manufactured by Mitsubishi Chemical Corporation; number average molecular weight of 2000).

Each of the aforementioned urethane resin emulsions is summarized in Table 1 below.

TABLE 1

| | | A1 | A2 | A3 | A4 | A5 | A6 | A7 | A8 | A9 | A10 | A11 |
|---|---|---|---|---|---|---|---|---|---|---|---|---|
| Isocyanate | MCHDI | 190 | — | — | — | — | — | — | — | — | — | — |
| A | IPDI | — | 160 | — | — | 160 | 160 | 160 | — | 160 | 160 | 160 |
| | BIMCH | — | — | 140 | 140 | — | — | — | 140 | — | — | — |
| Isocyanate | BICPB | — | — | — | — | — | — | — | — | — | — | — |
| B | BICMB | — | — | — | — | — | — | — | — | — | — | — |
| | 2,4-TDI | — | — | — | — | — | — | — | — | — | — | — |
| | MDI | — | — | — | — | — | — | — | — | — | — | — |
| | 1,6-HDI | — | — | — | — | — | — | — | — | — | — | — |
| Polytetra- | PTMG250 | — | — | — | — | — | — | — | — | — | 20 | — |
| methylene | PTMG2000 | 300 | 330 | 310 | — | 200 | 307 | 303 | — | — | — | — |
| glycol | PTMG3000 | — | — | — | 465 | — | — | — | — | — | 246 | — |
| | PTMG4000 | — | — | — | — | — | — | — | — | — | — | 660 |
| Other | PCD | — | — | — | — | 130 | — | — | — | — | — | — |
| polyols | PPG2000 | — | — | — | — | — | — | — | 310 | — | — | — |
| | PPG3000 | — | — | — | — | — | — | — | — | 307 | — | — |
| | TMP | — | — | — | — | — | 1 | — | — | 1 | — | — |
| | TEG | — | — | — | — | — | — | 2 | — | — | — | — |
| | PEPO | — | — | — | — | — | — | — | — | — | — | — |
| | BFEFO | — | — | — | — | — | — | — | — | — | — | — |
| Others | DMPA | 35 | 30 | 33 | 33 | 30 | 30 | 30 | 33 | 30 | 30 | 30 |
| | BCHDMA | 110 | 110 | 110 | 110 | 110 | 110 | 110 | 110 | 110 | 110 | 110 |
| | XK-614 | 0.26 | 0.26 | 0.26 | 0.26 | 0.26 | 0.26 | 0.26 | 0.26 | 0.26 | 0.26 | 0.26 |
| Acid value (MgKOH/g) | | 25 | 21 | 25 | 19 | 21 | 24 | 24 | 25 | 24 | 24 | 13 |
| | | B1 | B2 | B3 | B4 | B5 | B6 | B7 | B8 | C1 | C2 | C3 |
| Isocyanate | MCHDI | — | — | — | — | — | — | — | — | — | — | — |
| A | IPDI | — | — | — | — | — | — | — | — | — | 160 | 160 |
| | BIMCH | — | — | — | — | — | — | — | — | — | — | — |
| Isocyanate | BICPB | 177 | — | — | — | — | — | — | — | — | — | — |
| B | BICMB | — | 136 | — | — | — | — | — | — | — | — | — |
| | 2,4-TDI | — | — | 125 | 125 | — | — | 125 | 125 | — | — | — |
| | MDI | — | — | — | — | 180 | 150 | — | — | — | — | — |
| | 1,6-HDI | — | — | — | — | — | 20 | — | — | 121 | — | — |
| Polytetra- | PTMG250 | — | — | — | — | — | — | — | — | — | — | — |
| methylene | PTMG2000 | — | — | — | — | — | — | 170 | — | 330 | 200 | — |
| glycol | PTMG3000 | — | — | 300 | — | — | — | 160 | — | — | — | — |
| | PTMG4000 | — | — | — | — | — | — | — | — | — | — | — |
| Other | PCD | — | — | — | — | — | — | — | 130 | — | — | 80 |
| polyols | PPG2000 | — | — | — | — | — | — | — | 100 | — | — | 250 |
| | PPG3000 | — | — | — | — | — | — | — | 100 | — | — | — |
| | TMP | — | — | — | — | — | — | — | — | — | — | — |
| | TEG | — | — | — | — | — | — | — | — | — | — | — |
| | PEPO | 300 | 300 | 130 | 330 | 330 | 330 | — | — | — | — | — |
| | BFEFO | — | — | — | — | — | — | — | — | — | 31 | — |
| Others | DMPA | 40 | 34 | 30 | 30 | 30 | 30 | 30 | 30 | 30 | 30 | 30 |
| | BCHDMA | 110 | 110 | 110 | 110 | 110 | 110 | 110 | 110 | 110 | 110 | 110 |
| | XK-614 | 0.26 | 0.26 | 0.26 | 0.26 | 0.26 | 0.26 | 0.26 | 0.26 | 0.26 | 0.26 | 0.26 |

| | | | | | | | | | | | |
|---|---|---|---|---|---|---|---|---|---|---|---|
| Acid value (MgKOH/g) | 28 | 26 | 18 | 22 | 20 | 21 | 19 | 22 | 23 | 26 | 21 |

MCHDI: dicyclohexylmethane diisocyanate
IPDI: Isophorone diisocyanate
BIMCH: 1,3-bis(isocyanatemethyl)cyclohexane
BIPB: m-bis(isocyanatepropyl)benzene
BIMB: m-bis(isocyanatemethyl)benzene
2,4-TDI: 2,4-tolylene diisocyanate
MDI: 4,4′-diphenylmethane diisocyanate
1,6-HD: 1,6-hexamethylene diisocyanate
PCD: polyhexamethylene carbonate diol (“Nipolon 980R” manufactured by Tosoh Corporation)
TMP: trimethylolpropane
TEG: triethylene glycol
PEPO: OD-X-102, polyester polyol manufactured by DIC
BFEFO: bisphenokiethanolfluorene (manufactured by Osaka Chemical Co., Ltd.)
DMPA: dimethylolpropionic acid
BCHDMA: bicycloheptane dimethanamine
XK-614: urethane-forming catalyst
Polyethylene wax: Hitech E-6314 (polyethylene wax manufactured by Toho Chemical Industry Co., Ltd.)

Note that in Table 1, MCHDI, IPDI, and BIMCH are described as isocyanate A while BICPB, BICMB, 2,4-TDI, and MDI are described as isocyanate B.

### 3.3. Preparation of Pigment Dispersion

### Pigment Dispersion 1

A mixture was obtained by mixing 500 g of carbon black, 1,000 g of water-soluble resin, and 14,000 g of water. As the water-soluble resin, a water-soluble resin obtained by neutralizing a styrene-acrylic acid copolymer having an acid value of 100 mgKOH/g and a number average molecular weight of 10,000 with 0.1 mol/L aqueous solution of sodium hydroxide was used. The mixture was dispersed for 1 hour using a rocking mill using 1 mm zirconia beads, impurities were removed therefrom by centrifugation, and vacuum filtration was further performed thereon using a microfilter with a pore size of 5.0 μm (manufactured by Millipore). Then, the concentration of a solid content of the pigment was adjusted to obtain a pigment dispersion 2 with pH of 9.0. The pigment dispersion 2 contained a pigment dispersed with the water-soluble resin (resin dispersant), the content of the pigment was 30.0%, and the content of the resin was 15.0%.

### Pigment Dispersion 2

After a reaction vessel equipped with a stirrer, a thermometer, a reflux condenser, and a dropping funnel was substituted with nitrogen, 300 parts by mass of methyl ethyl ketone was poured thereinto, 40 parts by mass of styrene, 40 parts by mass of ethyl methacrylate. 5 parts by mass of lauryl acrylate, 5 parts by mass of lauryl methacrylate, 5 parts by mass of methoxy polyethylene glycol 400 acrylate AM-90G (manufactured by Shin-Nakamura Chemical Co., Ltd.), 5 parts by mass of acrylic acid, 0.2 parts by mass of ammonium persulphate, and 0.3 parts by mass of t-dodecyl mercaptan were poured into the dropping funnel and were dropped into the reaction vessel for 4 hours to cause a polymerization reaction of a polymer dispersant. Then, methyl ethyl ketone was added to the reaction vessel to prepare a 40% by mass of solution of the polymer dispersant.

A number average molecular weight of the aforementioned polymer dispersant solution in terms of styrene measured using THF as a solvent and using gel permeation chromatography (GPC) of L7100 System manufactured by Hitachi Ltd. was 58,000. Also, polydispersity index (Mw/Mn) was 3.1.

Also, 40 parts by mass of polymer dispersant solution described above, 30 parts by mass of chromofine blue C.I. Pigment Blue 15:3 (manufactured by Dainichiseika Color & Chemicals Mfg. Co., Ltd., product name, hereinafter, also referred to as “PB15:3” as a cyan pigment, 100 parts by mass of 0.1 mol/L of aqueous solution of sodium hydroxide, and 30 parts by mass of methyl ethyl ketone were mixed, and 8-pass dispersion processing was performed thereon using an Altimizer 25005 (a name of a product manufactured by Sugino Machine Ltd.). Then, 300 parts by mass of ion-exchanged water was added thereto, the whole amount of methyl ethyl ketone and a part of water were distilled off using a rotary evaporator, and the pH was adjusted to 9 through neutralization with 0.1 mol/L sodium hydroxide. Then, the mixture was dispersed until the volume average particle diameter of the cyan pigment became 100 nm while the volume average particle diameter was measured using a particle size distribution meter, and was then filtered with a 3 μm membrane filter, thereby obtaining a pigment dispersion containing 15% by mass of solid content (the polymer dispersant and the pigment).

### 3.4. Preparation of Ink Jet Ink Composition

### Preparation of Ink

### EXAMPLES AND COMPARATIVE EXAMPLES

The components described below were mixed, were sufficiently stirred, and were then subjected to vacuum filtration using a microfilter (manufactured by Millipore) with a pore size of 5.0 μm, thereby obtaining ink jet ink compositions in examples and comparative examples. Compositions of the ink jet ink compositions in the examples and the comparative examples are shown in Table 2. Note that Table 2 shows the net amounts of added pigment solid content.

The components shown in Tables 2 and 3 are 4.0% of 1,2-hexanediol (1,2-HD), 15% of propylene glycol (PG), 0.2% of triethanolamine (TiPA), 0.02% of EDTA (ethylenediaminetetraacetic acid disodium salt), 0.4% of SAG503A (silicone-based surfactant), Surfynol DF110D an acetylene glycol-based surfactant manufactured by Nisshin Chemical Co., Ltd.), and the balance of ion-exchanged water (the balance means such an amount that the total amount of all the components in the ink is 100.0%). Compositions and evaluation results of the ink jet ink compositions using the urethane resin emulsions are shown in Table 2.

TABLE 2

| | | Examples | | | | | | | |
|---|---|---|---|---|---|---|---|---|---|
| | | 1 | 2 | 3 | 4 | 5 | 6 | 7 | 8 |
| Recording medium | | OPP | OPP | PET | OPP | OPP | OPP | OPP | OPP |
| Pigment dispersion 1 | | 4.0 | 4.0 | 4.0 | 4.0 | 4.0 | — | — | 4.0 |
| Pigment dispersion 2 | | — | — | — | — | — | 4.0 | 4.0 | — |
| Polymer | A1 | 2.0 | — | — | — | — | — | — | — |
| particles A | A2 | — | 2.0 | 3.0 | — | — | — | — | — |
| | A3 | — | — | — | 2.0 | — | — | — | — |
| | A4 | — | — | — | — | 2.0 | — | — | — |
| | A5 | — | — | — | — | — | 2.0 | — | — |
| | A6 | — | — | — | — | — | — | 2.0 | — |
| | A7 | — | — | — | — | — | — | — | 2.0 |
| | A8 | — | — | — | — | — | — | — | — |
| | A9 | — | — | — | — | — | — | — | — |
| | A10 | — | — | — | — | — | — | — | — |
| | A11 | — | — | — | — | — | — | — | — |
| Polymer | B1 | 2.0 | — | — | — | — | — | — | — |
| particles B | B2 | — | 2.0 | 3.0 | — | — | — | — | — |
| | B3 | — | — | — | 2.0 | — | — | — | — |
| | B4 | — | — | — | — | 2.0 | — | — | — |
| | B5 | — | — | — | — | — | 2.0 | — | — |
| | B6 | — | — | — | — | — | — | 2.0 | 2.0 |
| | B7 | — | — | — | — | — | — | — | — |
| | B8 | — | — | — | — | — | — | — | — |
| | C1 | — | — | — | — | — | — | — | — |
| | C2 | — | — | — | — | — | — | — | — |
| | C3 | — | — | — | — | — | — | — | — |
| 1,2-HD | | 4.0 | 4.0 | 4.0 | 4.0 | 4.0 | 4.0 | 4.0 | 4.0 |
| PG | | 15.0 | 15.0 | 15.0 | 15.0 | 15.0 | 15.0 | 15.0 | 15.0 |
| SAG503A | | 0.4 | 0.4 | 0.4 | 0.4 | 0.4 | 0.4 | 0.4 | 0.4 |
| DF-110D | | 0.2 | 0.2 | 0.2 | 0.2 | 0.2 | 0.2 | 0.2 | 0.2 |
| TiPA | | 0.2 | 0.2 | 0.2 | 0.2 | 0.2 | 0.2 | 0.2 | 0.2 |
| EDTA | | 0.02 | 0.02 | 0.02 | 0.02 | 0.02 | 0.02 | 0.02 | 0.02 |
| Polyethylene wax | | — | — | — | — | — | — | — | — |
| Ion exchanged water | | Balance | Balance | Balance | Balance | Balance | Balance | Balance | Balance |
| Total | | 100.0 | 100.0 | 100.0 | 100.0 | 100.0 | 100.0 | 100.0 | 100.0 |
| Scratch resistance test (dry rubbing) | | A | A | A | A | B | A | A | A |
| Scratch resistance test (wet rubbing) | | B | B | B | B | B | B | B | B |
| Strength of delamination resistance | | B | A | A | A | B | A | B | B |
| Intermittent ejection stability test | | A | A | A | A | A | B | B | B |
| Successive printing stability | | A | B | B | B | B | A | A | A |
| Clogging recovery performance test | | A | A | A | B | B | A | A | A |
| 20° glossiness test | | A | A | A | A | A | B | A | B |
| | | Examples | | | | | | | |
| | | 9 | 10 | 11 | 12 | 13 | 14 | 15 | 16 |
| Recording medium | | OPP | OPP | OPP | OPP | OPP | OPP | OPP | OPP |
| Pigment dispersion 1 | | 4.0 | 4.0 | 4.0 | — | — | 4.0 | 4.0 | — |
| Pigment dispersion 2 | | — | — | — | 4.0 | 4.0 | — | — | 4.0 |
| Polymer | A1 | — | — | — | — | — | — | — | — |
| particles A | A2 | 2.0 | 2.0 | 2.0 | 2.0 | 2.0 | 2.0 | — | — |
| | A3 | — | — | — | — | — | — | — | — |
| | A4 | — | — | — | — | — | — | — | — |
| | A5 | — | — | — | — | — | — | — | — |
| | A6 | — | — | — | — | — | — | — | |
| | A7 | — | — | — | — | — | — | — | — |
| | A8 | — | — | — | — | — | — | — | — |
| | A9 | — | — | — | — | — | — | — | — |
| | A10 | — | — | — | — | — | — | 2.0 | — |
| | A11 | — | — | — | — | — | — | — | 2.0 |
| Polymer | B1 | — | — | — | — | — | — | — | — |
| particles B | B2 | — | — | — | — | — | — | — | — |
| | B3 | — | — | — | — | — | — | — | — |
| | B4 | — | — | 2.0 | 3.0 | 3.0 | 2.0 | 3.0 | 3.0 |
| | B5 | — | — | — | — | — | — | — | — |
| | B6 | — | — | — | — | — | — | — | — |
| | B7 | 2.0 | — | — | — | — | — | — | — |
| | B8 | — | 2.0 | — | — | — | — | — | — |
| | C1 | — | — | — | — | — | — | — | — |
| | C2 | — | — | — | — | 1.0 | 1.0 | — | — |
| | C3 | — | — | — | — | — | — | — | — |

| | | | | | | | | |
|---|---|---|---|---|---|---|---|---|
| 1,2-HD | 4.0 | 4.0 | 4.0 | 4.0 | 4.0 | 4.0 | 4.0 | 4.0 |
| PG | 15.0 | 15.0 | 15.0 | 15.0 | 15.0 | 15.0 | 15.0 | 15.0 |
| SAG503A | 0.4 | 0.4 | 0.4 | 0.4 | 0.4 | 0.4 | 0.4 | 0.4 |
| DF-110D | 0.2 | 0.2 | 0.2 | 0.2 | 0.2 | 0.2 | 0.2 | 0.2 |
| TiPA | 0.2 | 0.2 | 0.2 | 0.2 | 0.2 | 0.2 | 0.2 | 0.2 |
| EDTA | 0.02 | 0.02 | 0.02 | 0.02 | 0.02 | 0.02 | 0.02 | 0.02 |
| Polyethylene wax | — | — | — | 1.0 | — | 1.0 | — | — |
| Ion exchanged water | Balance | Balance | Balance | Balance | Balance | Balance | Balance | Balance |
| Total | 100.0 | 100.0 | 100.0 | 100.0 | 100.0 | 100.0 | 100.0 | 100.0 |
| Scratch resistance test (dry rubbing) | B | B | A | A | B | A | C | C |
| Scratch resistance test (wet rubbing) | C | C | A | B | A | A | C | C |
| Strength of delamination resistance | A | A | A | A | A | A | C | C |
| Intermittent ejection stability test | A | B | A | A | A | A | C | C |
| Successive printing stability | B | B | A | A | A | A | C | C |
| Clogging recovery performance test | B | B | A | A | A | A | B | C |
| 20° glossiness test | A | A | A | B | A | A | C | B |

TABLE 3

| | | Comparative examples | | | | | | | | | |
|---|---|---|---|---|---|---|---|---|---|---|---|
| | | 1 | 2 | 3 | 4 | 5 | 6 | 7 | 8 | 9 | 10 |
| Recording medium | | OPP | OPP | PET | PET | PET | OPP | OPP | OPP | OPP | OPP |
| Pigment dispersion 1 | | — | — | — | — | — | — | 4.0 | — | — | 4.0 |
| Pigment dispersion 2 | | 4.0 | 4.0 | 4.0 | 4.0 | 4.0 | 4.0 | — | 4.0 | 4.0 | — |
| Polymer | A1 | — | — | — | — | — | — | — | 5.0 | — | — |
| particles A | A2 | — | — | — | — | — | 2.0 | 2.0 | — | 5.0 | — |
| | A3 | — | — | — | — | — | — | — | — | — | 5.0 |
| | A4 | — | — | — | — | — | — | — | — | — | — |
| | A5 | — | — | — | — | — | — | — | — | — | — |
| | A6 | — | — | — | — | — | — | — | — | — | — |
| | A7 | — | — | — | — | — | — | — | — | — | — |
| | A8 | 2.0 | — | — | — | — | — | — | — | — | — |
| | A9 | — | 2.0 | 2.0 | — | — | — | — | — | — | — |
| | A10 | — | — | — | — | — | — | — | — | — | — |
| | A11 | — | — | — | — | — | — | — | — | — | — |
| Polymer | B1 | — | — | — | — | — | — | — | — | — | — |
| particles B | B2 | — | — | — | — | — | — | — | — | — | — |
| | B3 | — | — | — | — | — | — | — | — | — | — |
| | B4 | 3.0 | 3.0 | 3.0 | 5.0 | 3.0 | — | — | — | — | — |
| | B5 | — | — | — | — | — | — | — | — | — | — |
| | B6 | — | — | — | — | — | — | — | — | — | — |
| | B7 | — | — | — | — | — | — | — | — | — | — |
| | B8 | — | — | — | — | — | — | — | — | — | — |
| | C1 | — | — | — | — | 3.0 | — | 3.0 | — | — | — |
| | C2 | — | — | — | — | — | — | — | — | — | — |
| | C3 | — | — | — | — | — | 3.0 | — | — | — | — |

| | | | | | | | | | | |
|---|---|---|---|---|---|---|---|---|---|---|
| 1,2-HD | 4.0 | 4.0 | 4.0 | 4.0 | 4.0 | 4.0 | 4.0 | 4.0 | 4.0 | 4.0 |
| PG | 15.0 | 15.0 | 15.0 | 15.0 | 15.0 | 15.0 | 15.0 | 15.0 | 15.0 | 15.0 |
| SAG503A | 0.4 | 0.4 | 0.4 | 0.4 | 0.4 | 0.4 | 0.4 | 0.4 | 0.4 | 0.4 |
| DF-110D | 0.2 | 0.2 | 0.2 | 0.2 | 0.2 | 0.2 | 0.2 | 0.2 | 0.2 | 0.2 |
| TiPA | 0.2 | 0.2 | 0.2 | 0.2 | 0.2 | 0.2 | 0.2 | 0.2 | 0.2 | 0.2 |
| EDTA | 0.02 | 0.02 | 0.02 | 0.02 | 0.02 | 0.02 | 0.02 | 0.02 | 0.02 | 0.02 |
| Polyethylene wax | | | | | | | | | | |
| Ion exchanged water | Balance | Balance | Balance | Balance | Balance | Balance | Balance | Balance | Balance | Balance |
| Total | 100.0 | 100.0 | 100.0 | 100.0 | 100.0 | 100.0 | 100.0 | 100.0 | 100.0 | 100.0 |
| Scratch resistance | C | B | B | B | B | C | C | B | B | C |
| test (dry rubbing) | | | | | | | | | | |
| Scratch resistance | D | C | C | B | B | D | D | D | D | D |
| test (wet rubbing) | | | | | | | | | | |
| Strength of | D | D | D | D | D | C | C | C | B | B |
| delamination resistance | | | | | | | | | | |
| Intermittent ejection | B | B | B | B | B | C | C | C | C | C |
| stability test | | | | | | | | | | |
| Successive | B | B | B | B | B | B | B | B | B | B |
| printing stability | | | | | | | | | | |
| Clogging recovery | B | B | B | B | B | B | B | B | B | B |
| performance test | | | | | | | | | | |
| 20° glossiness test | C | C | C | A | A | B | B | B | B | B |

### 3.5. Evaluation Method

### Evaluation

An ink cartridge was filled with each ink jet ink composition obtained as described above, and the ink cartridge was mounted on an ink jet recording apparatus (product name: PX-G930 manufactured by Seiko Epson Corporation) adapted to eject the ink from a recording head using an effect of energy of piezoelectric elements. In each example, a recording duty of a solid printed product recorded under a condition that one ink droplet with a mass of 28 ng±10% per droplet was applied to a unit region of 1/600 inches× 1/600 inches was defined as 100%. As recording conditions, the temperature was set to 23° C., and the relative humidity was set to 55%. The following evaluation was conducted in each example, and as evaluation criteria thereof, A and B were defined as acceptable levels while C and D were defined as unacceptable levels. An ink jet recording device (product name: PX-G930 manufactured by Seiko Epson Corporation) modified for printing on a film was used. Specifically, the ink jet recording apparatus was modified so as to be able to heat a platen portion. The platen portion is a portion of a region, in which the ink jet head is caused to eject the ink, on the side of the printer, and is a portion installed on the rear side of a non-printed portion.

### Scratch Resistance Test

A scratch resistance test was conducted based on JIS L0849 2013 using a JSPS ablation resistance evaluation device AB-301 from Tester Sangyo Co., Ltd. under conditions of 100 reciprocations with 200 g load. A printed product was obtained by recording a solid printed product of 1.0 inches×0.5 inches with a recording duty of 100% on a film (product name OPP plain roll with a thickness of 25 μm; manufactured by Toyobo Co, Ltd. using the aforementioned ink jet recording apparatus. Printing was performed at a platen temperature of 60° C. and with dot density of 1440 dpi×1440 dpi. 10 minutes and 1 day after the recording, a dry shirting cotton (dry rubbing properties) or a wet shirting cotton (wet rubbing properties) were pressed against the solid printed product on the printed product, and evaluation was then conducted. The wet shirting cotton was obtained by uniformly moistening the cotton with 0.09 to 0.011 g/cm² of water. Thereafter, contamination of the shirting cotton, contamination of a non-recorded portion, and a degree of peeling of the printed portion were visually checked, and scratch resistance evaluation was conducted in accordance with the evaluation criteria described below.

A: There were substantially no contamination of the shirting cotton and no contamination of the non-recorded portion, and there was substantially no peeling of the printed portion.
B: There were little contamination of the shirting cotton and contamination of the non-recorded portion, and there was substantially no peeling of the printed portion.
C: There were contamination of the shirting cotton and contamination of the non-recorded portion, and there was slight peeling of the printed portion.
D: There were considerable amounts of contamination of the shirting cotton and contamination of the non-recorded portion, and there was a lot of peeling of the printed portion.

### Delamination Resistance Strength Test

An adhesive composition obtained by blending a main agent, a curing agent, and ethyl acetate that was a diluting agent was applied to an OPP (biaxially extended polypropylene) film, on which printing was performed under the same conditions as those used for the aforementioned scratch resistance test such that the amount of application was 2.5 g (nonvolatile content)/m² using a test laminator (manufactured by Musashino Kikai Co., Ltd.) based on JIS Z0237, the diluting agent was volatilized and dried with a dryer, and the adhesive surface of the OPP to which the adhesive composition was applied and a cast polypropylene (CPP) film were laminated, thereby producing a laminated film including two layers of OPP/CPP. Then, the laminated film was subjected to aging at 40° C. for 3 days to cure the adhesive composition, thereby obtaining a laminated film sheet.

Even when the PET was a base material, printing was similarly performed, an adhesive was applied to the PET film, a diluting agent was volatilized and dried with a dryer, and a PET adhesive surface, to which the adhesive composition was applied, and a PE (polyethylene) film were laminated, thereby producing a laminated film including the two layers of PET/PE. Then, the laminated film was subjected to aging at 40° C. for 3 days to cure the adhesive composition, thereby obtaining a laminated film sheet.

As films for the delamination resistance strength test, the following films were used.
OPP film (base material: printed film): manufactured by Futamura Chemical Co., Ltd., Taiko polypropylene film, FOS-AQ, 60 μm
CPP film (sealant film): CPP sealant (manufactured by Toyobo Co., Ltd., FHK-2, 50 μm)

Note that the following adhesives were used.
Two-solution curable dry laminate adhesives Polybond AY-651A (main agent) and AY-651C (curing agent) manufactured by Sanyo Chemical Industries, Ltd.
PET film (base material: printed film): manufactured by Futamura Chemical Co., Ltd, Taiko polyester film, FE2001, 50 μm
PE film (sealant film): manufactured by TUX-HCE 60 μm manufactured by Mitsui Chemicals Tohcello Inc., TUX-HCE, 60 μm

Note that the same adhesives as those for OPP were used.
Aliphatic ester-based TM-569 (main agent) and CAT-10L (curing agent) manufactured by Toyo-Morton, Ltd.

Hereinafter, a method for evaluating strength of delamination resistance will be described.

A sample of each laminated film was cut into a width of 15 mm, and peeling strength test was conducted thereon using a tensile tester TSNSILON RTG1250 manufactured by A&D Company, Ltd. A 50N load cell was used to conduct the test at the speed of 5 mm/s. The sample was folded back at 180°, was peeled from a test plate by 25 mm, and was secured to a chuck, the first 25 mm after starting measurement was ignored, and measurement value at the length of 5 mm after the 25 mm was obtained three times, and an average thereof was obtained as the value. The result was as follows.

A: The average value of the three measurements was equal to or greater than 3N/15 mm.
B: The average value of the three measurements was equal to or greater than 1N/15 mm and less than 3N/15 mm.
C: The average value of the three measurements was equal to or greater than 0.5N/15 mm and less than 1N/15 mm.
D: The average value of the three measurements was less than 0.5N/15 mm.

### Intermittent Ejection Stability Test

A part of the printer PX-G930 (manufactured by Seiko Epson Corporation) was modified to provide a printer capable of performing printing on a film. Ejection stability at the time of intermittent printing was evaluated in an environment at a temperature of 40° C. and a relative humidity of 20% using this printer. First, it was confirmed that the ink jet ink composition was ejected normally from all the nozzles. Then, the ink jet ink composition was ejected onto an A4 photo sheet (photo glossy paper manufactured by Seiko Epson Corporation), a 2-minute resting time was then provided in an environment at a temperature of 40° C. and a relative humidity of 20%, and the ink jet ink composition was ejected again onto the A4 photo sheet. In the second ejection, dot positional deviation between the position of the first dot adhering to the A4 photo sheet and the target position was measured with an optical microscope. Intermittent properties were evaluated by the following evaluation criteria based on the obtained dot positional deviation.

A: The dot positional deviation was equal to or less than 10 μm.
B: The dot positional deviation was greater than 10 μm and equal to or less than 20 μm.
C: The dot positional deviation was greater than 20 μm and equal to or less than 30 μm.
D: The dot positional deviation was greater than 30 μm.

### Successive Printing Stability Test

A part of the printer PX-G930 (manufactured by Seiko Epson Corporation) was modified to provide a printer capable of performing printing on a film. An ink cartridge of the printer was filled with each of the ink jet ink composition obtained as described above. Then, the ink jet ink composition was ejected onto the A4 photo sheet (photo glossy paper manufactured by Seiko Epson Corporation) with a resolution of 720 dpi in the vertical direction×720 dpi in the horizontal direction, thereby producing a recorded sample with a cyan solid pattern. In an environment at a temperature of 40° C. and a relative humidity of 20%, this operation was repeated for up to 8 hours to eject the ink jet ink composition, and the time until droplets of the ink jet ink composition were not stably ejected from a nozzle was measured. Successive printing stability was evaluated using the following evaluation criteria based on the obtained time.

A: Neither non-ejection nor ejection disorder was observed even after 8 hours from the start of the ejection.
B: Non-ejection and ejection disorder were observed in not less than 2 hours and less than 8 hours after the start of the ejection.
C: Non-ejection and ejection disorder were observed in not less than 1 hour and less than 2 hours after the start of the ejection.
D: Non-ejection, ejection disorder, and the like were observed in less than 1 hours after the start of the ejection.

### Clogging Recovery Property Test

A printer PX-G930 (manufactured by Seiko Epson Corporation) was used, an ink cartridge of the printer was filled with the ink jet ink composition obtained as described above, and printing was performed on an A4 OPP film with a resolution of 720 dpi in the vertical direction×720 dpi in the horizontal direction to confirm that the ink jet ink composition was ejected from all nozzles. Thereafter, the printer was left in an environment at 40° C. and a relative humidity of 20% for 30 days. After leaving the printer, the ink jet ink composition was ejected from all the nozzles again, cleaning was repeatedly performed until it became possible to perform printing equivalent to initial printing, and the number of times the cleaning was performed at that time was measured. Clogging recovery properties were evaluated by the following evaluation criteria based on the number of times the cleaning was performed.

A: The ink composition was ejected from all the nozzles in the cleaning performed one to three times.
B: The ink composition was ejected from all the nozzles in the cleaning performed four to six times.
C: The ink composition was ejected from all the nozzles in the cleaning performed seven or more times.
D: The ink composition was not able to be ejected from any of the nozzles in the cleaning.

### 20° Glossiness Test

A sample was produced by performing solid printing (1440 dpi×1440 dpi) on a corona treated OPP (FOS-AQ manufactured by Futamura Chemical Co., Ltd; thickness of 60 μm) at a platen temperature of 55° C. using PX-G930 and drying the solid printing at 90° C. for 10 minutes, and 20° glossiness was measured with a glossiness meter. The glossiness was measured with a handy type glossiness meter MULTI GLOSS 268 (manufactured by Konica Minolta Co., Ltd.).

A: 20° glossiness on the OPP film was equal to or greater than 70.
B: 20° glossiness on the OPP film was equal to or greater than 55 and less than 70.
C: 20° glossiness on the OPP film was equal to or greater than 40 and less than 55.
D: 20° glossiness on the OPP film was less than 40.

### 3.6. Evaluation Results

All the ink jet ink composition in the examples, each of which contained polymer particles A constituted of a polymer using any isocyanate from among dicyclohexylmethane diisocyanate, isophorone diisocyanate, and 1,3-bis(isocyanatemethyl)cyclohexane and polytetramethylene glycol and polymer particles B constituted of a polymer using any of m-bis(isocyanatepropyl)benzene, m-bis(isocyanatemethyl)benzene, tolylene diisocyanate, and 4,4-diphenylmethane diisocyanate, had excellent scratch resistance (dry rubbing and wet rubbing) and delamination resistance.

On the other hand, either the scratch resistance and the delamination resistance was degraded in all the comparative examples in which the conditions were not met. Details will be described below.

In Examples 1 to 8, 15, and 16, more excellent scratch resistance and delamination resistance were achieved, and more excellent intermittent ejection stability, successive printing stability, clogging recovery properties, glossiness, and the like were achieved in the case in which polytetramethylene glycol with a molecular weight of 500 to 3000 was used as the polymer particles A than in the cases of the other molecular weights. Particularly excellent results were obtained in Example 11.

In Examples 1 to 8, 9, and 10, more excellent scratch resistance was achieved in the case in which polyester polyol was used as the polymer particles B.

In Examples 1 to 8, 12, and the like, more excellent scratch resistance was achieved in the case in which the ink contains the wax.

In Examples 1 to 8, 14, and the like, more excellent scratch resistance, delamination resistance, and the like were achieved in the case in which the ink contained the polymer particles constituted of polymers with a fluorene structure.

In Comparative Examples 1 to 5, the ink did not contain the polymer particles A, and at least delamination resistance was degraded.

In Comparative Examples 6 to 10, the ink did not contain the polymer particles B, and scratch resistance was degraded.

The present disclosure is not limited to the aforementioned embodiment and can be modified in various manners. For example, the disclosure includes configurations that are substantially the same as the configurations described in the embodiments (for example, configurations having the same functions, methods, and results or configurations having the same objects and effects). Further, the present disclosure includes configurations achieved by replacing non-essential parts in the configurations described in the embodiment. Also, the disclosure includes configurations that achieve the same effect as those of the configurations described in the embodiment or configurations that can achieve the same objects. Further, the disclosure includes configurations achieved by adding known techniques to the configurations described in the embodiment.

What is claimed is:

1. An ink jet ink composition comprising:
polymer particles,
wherein
a polymer constituting the polymer particles includes a polymer that has
a urethane group derived from one or more isocyanates selected from dicyclohexylmethane diisocyanate, isophorone diisocyanate, 1,3-bis(isocyanatemethyl)cyclohexane, m-bis(isocyanatepropyl)benzene, and m-bis(isocyanatemethyl)benzene and
a structure derived from polytetramethylene glycol and
has an acid value of 50 to 100 mgKOH/g.

2. The ink jet ink composition according to claim 1, wherein
a content of the polymer particles is 1% to 20% by mass with respect to a total mass of the ink composition.

3. The ink jet ink composition according to claim 1, wherein
the polymer particles have chains extended with polyamine having 1 to 10 carbon atoms and have a urea group.

4. The ink jet ink composition according to claim 1, wherein
a molecular weight of the polytetramethylene glycol is 500 to 3000.

5. The ink jet ink composition according to claim 1, further comprising:
a silicone-based surfactant and/or an acetylene glycol-based surfactant.

6. The ink jet ink composition according to claim 1, wherein
the polymer particles are polymer particles produced by performing a reaction of the one or more isocyanates, the polytetramethylene glycol, and acid group-containing polyol in an organic solvent and performing a chain extending reaction using polyamine in an aqueous solvent.

7. The ink jet ink composition according to claim 1, wherein
the ink jet ink composition is used to perform recording on a poorly absorbable recording medium or a non-absorbable recording medium.

8. The ink jet ink composition according to claim 1, wherein
the ink jet ink composition is used to perform recording on a non-absorbable recording medium made of polyolefin or polyethylene terephthalate.

9. An ink producing method for producing the ink jet ink composition according to claim 1, the method comprising:
performing by using polymer particles.

10. A recorded product obtained by recording with the ink jet ink composition according to claim 1 on a poorly absorbable recording medium or a non-absorbable recording medium.

11. The recorded product according to claim 10, wherein
the recorded product is obtained by recording on the non-absorbable recording medium made of polyolefin or polyethylene terephthalate.

12. An ink jet recording method comprising:
ejecting the ink jet ink composition according to claim 1 from an ink jet head and causing the ink jet ink composition to adhere to a recording medium.
